(19) United States
(12) Patent Application Publication
(10) Pub. No.: US 2026/0319571 A1
(43) Pub. Date: Oct. 15, 2026

(54) BEHAVIOR CONTROL SYSTEM

(71) Applicant: SOFTBANK GROUP CORP., Tokyo (JP)

(72) Inventor: Masayoshi SON, Tokyo (JP)

(73) Assignee: SOFTBANK GROUP CORP., Tokyo (JP)

(21) Appl. No.: 19/464,638

(22) Filed: Jan. 30, 2026

Related U.S. Application Data
(63) Continuation of application No. PCT/JP2024/026872, filed on Jul. 26, 2024.

(30) Foreign Application Priority Data
Aug. 2, 2023 (JP) 2023-126500
Aug. 3, 2023 (JP) 2023-127389
Aug. 4, 2023 (JP) 2023-128188
Aug. 4, 2023 (JP) 2023-128189
Aug. 4, 2023 (JP) 2023-128190
Aug. 10, 2023 (JP) 2023-131230
Aug. 14, 2023 (JP) 2023-132032
Aug. 14, 2023 (JP) 2023-132072
Aug. 15, 2023 (JP) 2023-132221

(51) Int. Cl. G06F 3/01; G06F 40/166; G06T 11/60

(52) U.S. Cl. CPC G06F 3/011; G06F 40/166; G06T 11/60; G06F 2203/011

(57) ABSTRACT

A behavior determination unit determines, as a behavior of an avatar, any one of plural types of avatar behaviors including performing no operation by using at least one of a user state, a state of electronic equipment, an emotion of a user, or an emotion of an avatar representing an agent for having a dialogue with the user, and a behavior determination model at a predetermined timing; and a behavior control unit that displays the avatar in an image display region of the electronic equipment, in which the avatar behaviors include provision of advice on health to the user, and in a case where the behavior determination unit determines, as the behavior of the avatar, to provide advice on health to the user, the behavior determination unit autonomously determines a behavior corresponding to a health condition of the user based on a parameter representing the health condition of the user.

### CROSS-REFERENCE TO RELATED APPLICATIONS

This application is a continuation of International Application No. PCT/JP2024/026872, filed on Jul. 26, 2024, which claims priority from Japanese Patent Application No. 2023-126500, filed on Aug. 2, 2023, Japanese Patent Application No. 2023-127389, filed on Aug. 3, 2023, Japanese Patent Application No. 2023-128188, filed on Aug. 4, 2023, Japanese Patent Application No. 2023-128189, filed on Aug. 4, 2023, Japanese Patent Application No. 2023-128190, filed on Aug. 4, 2023, Japanese Patent Application No. 2023-131230, filed on Aug. 10, 2023, Japanese Patent Application No. 2023-132032, filed on Aug. 14, 2023, Japanese Patent Application No. 2023-132072, filed on Aug. 14, 2023, Japanese Patent Application No. 2023-132221, filed on Aug. 15, 2023. The entire disclosure of each of the above applications is incorporated herein by reference.

### TECHNICAL FIELD

The present disclosure relates to a behavior control system.

### BACKGROUND ART

Japanese Patent No. 6053847 discloses a technology for determining an appropriate behavior of a robot for a state of a user. In the related art of Patent Literature 1, a reaction of the user in a case where the robot performs a specific behavior is recognized, and in a case where a behavior of the robot for the recognized reaction of the user cannot be determined, the behavior of the robot is updated by receiving information regarding a behavior appropriate for a recognized state of the user from a server.

### SUMMARY OF INVENTION

### Technical Problem

However, in the related art, there is room for improvement in causing the robot to perform an appropriate behavior for a behavior of the user.

According to a first aspect of the present disclosure, a behavior control system is provided. The behavior control system includes: a state recognition unit that recognizes a user state including a behavior of a user and a state of electronic equipment; an emotion determination unit that determines an emotion of the user or an emotion of an avatar representing an agent for having a dialogue with the user; a behavior determination unit that determines, as a behavior of the avatar, any one of a plurality of types of avatar behaviors including performing no operation by using at least one of the user state, the state of the electronic equipment, the emotion of the user, or the emotion of the avatar, and a behavior determination model at a predetermined timing; a storage control unit that stores, in history data, event data including an emotion value determined by the emotion determination unit and data including the behavior of the user; and a behavior control unit that displays the avatar in an image display region of the electronic equipment, in which the avatar behaviors include provision of advice on health to the user, and in a case where the behavior determination unit determines, as the behavior of the avatar, to provide the advice on health to the user, the behavior determination unit autonomously determines a behavior corresponding to a health condition of the user based on a parameter representing the health condition of the user.

### Solution to Problem

In a second aspect of the disclosure, in a case where the behavior determination unit determines, as the behavior of the avatar, to provide advice on health to the user, the behavior determination unit causes the avatar to perform at least one of concerning the health of the user by speaking to the user to watch over the user or spontaneously determining a symptom of the user to recommend taking appropriate medication.

In a third aspect of the disclosure, in a case where the behavior control unit spontaneously determines the symptom of the user to recommend taking appropriate medication, the behavior control unit recommends to take the medication while operating the avatar according to the symptom of the user.

In a fourth aspect of the disclosure, the parameter representing the health condition of the user is at least one of an inflection of a conversation of the user, a complexion of the user, trembling of a hand of the user, a body temperature of the user, a respiratory rate of the user, a sleep duration of the user, the number of times the user has entered a toilet, a heart rate of the user, a blood pressure of the user, or a blood glucose level of the user.

In a fifth aspect of the disclosure, a behavior control system includes: a state recognition unit that recognizes a user state including a behavior of a user and a state of electronic equipment; an emotion determination unit that determines an emotion of the user or an emotion of an avatar representing an agent for having a dialogue with the user; a behavior determination unit that determines, as a behavior of the avatar, any one of a plurality of types of avatar behaviors including performing no operation by using at least one of the user state, the state of the electronic equipment, the emotion of the user, or the emotion of the avatar, and a behavior determination model at a predetermined timing; and a behavior control unit that displays the avatar in an image display region of the electronic equipment, in which the avatar behaviors include proposal to go to an art gallery, a museum, and an exhibition according to a schedule of the user, and in a case where the behavior determination unit determines, as the behavior of the avatar, to propose to the user to go to an art gallery, a museum, or an exhibition, the behavior determination unit determines a destination to be proposed based on event data stored in history data.

In a sixth aspect of the disclosure, the avatar behaviors include proposal of participation in an event, and in a case where the behavior control unit determines, as the behavior of the avatar, to propose participation in the event, the behavior control unit causes the avatar to change an appearance so as to match the proposed event.

In a seventh aspect of the disclosure, a behavior control system includes: a state recognition unit that recognizes a user state including a behavior of a user and a state of electronic equipment; an emotion determination unit that determines an emotion of the user or an emotion of an avatar representing an agent for having a dialogue with the user; a behavior determination unit that determines, as a behavior of the avatar, any one of a plurality of types of avatar behaviors including performing no operation by using at least one of the user state, the state of the electronic equipment, the emotion of the user, or the emotion of the avatar, and a behavior determination model at a predetermined timing; and a behavior control unit that displays the avatar in an image display region of the electronic equipment, in which the avatar behaviors include playback of a piece of music the user likes, and in a case where the behavior determination unit determines, as the behavior of the avatar, to play a piece of music the user likes, the behavior determination unit causes the avatar to play the piece of music based on information regarding a preference of the user in music stored in a storage unit.

In an eighth aspect of the disclosure, in a case where the behavior determination unit determines, as the behavior of the avatar, to play the piece of music the user likes, the behavior determination unit causes the avatar to play the piece of music based on at least one of a preference in types of music, a preference in musical instruments, or a preference in singers as the information regarding the preference of the user in music.

In a ninth aspect of the disclosure, in a case where the behavior determination unit determines, as the behavior of the avatar, to play the piece of music the user likes, the behavior determination unit causes the avatar to adjust a volume level according to a preference of the user in volume levels.

In a tenth aspect of the disclosure, the behavior control unit is configured to display a plurality of avatars according to the number of performers of the piece of music.

In an eleventh aspect of the disclosure, the behavior control unit is configured to cause the avatar to be transformed into a musical instrument and displayed according to the musical instrument used for the piece of music.

In a twelfth aspect of the disclosure, the behavior control unit is configured to cause the avatar to be transformed into a virtual avatar of a singer and displayed according to the singer of the piece of music.

In a thirteenth aspect of the disclosure, a behavior control system includes: a state recognition unit that recognizes a user state including a behavior of a user and a state of electronic equipment; an emotion determination unit that determines an emotion of the user or an emotion of an avatar representing an agent for having a dialogue with the user; a behavior determination unit that determines, as a behavior of the avatar, any one of a plurality of types of avatar behaviors including performing no operation by using at least one of the user state, the state of the electronic equipment, the emotion of the user, or the emotion of the avatar, and a behavior determination model at a predetermined timing; and a behavior control unit that includes displaying the avatar in an image display region of the electronic equipment, in which the avatar behaviors include proposal of external data related to preference information of the user, and in a case where the behavior determination unit determines, as the behavior of the avatar, to propose the external data related to the preference information of the user, the behavior determination unit outputs the external data related to the preference information of the user, the external data being collected in advance.

In a fourteenth aspect of the disclosure, in a case where the behavior control unit determines, as the behavior of the avatar, to propose the external data related to the preference information of the user, the behavior control unit causes the avatar to have an appearance corresponding to the external data related to the preference information of the user, the external data being collected in advance.

In a fifteenth aspect of the disclosure, a behavior control system includes: a state recognition unit that recognizes a user state including a behavior of a user and a state of electronic equipment; an emotion determination unit that determines an emotion of the user or an emotion of an avatar representing an agent for having a dialogue with the user; a behavior determination unit that determines, as a behavior of the avatar, any one of a plurality of types of avatar behaviors including performing no operation by using at least one of the user state, the state of the electronic equipment, the emotion of the user, or the emotion of the avatar, and a behavior determination model at a predetermined timing; a storage control unit that stores, in history data, event data including an emotion value determined by the emotion determination unit and data including the behavior of the user; and a behavior control unit that displays the avatar in an image display region of the electronic equipment, in which the state recognition unit periodically recognizes the user state, the avatar behaviors include proposal of the behavior of the user, and in a case where the behavior determination unit determines, as the behavior of the avatar, to propose the behavior of the user, the behavior determination unit determines the behavior of the user to be proposed by using a text generation model based on event data.

In a sixteenth aspect of the disclosure, in a case where the behavior determination unit determines, as the behavior of the avatar, to transform the avatar into another avatar having a different appearance, the behavior determination unit causes the avatar to be transformed into the another avatar.

In a seventeenth aspect of the disclosure, a behavior control system includes: a state recognition unit that recognizes a user state including a behavior of a user and a state of electronic equipment; an emotion determination unit that determines an emotion of the user or an emotion of an avatar representing an agent for having a dialogue with the user; a behavior determination unit that determines, as a behavior of the avatar, any one of a plurality of types of avatar behaviors including performing no operation by using at least one of the user state, the state of the electronic equipment, the emotion of the user, or the emotion of the avatar, and a behavior determination model at a predetermined timing; a storage control unit that stores, in history data, event data including an emotion value determined by the emotion determination unit and data including the behavior of the user; and a behavior control unit that displays the avatar in an image display region of the electronic equipment, in which the avatar behaviors include proposal of an activity related to food and drink, and in a case where the behavior determination unit determines, as the behavior of the avatar, to propose the activity related to food and drink, the behavior determination unit causes the avatar to propose the activity related to food and drink.

In an eighteenth aspect of the disclosure, a behavior control system includes: a state recognition unit that recognizes a user state including a behavior of a user and a state of electronic equipment; an emotion determination unit that determines an emotion of the user or an emotion of an avatar representing an agent for having a dialogue with the user; a behavior determination unit that determines, as a behavior of the avatar, any one of a plurality of types of avatar behaviors including performing no operation by using at least one of the user state, the state of the electronic equipment, the emotion of the user, or the emotion of the avatar, and a behavior determination model at a predetermined timing; a storage control unit that stores, in history data, event data including an emotion value determined by the emotion determination unit and data including the behavior of the user; and a behavior control unit that displays the avatar in an image display region of the electronic equipment, in which the avatar behaviors include determination of a schedule of the user, and in a case where the behavior determination unit determines, as the behavior of the avatar, to propose the schedule, the behavior determination unit determines the schedule of the user to be proposed by using a text generation model based on event data stored in history data.

In a nineteenth aspect of the disclosure, in a case where it is determined that the schedule is a schedule that the user does not want to attend based on at least the user state and the emotion of the user, the behavior control unit determines, as the behavior of the avatar, to reject the schedule, and causes the avatar to make a notification of rejection.

In a twentieth aspect of the disclosure, a behavior control system includes: a state recognition unit that recognizes a user state including a behavior of a user and a state of electronic equipment; an emotion determination unit that determines an emotion of the user or an emotion of an avatar representing an agent for having a dialogue with the user; a behavior determination unit that determines, as a behavior of the avatar, any one of a plurality of types of avatar behaviors including performing no operation by using at least one of the user state, the state of the electronic equipment, the emotion of the user, or the emotion of the avatar, and a behavior determination model at a predetermined timing; a storage control unit that stores, in history data, event data including an emotion value determined by the emotion determination unit and data including the behavior of the user; and a behavior control unit that displays the avatar in an image display region of the electronic equipment, in which the avatar behaviors include having a conversation with another avatar, and in a case where the behavior determination unit determines, as the behavior of the avatar, to have a conversation with the another avatar, the behavior determination unit determines a conversation to be uttered by using a sentence generation model based on the event data stored in the history data.

In a twenty-first aspect of the disclosure, in a case where the behavior determination unit determines, as the behavior of the avatar, to have a conversation with the another avatar, the behavior determination unit determines the conversation to be uttered further based on a state of electronic equipment of another user or an emotion of the another avatar displayed on the electronic equipment of the another user.

In a twenty-second aspect of the disclosure, a behavior control system includes: a state recognition unit that recognizes a user state including a behavior of a user and a state of electronic equipment; an emotion determination unit that determines an emotion of the user or an emotion of an avatar representing an agent for having a dialogue with the user; a behavior determination unit that determines, as a behavior of the avatar, any one of a plurality of types of avatar behaviors including performing no operation by using at least one of the user state, the state of the electronic equipment, the emotion of the user, or the emotion of the avatar, and a behavior determination model at a predetermined timing; a storage control unit that stores, in history data, event data including an emotion value determined by the emotion determination unit and data including the behavior of the user; and a behavior control unit that displays the avatar in an image display region of the electronic equipment, in which the avatar behaviors include participation in a party, and in a case where the behavior determination unit determines, as the behavior of the avatar, to participate in the party, the behavior determination unit causes the avatar to participate in the party.

In a twenty-third aspect of the disclosure, the behavior control unit displays the avatar with a facial expression according to the emotion of the user or the emotion of the avatar.

In a twenty-fourth aspect of the disclosure, the behavior determination model is a data generation model configured to generate data according to input data, and the behavior determination unit inputs, to the data generation model, data representing at least one of the user state, the state of the electronic equipment, the emotion of the user, or the emotion of the avatar and data for inquiry about the avatar behavior, and determines the behavior of the avatar based on an output of the data generation model.

In a twenty-fifth aspect of the disclosure, the electronic equipment is a headset-type terminal.

In a twenty-sixth aspect of the disclosure, the electronic equipment is a glasses-type terminal.

Here, the avatar is implemented in software in a device that outputs a video or a voice without performing a physical operation.

### BRIEF DESCRIPTION OF DRAWINGS

FIG. 1 schematically shows an example of a system 5 according to a first embodiment.

FIG. 2 schematically shows a functional configuration of a robot 100 according to the first embodiment.

FIG. 3 schematically shows an example of an operation flow of collection processing performed by the robot 100 according to the first embodiment.

FIG. 4A schematically shows an example of an operation flow of response processing performed by the robot 100 according to the first embodiment.

FIG. 4B schematically shows an example of an operation flow of autonomous processing performed by the robot 100 according to the first embodiment.

FIG. 5 shows an emotion map 400 in which a plurality of emotions are mapped.

FIG. 6 shows an emotion map 900 in which a plurality of emotions are mapped.

FIG. 7(A) is an external view of a stuffed toy 100N according to a second embodiment, and FIG. 7(B) is an internal structural view of the stuffed toy 100N.

FIG. 8 is a rear view of the stuffed toy 100N according to the second embodiment.

FIG. 9 schematically shows a functional configuration of the stuffed toy 100N according to the second embodiment.

FIG. 10 schematically shows a functional configuration of an agent system 500 according to a third embodiment.

FIG. 11 shows an example of an operation of the agent system.

FIG. 12 shows an example of an operation of the agent system.

FIG. 13 schematically shows a functional configuration of an agent system 700 according to a fourth embodiment.

FIG. 14 shows an example of a usage aspect of the agent system in smart glasses.

FIG. 15 schematically shows a functional configuration of an agent system 800 according to a fifth embodiment.

FIG. 16 shows an example of a headset-type terminal.

FIG. 17 schematically shows an example of a hardware configuration of a computer 1200.

### DESCRIPTION OF EMBODIMENTS

Hereinafter, the present invention will be described through embodiments of the invention, but the following embodiments do not limit the invention according to the claims. In addition, not all combinations of features described in the embodiments are essential to the solution of the invention.

### First Embodiment

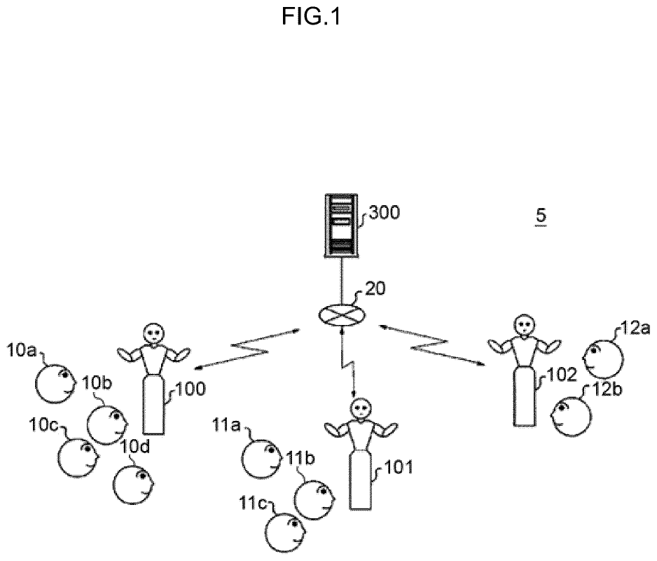

FIG. 1 schematically shows an example of a system 5 according to the present embodiment. The system 5 includes a robot 100, a robot 101, a robot 102, and a server 300. A user 10a, a user 10b, a user 10c, and a user 10d are users of the robot 100. A user 11a, a user 11b, and a user 11c are users of the robot 101. A user 12a and a user 12b are users of the robot 102. In the description of the present embodiment, the user 10a, the user 10b, the user 10c, and the user 10d may be collectively referred to as the user 10. Further, the user 11a, the user 11b, and the user 11c may be collectively referred to as the user 11. Further, the user 12a and the user 12b may be collectively referred to as the user 12. The robot 101 and the robot 102 have substantially the same functions as those of the robot 100. Therefore, the system 5 will be described focusing on the function of the robot 100.

The robot 100 has a conversation with the user 10 and provides a video to the user 10. At this time, the robot 100 has a conversation with the user 10, provides a video to the user 10, and the like in cooperation with the server 300 and the like that can perform communication via a communication network 20. For example, the robot 100 not only learns an appropriate conversation by itself, but also performs learning to have a more appropriate conversation with the user 10 in cooperation with the server 300. Further, the robot 100 causes the server 300 to record captured video data and the like of the user 10, requests the server 300 to transmit the video data and the like if necessary, and provides the video data and the like to the user 10.

Further, the robot 100 has an emotion value representing a type of an emotion thereof. For example, the robot 100 has the emotion value representing an intensity of each of emotions “joy”, “anger”, “sorrow”, “pleasure”, “comfort”, “discomfort”, “relief”, “anxiety”, “sadness”, “excitement”, “worry”, “reassurance”, “sense of fulfillment”, “sense of emptiness”, and “neutral”. For example, in the case of having a conversation with the user 10 in a state in which the emotion value of excitement is large, the robot 100 utters a speech at a high speed. As described above, the robot 100 can express the emotion thereof by a behavior.

Further, the robot 100 may be configured to determine a behavior of the robot 100 corresponding to an emotion of the user 10 by matching a text generation model and an emotion engine using an artificial intelligence (AI). Specifically, the robot 100 may be configured to recognize a behavior of the user 10, determine the emotion of the user 10 for the behavior of the user, and determine the behavior of the robot 100 corresponding to the determined emotion.

More specifically, in a case where the behavior of the user 10 is recognized, the robot 100 automatically generates a content of a behavior to be performed by the robot 100 for the behavior of the user 10 using the preset text generation model. The text generation model may be interpreted as an algorithm and operation for text-based automatic dialogue processing. Since the text generation model is known as disclosed in, for example, Japanese Patent Application Laid-Open No. 2018-081444 and ChatGPT (Internet search <URL: https://openai.com/blog/chatgpt>), a detailed description thereof is omitted. Such a text generation model is implemented by a large language model (LLM).

As described above, in the present embodiment, it is possible to reflect the emotions of the user 10 and the robot 100 and various types of linguistic information in the behavior of the robot 100 by combining the large language model and the emotion engine. That is, according to the present embodiment, a synergistic effect can be obtained by combining the text generation model and the emotion engine.

Further, the robot 100 has a function of recognizing the behavior of the user 10. The robot 100 recognizes the behavior of the user 10 by analyzing a face image of the user 10 acquired by a camera function and a speech of the user 10 acquired by a microphone function. The robot 100 determines a behavior to be performed by the robot 100 based on the recognized behavior of the user 10 or the like.

The robot 100 stores, as an example of a behavior determination model, a rule setting a behavior to be performed by the robot 100 based on the emotion of the user 10, the emotion of the robot 100, and the behavior of the user 10, and performs various behaviors according to the rule.

Specifically, the robot 100 has, as an example of the behavior determination model, a reaction rule for determining the behavior of the robot 100 based on the emotion of the user 10, the emotion of the robot 100, and the behavior of the user 10. In the reaction rule, for example, a behavior of “laughing” is set as the behavior of the robot 100 for a case where the behavior of the user 10 is “laughing”. Further, in the reaction rule, a behavior of “apologizing” is set as the behavior of the robot 100 for a case where the behavior of the user 10 is “getting angry”. Further, in the reaction rule, a behavior of “answering” is set as the behavior of the robot 100 for a case where the behavior of the user 10 is “asking a question”. In the reaction rule, a behavior of “calling out” is set as the behavior of the robot 100 for a case where the behavior of the user 10 is “being sad”.

In a case where the robot 100 recognizes that the behavior of the user 10 is “getting angry”, the robot 100 selects the behavior of “apologizing” set in the reaction rule as a behavior to be performed by the robot 100 based on the reaction rule. For example, in a case where the behavior of “apologizing” is selected, the robot 100 performs the behavior of “apologizing” and outputs a speech representing words of “apology”.

Further, in a case where a condition that the emotion of the robot 100 is “neutral” (that is, “joy”=0, “anger”=0, “sorrow”=0, and “pleasure”=0) and a state of the user 10 is “alone and looking lonely” is satisfied, a content of a change in the emotion of the robot 100 to “worried” is determined, and it is determined that the behavior of “calling out” can be performed.

In a case where the robot 100 recognizes that the current emotion of the robot 100 is “neutral” and the user 10 is alone and looks lonely, the emotion value of “sorrow” of the robot 100 is increased based on the reaction rule. Further, the robot 100 selects the behavior of “calling out” set in the reaction rule as a behavior to be performed for the user 10. For example, in a case where the behavior of “calling out” is selected, the robot 100 converts a phrase “What's wrong?” expressing that the robot 100 is worried into a sympathetic voice, and outputs the voice.

Further, the robot 100 transmits, to the server 300, user reaction information indicating that a positive reaction has been obtained from the user 10 for the behavior. Examples of the user reaction information include the user behavior of “getting angry”, the behavior of the robot 100 of “apologizing”, the positive reaction of the user 10, and an attribute of the user 10.

The server 300 stores the user reaction information received from the robot 100. The server 300 receives and stores the user reaction information not only from the robot 100 but also from each of the robot 101 and the robot 102. Then, the server 300 analyzes the user reaction information from the robot 100, the robot 101, and the robot 102, and updates the reaction rule.

The robot 100 receives the updated reaction rule from the server 300 by inquiring the server 300 about the updated reaction rule. The robot 100 incorporates the updated reaction rule into the reaction rule stored in the robot 100. As a result, the robot 100 can incorporate the reaction rule acquired by the robot 101, the robot 102, or the like into the reaction rule thereof.

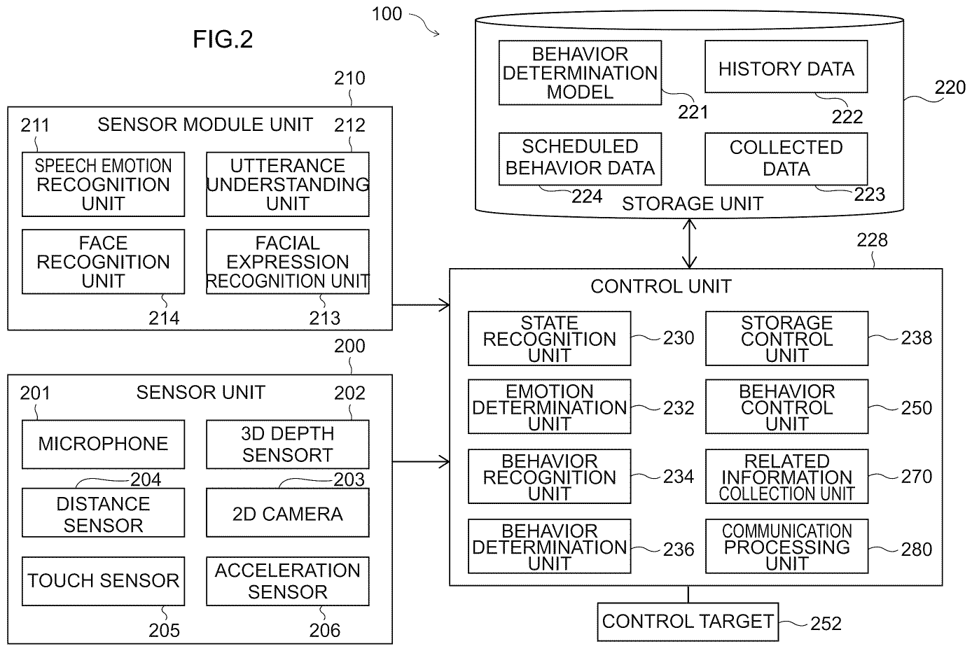

FIG. 2 schematically shows a functional configuration of the robot 100. The robot 100 includes a sensor unit 200, a sensor module unit 210, a storage unit 220, a control unit 228, and a control target 252. The control unit 228 includes a state recognition unit 230, an emotion determination unit 232, a behavior recognition unit 234, a behavior determination unit 236, a storage control unit 238, a behavior control unit 250, a related information collection unit 270, and a communication processing unit 280.

The control target 252 includes a display device, a speaker, a light emitting diode (LED) of an eye portion, motors that drive an arm, a hand, a foot, and the like, and the like. A posture and a gesture of the robot 100 are controlled by controlling the motors for the arm, the hand, the foot, and the like. Some emotions of the robot 100 can be expressed by controlling the motors. Furthermore, a facial expression of the robot 100 can be expressed by controlling a light emission state of the LED of the eye portion of the robot 100. The posture, the gesture and the facial expression of the robot 100 are examples of an attitude of the robot 100.

The sensor unit 200 includes a microphone 201, a 3D depth sensor 202, a 2D camera 203, a distance sensor 204, a touch sensor 205, and an acceleration sensor 206. The microphone 201 continuously detects a speech and outputs speech data. The microphone 201 may be provided at a head portion of the robot 100 and may have a function of performing binaural recording. The 3D depth sensor 202 detects an outline of an object by continuously radiating an infrared pattern and analyzing the infrared pattern based on an infrared image continuously captured by an infrared camera. The 2D camera 203 is an example of an image sensor. The 2D camera 203 performs imaging with visible light and generates video information of visible light. The distance sensor 204 detects a distance to an object by emitting, for example, a laser beam or an ultrasonic wave. The sensor unit 200 may further include a clock, a gyro sensor, a sensor for motor feedback, and the like.

Among the components of the robot 100 shown in FIG. 2, the components other than the control target 252 and the sensor unit 200 are examples of components included in a behavior control system included in the robot 100. The behavior control system of the robot 100 controls the control target 252.

The storage unit 220 includes a behavior determination model 221, history data 222, collected data 223, and scheduled behavior data 224. The history data 222 includes a history of the past emotion value of a user 10, the past emotion value of the robot 100, and behaviors, and specifically includes a plurality of pieces of event data including an emotion value of the user 10, an emotion value of the robot 100, and the behavior of the user 10. Data including the behavior of the user 10 includes a camera image representing the behavior of the user 10. The history of the emotion value and the behavior is recorded for each user 10 by being associated with identification information of the user 10, for example. At least a part of the storage unit 220 is implemented by a storage medium such as a memory. A person DB that stores the face image of the user 10, attribute information of the user 10, and the like may be included. Among the components of the robot 100 shown in FIG. 2, functions of the components other than the control target 252, the sensor unit 200, and the storage unit 220 can be implemented by a central processing unit (CPU) operating based on a program. For example, the functions of the components can be implemented as an operation of the CPU by basic software (OS) and a program operating on the OS.

The sensor module unit 210 includes a speech emotion recognition unit 211, an utterance understanding unit 212, a facial expression recognition unit 213, and a face recognition unit 214. Information detected by the sensor unit 200 is input to the sensor module unit 210. The sensor module unit 210 analyzes the information detected by the sensor unit 200 and outputs an analysis result to the state recognition unit 230.

The speech emotion recognition unit 211 of the sensor module unit 210 analyzes the speech of the user 10 detected by the microphone 201 to recognize the emotion of the user 10. For example, the speech emotion recognition unit 211 extracts a feature amount such as a frequency component of a speech and recognizes the emotion of the user 10 based on the extracted feature amount. The utterance understanding unit 212 analyzes the speech of the user 10 detected by the microphone 201 and outputs text information indicating an utterance content of the user 10.

The facial expression recognition unit 213 recognizes a facial expression of the user 10 and the emotion of the user 10 from an image of the user 10 captured by the 2D camera 203. For example, the facial expression recognition unit 213 recognizes the facial expression and the emotion of the user 10 based on shapes, positional relationships, and the like of the eyes and the mouth.

The face recognition unit 214 recognizes the face of the user 10. The face recognition unit 214 recognizes the user 10 by matching a face image stored in the person DB (not shown) with the face image of the user 10 captured by the 2D camera 203.

The state recognition unit 230 recognizes the state of the user 10 based on the information analyzed by the sensor module unit 210. For example, processing mainly related to perception is performed using an analysis result of the sensor module unit 210. For example, perception information such as “Dad is alone” and “There is a 90% probability that dad is not smiling” is generated. Processing of understanding the meaning of the generated perception information is performed. For example, semantic information such as “Dad is alone and looks lonely” is generated.

The state recognition unit 230 recognizes a state of the robot 100 based on the information detected by the sensor unit 200. For example, the state recognition unit 230 recognizes a remaining battery level of the robot 100, a brightness of a surrounding environment of the robot 100, and the like as the state of the robot 100.

The emotion determination unit 232 determines an emotion value indicating the emotion of the user 10 based on the information analyzed by the sensor module unit 210 and the state of the user 10 recognized by the state recognition unit 230. For example, the emotion value indicating the emotion of the user 10 is acquired by inputting the information analyzed by the sensor module unit 210 and the recognized state of the user 10 to a neural network trained in advance.

Here, the emotion value indicating the emotion of the user 10 is a value indicating whether the emotion of the user is positive or negative. For example, the emotion value has a positive value in a case where the emotion of the user is a bright emotion accompanied by pleasure or a sense of calm, such as “joy”, “pleasure”, “comfort”, “relief”, “excitement”, “reassurance”, or “sense of fulfillment”, and the emotion value becomes larger as the emotion becomes brighter. The emotion value has a negative value in a case where the emotion of the user is an unpleasant emotion such as “anger”, “sorrow”, “discomfort”, “anxiety”, “sadness”, “worry”, or “sense of emptiness”, and the more unpleasant the emotion is, the larger the absolute value of the negative value becomes. In a case where the emotion of the user is not any of the above (“neutral”), the emotion value has a value of 0.

Further, the emotion determination unit 232 determines an emotion value indicating the emotion of the robot 100 based on the information analyzed by the sensor module unit 210, the information detected by the sensor unit 200, and the state of the user 10 recognized by the state recognition unit 230.

The emotion value of the robot 100 includes an emotion value for each of a plurality of emotion classifications, and is, for example, a value (0 to 5) indicating an intensity of each of “joy”, “anger”, “sorrow”, and “pleasure”.

Specifically, the emotion determination unit 232 determines the emotion value indicating the emotion of the robot 100 according to a rule for updating the emotion value of the robot 100, the rule being set in association with the information analyzed by the sensor module unit 210 and the state of the user 10 recognized by the state recognition unit 230.

For example, in a case where the state recognition unit 230 recognizes that the user 10 looks lonely, the emotion determination unit 232 increases the emotion value of “sorrow” of the robot 100. Furthermore, in a case where the state recognition unit 230 recognizes that the user 10 is smiling, the emotion determination unit 232 increases the emotion value of “joy” of the robot 100.

The emotion determination unit 232 may determine the emotion value indicating the emotion of the robot 100 in further consideration of the state of the robot 100. For example, in a case where the remaining battery level of the robot 100 is low, a case where the surrounding environment of the robot 100 is dark, or the like, the emotion determination unit 232 may increase the emotion value of “sorrow” of the robot 100. Furthermore, in the case of the user 10 who continues to speak to the robot 100 despite the low remaining battery level, the emotion determination unit 232 may increase the emotion value of “anger”.

The behavior recognition unit 234 recognizes the behavior of the user 10 based on the information analyzed by the sensor module unit 210 and the state of the user 10 recognized by the state recognition unit 230. For example, a probability of each of a plurality of predetermined behavior classifications (for example, “laughing”, “getting angry”, “asking a question”, and “being sad”) is acquired by inputting the information analyzed by the sensor module unit 210 and the recognized state of the user 10 to the neural network trained in advance, and a behavior classification having the highest probability is recognized as the behavior of the user 10.

As described above, in the present embodiment, the robot 100 acquires the utterance content of the user 10 after specifying the user 10, but in acquiring and using the utterance content, the behavior control system of the robot 100 according to the present embodiment considers protection of personal information and privacy of the user 10 in addition to acquisition of necessary consent according to laws and regulations from the user 10.

Next, processing performed by the behavior determination unit 236 in a case where the robot 100 performs response processing of responding to the behavior of the user 10 will be described.

The behavior determination unit 236 determines a behavior corresponding to the behavior of the user 10 recognized by the behavior recognition unit 234, based on the current emotion value of the user 10 determined by the emotion determination unit 232, the history data 222 of the past emotion value determined by the emotion determination unit 232 before the current emotion value of the user 10 is determined, and the emotion value of the robot 100. In the present embodiment, a case where the behavior determination unit 236 uses one most recent emotion value included in the history data 222 as the past emotion value of the user 10 is described, but the disclosed technology is not limited to such an aspect. For example, the behavior determination unit 236 may use a plurality of most recent emotion values as the past emotion values of the user 10, or may use emotion values from a unit period earlier, such as one day ago, as the past emotion values of the user 10. Further, the behavior determination unit 236 may determine the behavior corresponding to the behavior of the user 10 in further consideration of the history of the past emotion value of the robot 100 in addition to the current emotion value of the robot 100. The behavior determined by the behavior determination unit 236 includes the gesture made by the robot 100 or an utterance content of the robot 100.

The behavior determination unit 236 according to the present embodiment determines, as the behavior corresponding to the behavior of the user 10, the behavior of the robot 100 based on a combination of the past emotion value and the current emotion value of the user 10, the emotion value of the robot 100, the behavior of the user 10, and the behavior determination model 221. For example, in a case where the past emotion value of the user 10 is a positive value and the current emotion value is a negative value, the behavior determination unit 236 determines a behavior for positively changing the emotion value of the user 10 as the behavior corresponding to the behavior of the user 10.

In a reaction rule as the behavior determination model 221, the behavior of the robot 100 based on a combination of the past emotion value and the current emotion value of the user 10, the emotion value of the robot 100, and the behavior of the user 10 is set. For example, a combination of a gesture and an utterance content when encouraging the user 10 with a gesture is set as the behavior of the robot 100 in a case where the past emotion value of the user 10 is a positive value, the current emotion value is a negative value, and the behavior of the user 10 is being sad.

For example, in the reaction rule as the behavior determination model 221, behaviors of the robot 100 are set for all combinations of patterns of the emotion value of the robot 100 (1296 patterns which correspond to the fourth power of six values of “0” to “5” of “joy”, “anger”, “sorrow”, and “pleasure”), patterns of a combination of the past emotion value and the current emotion value of the user 10, and a behavior pattern of the user 10. That is, for each pattern of the emotion value of the robot 100, the behavior of the robot 100 based on the behavior pattern of the user 10 is determined for each of a plurality of combinations of the past emotion value and the current emotion value of the user 10, such as a combination of a negative value and a negative value, a combination of a negative value and a positive value, a combination of a positive value and a negative value, a combination of a positive value and a positive value, a combination of a negative value and a value indicating the neutral emotion, and a combination of a value indicating the neutral emotion and a value indicating the neutral emotion. The behavior determination unit 236 may transition to an operation mode of determining the behavior of the robot 100 by using the history data 222, for example, in a case where the user 10 has made an utterance that intends to continue a conversation of the past topic, such as “I want to talk about the topic we discussed earlier”.

In the reaction rule as the behavior determination model 221, at least one of a gesture or a statement content may be set as the behavior of the robot 100 for each pattern (1296 patterns) of the emotion value of the robot 100, with at most one behavior per pattern. Alternatively, in the reaction rule as the behavior determination model 221, at least one of the gesture or the statement content may be set as the behavior of the robot 100 for each group of the patterns of the emotion values of the robot 100.

An intensity of each gesture included in the behavior of the robot 100 and set in the reaction rule as the behavior determination model 221 is set in advance. An intensity of each utterance content included in the behavior of the robot 100 set in the reaction rule as the behavior determination model 221 is set in advance.

The storage control unit 238 determines whether or not to store data including the behavior of the user 10 in the history data 222 based on a predetermined behavior intensity for the behavior determined by the behavior determination unit 236 and the emotion value of the robot 100 determined by the emotion determination unit 232.

Specifically, in a case where the total sum of the emotion values of the plurality of emotion classifications of the robot 100 and a total intensity value, which is the sum of the predetermined intensity for the gesture included in the behavior determined by the behavior determination unit 236 and the predetermined intensity for the utterance content included in the behavior determined by the behavior determination unit 236, are equal to or larger than thresholds, the storage control unit 238 determines to store the data including the behavior of the user 10 in the history data 222.

In a case where the storage control unit 238 determines to store the data including the behavior of the user 10 in the history data 222, the behavior determined by the behavior determination unit 236, the information (for example, any surrounding information such as data such as a sound, an image, and a scent at that time) analyzed by the sensor module unit 210 over a certain period prior to the current time point, and the state (for example, the facial expression or emotion of the user 10) of the user 10 recognized by the state recognition unit 230 are stored in the history data 222.

The behavior control unit 250 controls the control target 252 based on the behavior determined by the behavior determination unit 236. For example, in a case where the behavior determination unit 236 determines a behavior including an utterance, the behavior control unit 250 causes the speaker included in the control target 252 to output a speech. At this time, the behavior control unit 250 may determine an utterance speed of the speech based on the emotion value of the robot 100. For example, the behavior control unit 250 determines a higher utterance speed as the emotion value of the robot 100 is larger. In this manner, the behavior control unit 250 determines an execution mode of the behavior determined by the behavior determination unit 236 based on the emotion value determined by the emotion determination unit 232.

The behavior control unit 250 may recognize a change in the emotion of the user 10 for execution of the behavior determined by the behavior determination unit 236. For example, the change in the emotion may be recognized based on the speech or facial expression of the user 10. In addition, the change in the emotion of the user 10 may be recognized based on detection of an impact applied to the touch sensor 205 included in the sensor unit 200. In a case where an impact is detected by the touch sensor 205 included in the sensor unit 200, it may be recognized that the emotion of the user 10 has become worse, and in a case where it is determined that the reaction of the user 10 is smiling or being happy based on a detection result of the touch sensor 205 included in the sensor unit 200, it may be recognized that the emotion of the user 10 has been improved. Information indicating the reaction of the user 10 is output to the communication processing unit 280.

Further, after the behavior control unit 250 performs the behavior determined by the behavior determination unit 236 in the execution mode determined according to the emotion of the robot 100, the emotion determination unit 232 further changes the emotion value of the robot 100 based on the reaction of the user for the execution of the behavior. Specifically, the emotion determination unit 232 increases the emotion value of “joy” of the robot 100 in a case where the reaction of the user for the behavior determined by the behavior determination unit 236 and performed for the user in the execution mode determined by the behavior control unit 250 is not negative. Further, the emotion determination unit 232 increases the emotion value of “sorrow” of the robot 100 in a case where the reaction of the user for the behavior determined by the behavior determination unit 236 and performed for the user in the execution mode determined by the behavior control unit 250 is negative.

Furthermore, the behavior control unit 250 expresses the emotion of the robot 100 based on the determined emotion value of the robot 100. For example, in a case where the emotion value of “joy” of the robot 100 is increased, the behavior control unit 250 controls the control target 252 to cause the robot 100 to make a joyful gesture. Further, in a case where the emotion value of “sorrow” of the robot 100 is increased, the behavior control unit 250 controls the control target 252 such that the posture of the robot 100 becomes a drooping posture.

The communication processing unit 280 is responsible for communication with the server 300. As described above, the communication processing unit 280 transmits the user reaction information to the server 300. Further, the communication processing unit 280 receives the updated reaction rule from the server 300. In a case where the updated reaction rule is received from the server 300, the communication processing unit 280 updates the reaction rule as the behavior determination model 221.

The server 300 performs communication between the server 300 and the robot 100, the robot 101, and the robot 102, receives the user reaction information transmitted from the robot 100, and updates the reaction rule based on a reaction rule including a behavior for which a positive reaction has been obtained.

The related information collection unit 270 collects information related to preference information from external data (websites such as news sites and moving image sites) based on the preference information acquired for the user 10 at a predetermined timing.

Specifically, the related information collection unit 270 acquires the preference information indicating matters of interest to the user 10 from the utterance content of the user 10 or a setting operation performed by the user 10. The related information collection unit 270 collects news related to the preference information from the external data at regular intervals by using, for example, ChatGPT plugins (Internet search <URL: https://openai.com/blog/chatgpt-plugins>). For example, in a case where information indicating that the user 10 is a fan of a specific professional baseball team is acquired as the preference information, the related information collection unit 270 collects news related to a game result of the specific professional baseball team from the external data at a predetermined time every day, for example, using ChatGPT plugins.

The emotion determination unit 232 determines the emotion of the robot 100 based on the information related to the preference information, which is collected by the related information collection unit 270.

Specifically, the emotion determination unit 232 determines the emotion of the robot 100 by inputting a text representing the information related to the preference information, which is collected by the related information collection unit 270, to the neural network trained in advance for emotion determination, and acquiring the emotion value indicating each emotion. For example, in a case where the collected news related to the game result of the specific professional baseball team indicates that the specific professional baseball team has won, determination is made so as to increase the emotion value of “joy” of the robot 100.

In a case where the emotion value of the robot 100 is equal to or larger than a threshold, the storage control unit 238 stores the information related to the preference information, which is collected by the related information collection unit 270, in the collected data 223.

Next, processing performed by the behavior determination unit 236 and the like in a case where the robot 100 performs autonomous processing of autonomously performing a behavior will be described.

The robot 100 (agent) has a mind (or behaves as if the robot 100 has a mind) and autonomously (spontaneously) and periodically checks a health condition of the user 10. More specifically, the behavior determination unit 236 detects a parameter representing the health condition of the user 10 autonomously and periodically via the sensor unit 200. Examples of the parameter representing the health condition of the user 10 include an inflection of a conversation of the user 10, a complexion of the user 10, trembling of a hand of the user 10, a body temperature of the user 10 measured by a thermo sensor, a respiratory rate of the user 10, a heart rate of the user 10, a sleep duration of the user 10, and the number of times the user 10 has entered a toilet. Furthermore, in a case where the user 10 wears a wearable device having a function of measuring a blood pressure, a blood glucose level, and the like, it is also possible to acquire the blood pressure, the blood glucose level, and the like of the user 10 by performing wireless communication with the wearable device. The detected parameter representing the health condition of the user 10 is stored in time series as the history data 222 by the storage control unit 238.

Furthermore, the behavior determination unit 236 checks the health condition of the user 10 by using the behavior determination model 221 based on the parameter representing the health condition of the user 10 stored in time series as the history data 222 (determines whether or not to speak to the user 10 or to provide a medication recommendation to the user 10). Then, the behavior determination unit 236 autonomously speaks to the user 10 to watch over the user 10 as necessary to autonomously concern the health of the user 10, autonomously determines a symptom of the user 10 without being asked by the user 10, and recommends that the user 10 takes appropriate medication if necessary.

The behavior determination unit 236 determines, as the behavior of the robot 100, any one of a plurality of types of robot behaviors including performing no operation by using at least one of the state of the user 10, the emotion of the user 10, the emotion of the robot 100, or the state of the robot 100, and the behavior determination model 221 at a predetermined timing. Here, a case where the text generation model having a dialogue function is used as the behavior determination model 221 will be described as an example.

Specifically, the behavior determination unit 236 inputs a text representing at least one of the state of the user 10, the emotion of the user 10, the emotion of the robot 100, or the state of the robot 100 and a text for inquiry about the robot behavior to the text generation model, and determines the behavior of the robot 100 based on an output of the text generation model.

For example, the plurality of types of robot behaviors include the following behaviors (1) to (11).
(1) The robot does nothing.
(2) The robot dreams.
(3) The robot speaks to the user.
(4) The robot creates a picture diary.
(5) The robot proposes an activity.
(6) The robot proposes a person the user should meet.
(7) The robot introduces news that the user is interested in.
(8) The robot edits pictures and moving images.
(9) The robot studies with the user.
(10) The robot recalls memory.
(11) The robot provides advice on health to the user.

The behavior determination unit 236 inputs, to the text generation model, a text representing the state of the user 10 and the state of the robot 100 that are recognized by the state recognition unit 230, and the current emotion value of the user 10 and the current emotion value of the robot 100 that are determined by the emotion determination unit 232, and a text for inquiry about any one of the plurality of types of robot behaviors including performing no operation, every lapse of a certain period of time, and determines the behavior of the robot 100 based on an output of the text generation model. Here, in a case where the user 10 is absent around the robot 100, a text to be input to the text generation model need not include the state of the user 10 and the current emotion value of the user 10, or may include information indicating that the user 10 is absent.

As an example, the following text is input to the text generation model:
“The robot is in a very pleasant state. The user is in a normally pleasant state. The user is sleeping. Among the following behaviors (1) to (11), which behavior is appropriate for the robot?
(1) The robot does nothing.
(2) The robot dreams.
(3) The robot speaks to the user.
. . . ”. Based on an output of the text generation model stating that “(1) the robot does nothing or (2) the robot dreams can be considered to be the most appropriate behavior”, the behavior “(1) the robot does nothing” or the behavior “(2) the robot dreams” is determined as the behavior of the robot 100.

As another example, the following text is input to the text generation model:
“The robot is in a slightly lonely state. The user is absent. The surroundings of the robot are dark. Among the following behaviors (1) to (11), which behavior is appropriate for the robot?
(1) The robot does nothing.
(2) The robot dreams.
(3) The robot speaks to the user.
. . . ”. Based on an output of the text generation model stating that “(2) The robot dreams or (4) the robot creates a picture diary can be considered to be the most appropriate behavior”, the behavior “(2) The robot dreams” or the behavior “(4) The robot creates a picture diary” is determined as the behavior of the robot 100.

In a case where the behavior determination unit 236 determines, as the robot behavior, the behavior “(2) The robot dreams”, that is, creation of an original event, the behavior determination unit 236 creates the original event obtained by combining a plurality of pieces of event data in history data 222 by using the text generation model. At this time, the storage control unit 238 stores the created original event in the history data 222.

In a case where the behavior determination unit 236 determines, as the robot behavior, the behavior “(3) The robot speaks to the user”, that is, utterance by the robot 100, the behavior determination unit 236 determines the utterance content of the robot, which corresponds to the state of the user and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(7) The robot introduces news that the user is interested in”, the behavior determination unit 236 determines the utterance content of the robot, which corresponds to information stored in the collected data 223, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(4) The robot creates a picture diary”, that is, creation of an event image by the robot 100, the behavior determination unit 236 generates an image representing event data selected from the history data 222 by using an image generation model, generates an explanatory sentence representing the event data by using the text generation model, and outputs a combination of the image representing the event data and the explanatory sentence representing the event data as the event image. In a case where the user 10 is absent around the robot 100, the behavior control unit 250 stores the event image in the scheduled behavior data 224 without outputting the event image.

In a case where the behavior determination unit 236 determines, as the robot behavior, the behavior “(8) The robot edits pictures and moving images”, that is, image edition, the behavior determination unit 236 selects event data from the history data 222 based on the emotion value, edits image data of the selected event data, and outputs the edited image data. In a case where the user 10 is absent around the robot 100, the behavior control unit 250 stores the edited image data in the scheduled behavior data 224 without outputting the edited image data.

In a case where the behavior determination unit 236 determines, as the robot behavior, the behavior “(5) The robot proposes an activity”, that is, proposal of the behavior of the user 10, the behavior determination unit 236 determines the behavior of the user to be proposed by using the text generation model based on the event data stored in the history data 222. At this time, the behavior control unit 250 causes the speaker included in the control target 252 to output a speech for proposing the behavior of the user. In a case where the user 10 is absent around the robot 100, the behavior control unit 250 stores the proposal of the behavior of the user in the scheduled behavior data 224 without outputting the speech for proposing the behavior of the user.

In a case where the behavior determination unit 236 determines, as the robot behavior, the behavior “(6) The robot proposes a person the user should meet”, that is, proposal of a person the user 10 should connect with, the behavior determination unit 236 determines a person to be proposed as the person the user should connect with by using the text generation model based on the event data stored in the history data 222. At this time, the behavior control unit 250 causes the speaker included in the control target 252 to output a speech representing the proposal of a person the user should connect with. In a case where the user 10 is absent around the robot 100, the behavior control unit 250 stores the proposal of a person the user should connect with in the scheduled behavior data 224 without outputting the speech representing the proposal of a person the user should connect with.

In a case where the behavior determination unit 236 determines, as the robot behavior, the behavior “(9) The robot studies with the user”, that is, utterance by the robot 100 about study, the behavior determination unit 236 determines the utterance content of the robot for encouraging study, posing questions, or providing study-related advice, which corresponds to the user state and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(10) The robot recalls memory”, that is, recalling of the event data, the behavior determination unit 236 selects the event data from the history data 222. At this time, the emotion determination unit 232 determines the emotion of the robot 100 based on the selected event data. Furthermore, the behavior determination unit 236 creates an emotion changing event representing the utterance content or behavior of the robot 100 for changing the emotion value of the user by using the text generation model based on the selected event data. At this time, the storage control unit 238 stores the emotion changing event in the scheduled behavior data 224.

For example, in a case where information indicating that a moving image the user was watching was related to a panda is stored in the history data 222 as the event data, and the event data is selected, a prompt like “What are three things the robot could say the next time the robot meets the user, based on the topic of pandas?” is input to the text generation model, in a case where an output of the text generation model is “(1) Let's go to the zoo, (2) Let's draw a picture of a panda, and (3) Let's go buy a panda-shaped stuffed toy”, the robot 100 inputs a prompt like “Which of (1), (2), or (3) is most likely to make the user happiest?” to the text generation model, and in a case where an output of the text generation model is “(1) Let's go to the zoo”, uttering “(1) Let's go to the zoo” by the robot 100 when the robot 100 meets the user next is created as the emotion changing event and stored in the scheduled behavior data 224.

Further, for example, event data having a large emotion value of the robot 100 is selected as an impressive memory of the robot 100. As a result, it is possible to create the emotion changing event based on the event data selected as the impressive memory.

In a case where the behavior determination unit 236 determines, as the robot behavior, “(11) The robot provides advice on health to the user”, that is, utterance by the robot 100 about the health of the user 10, the behavior determination unit 236 checks the health condition of the user 10 by inputting, to the text generation model, the parameter representing the health condition of the user 10, which is stored in time series as the history data 222, and determines the utterance content of the robot regarding the health condition of the user 10. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

As an example, the behavior determination unit 236 inputs, to the text generation model, a text “The parameter representing the health condition of the user indicates that the body temperature of the user has changed as T1 (t1), T2 (t2), and T3 (t3). Which of the following behaviors (11a) to (11c) is appropriate as the behavior of the robot?
(11a) The robot does nothing.
(11b) The robot speaks to the user with words expressing concern for the condition.
(11c) The robot recommends that the user takes medication”.

Here, in a case where an output of the text generation model is “It can be said that the behavior of (11b) speaking to the user with words expressing concern for the condition and the behavior of (11c) recommending that the user takes medication are appropriate behaviors”, the behavior determination unit 236 determines, as the behaviors of the robot 100, the behavior of “(11b) speaking to the user with words expressing concern for the condition” and the behavior of “(11c) recommending that the user takes medication” based on the output. Furthermore, in a case where the output of the text generation model includes the behavior of “(11c) recommending that the user takes medication” as described above, the behavior determination unit 236 further inputs a text such as “What medication should be recommended to the user?” to the text generation model. Here, in a case where the output of the text generation model is “The medication recommended to the user is X”, the behavior determination unit 236 determines, as the behavior of the robot 100, an utterance “I recommend taking medication X” based on the output.

Furthermore, for the behavior “(11) The robot provides advice on health to the user”, the storage control unit 238 stores the parameter representing the health condition of the user 10 detected autonomously and periodically as the time-series history data 222.

In the above example, an aspect in which it is determined to provide advice on health to the user in a case where the output of the text generation model is a content of recommending the behavior “(11) The robot provides advice on health to the user” has been described. However, the disclosure is not limited thereto, and the behavior determination unit 236 may autonomously check the health condition of the user 10 based on the parameter representing the health condition of the user 10, and may determine to provide advice on health to the user in a case where it is determined that there is a certain abnormality in the health condition of the user 10. The health condition of the user 10 may be autonomously checked, for example, by comparing the detected parameter representing the health condition of the user 10 with a preset threshold, or by inputting the detected parameter representing the health condition of the user 10 to the neural network trained in advance and acquiring an evaluation value for evaluating the health condition of the user 10.

In a case where the behavior of the user 10 for the robot 100 is detected following a state in which the user 10 does nothing for the robot 100 based on the state of the user 10 recognized by the state recognition unit 230, the behavior determination unit 236 reads data stored in the scheduled behavior data 224 and determines the behavior of the robot 100.

For example, in a case where the user 10 is absent around the robot 100, the behavior determination unit 236 reads data stored in the scheduled behavior data 224 and determines the behavior of the robot 100 in response to detection of the user 10. In addition, in a case where the user 10 is sleeping, the behavior determination unit 236 reads data stored in the scheduled behavior data 224 and determines the behavior of the robot 100 in response to the user 10 waking up.

### First Other Example

A first other example of the processing performed by the behavior determination unit 236 in a case where the robot 100 performs the autonomous processing of autonomously performing a behavior will be described.

In the autonomous processing in the present embodiment, the robot 100 spontaneously and periodically detects the state of the user 10. For example, the robot 100 constantly detects a hobby, a preference, or the like of the user 10, and proposes to go to an art gallery, a museum, or the like according to a holiday of the user 10 in a case where the hobby of the user 10 relates to an art gallery, a museum, an exhibition, or the like. Furthermore, in a case where the user 10 goes to an art gallery or a museum, the robot 100 selects an exhibit matching a liking or preference of the user 10, and functions as an agent who has a conversation while having fun together by explaining the exhibit.

The behavior determination unit 236 determines, as the behavior of the robot 100, any one of a plurality of types of robot behaviors including performing no operation by using at least one of the state of the user 10, the emotion of the user 10, the emotion of the robot 100, or the state of the robot 100, and the behavior determination model 221 at a predetermined timing. Here, a case where the text generation model having the dialogue function is used as the behavior determination model 221 will be described as an example.

Specifically, the behavior determination unit 236 inputs a text representing at least one of the state of the user 10, the emotion of the user 10, the emotion of the robot 100, or the state of the robot 100 and a text for inquiry about the robot behavior to the text generation model, and determines the behavior of the robot 100 based on an output of the text generation model.

For example, the plurality of types of robot behaviors include the following behaviors (1) to (12).
(1) The robot does nothing.
(2) The robot dreams.
(3) The robot speaks to the user.
(4) The robot creates a picture diary.
(5) The robot proposes an activity.
(6) The robot proposes a person the user should meet.
(7) The robot introduces news that the user is interested in.
(8) The robot edits pictures and moving images.
(9) The robot studies with the user.
(10) The robot recalls memory.
(11) The robot proposes an art gallery, a museum, and an exhibition that the user should visit.
(12) The robot introduces an event that the user should participate in.

The behavior determination unit 236 inputs, to the text generation model, a text representing the state of the user 10 and the state of the robot 100 that are recognized by a state recognition unit 230, and the current emotion value of the user 10 and the current emotion value of the robot 100 that are determined by the emotion determination unit 232, and a text for inquiry about any one of the plurality of types of robot behaviors including performing no operation, every lapse of a certain period of time, and determines the behavior of the robot 100 based on an output of the text generation model. Here, in a case where the user 10 is absent around the robot 100, a text to be input to the text generation model need not include the state of the user 10 and the current emotion value of the user 10, or may include information indicating that the user 10 is absent.

As an example, the following text is input to the text generation model:
“The robot is in a very pleasant state. The user is in a normally pleasant state. The user is sleeping. Among the following behaviors (1) to (12), which behavior is appropriate for the robot?
(1) The robot does nothing.
(2) The robot dreams.
(3) The robot speaks to the user.
. . . ”. Based on an output of the text generation model stating that “(1) the robot does nothing or (2) the robot dreams can be considered to be the most appropriate behavior”, the behavior “(1) the robot does nothing” or the behavior “(2) the robot dreams” is determined as the behavior of the robot 100.

As another example, the following text is input to the text generation model:
“The robot is in a slightly lonely state. The user is absent. The surroundings of the robot are dark. Among the following behaviors (1) to (12), which behavior is appropriate for the robot?
(1) The robot does nothing.
(2) The robot dreams.
(3) The robot speaks to the user.
. . . ”. Based on an output of the text generation model stating that “(2) The robot dreams or (4) the robot creates a picture diary can be considered to be the most appropriate behavior”, the behavior “(2) The robot dreams” or the behavior “(4) The robot creates a picture diary” is determined as the behavior of the robot 100.

In a case where the behavior determination unit 236 determines, as the robot behavior, the behavior “(2) The robot dreams”, that is, creation of an original event, the behavior determination unit 236 creates the original event obtained by combining a plurality of pieces of event data in history data 222 by using the text generation model. At this time, the storage control unit 238 stores the created original event in the history data 222.

In a case where the behavior determination unit 236 determines, as the robot behavior, the behavior “(3) The robot speaks to the user”, that is, utterance by the robot 100, the behavior determination unit 236 determines the utterance content of the robot, which corresponds to the state of the user and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(7) The robot introduces news that the user is interested in”, the behavior determination unit 236 determines the utterance content of the robot, which corresponds to information stored in the collected data 223, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(4) The robot creates a picture diary”, that is, creation of an event image by the robot 100, the behavior determination unit 236 generates an image representing event data selected from the history data 222 by using the image generation model, generates an explanatory sentence representing the event data by using the text generation model, and outputs a combination of the image representing the event data and the explanatory sentence representing the event data as the event image. In a case where the user 10 is absent around the robot 100, the behavior control unit 250 stores the event image in the scheduled behavior data 224 without outputting the event image.

In a case where the behavior determination unit 236 determines, as the robot behavior, the behavior “(8) The robot edits pictures and moving images”, that is, image edition, the behavior determination unit 236 selects event data from the history data 222 based on the emotion value, edits image data of the selected event data, and outputs the edited image data. In a case where the user 10 is absent around the robot 100, the behavior control unit 250 stores the edited image data in the scheduled behavior data 224 without outputting the edited image data.

In a case where the behavior determination unit 236 determines, as the robot behavior, the behavior “(5) The robot proposes an activity”, that is, proposal of the behavior of the user 10, the behavior determination unit 236 determines the behavior of the user to be proposed by using the text generation model based on the event data stored in the history data 222. At this time, the behavior control unit 250 causes the speaker included in the control target 252 to output a speech for proposing the behavior of the user. In a case where the user 10 is absent around the robot 100, the behavior control unit 250 stores the proposal of the behavior of the user in the scheduled behavior data 224 without outputting the speech for proposing the behavior of the user.

In a case where the behavior determination unit 236 determines, as the robot behavior, the behavior “(6) The robot proposes a person the user should meet”, that is, proposal of a person the user 10 should connect with, the behavior determination unit 236 determines a person to be proposed as the person the user should connect with by using the text generation model based on the event data stored in the history data 222. At this time, the behavior control unit 250 causes the speaker included in the control target 252 to output a speech representing the proposal of a person the user should connect with. In a case where the user 10 is absent around the robot 100, the behavior control unit 250 stores the proposal of a person the user should connect with in the scheduled behavior data 224 without outputting the speech representing the proposal of a person the user should connect with.

In a case where the behavior determination unit 236 determines, as the robot behavior, the behavior “(9) The robot studies with the user”, that is, utterance by the robot 100 about study, the behavior determination unit 236 determines the utterance content of the robot for encouraging study, posing questions, or providing study-related advice, which corresponds to the user state and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(10) The robot recalls memory”, that is, recalling of the event data, the behavior determination unit 236 selects the event data from the history data 222. At this time, the emotion determination unit 232 determines the emotion of the robot 100 based on the selected event data. Furthermore, the behavior determination unit 236 creates an emotion changing event representing the utterance content or behavior of the robot 100 for changing the emotion value of the user by using the text generation model based on the selected event data. At this time, the storage control unit 238 stores the emotion changing event in the scheduled behavior data 224.

For example, in a case where information indicating that a moving image the user was watching was related to a panda is stored in the history data 222 as the event data, and the event data is selected, a prompt like “What are three things the robot could say the next time the robot meets the user, based on the topic of pandas?” is input to the text generation model, in a case where an output of the text generation model is “(1) Let's go to the zoo, (2) Let's draw a picture of a panda, and (3) Let's go buy a panda-shaped stuffed toy”, the robot 100 inputs a prompt like “Which of (1), (2), or (3) is most likely to make the user happiest?” to the text generation model, and in a case where an output of the text generation model is “(1) Let's go to the zoo”, uttering “(1) Let's go to the zoo” by the robot 100 when the robot 100 meets the user next is created as the emotion changing event and stored in the scheduled behavior data 224.

Further, for example, event data having a large emotion value of the robot 100 is selected as an impressive memory of the robot 100. As a result, it is possible to create the emotion changing event based on the event data selected as the impressive memory.

In a case where the behavior determination unit 236 determines, as the robot behavior, the behavior “(11) The robot proposes an art gallery, a museum, and an exhibition that the user should visit”, that is, proposal of the behavior of the user 10, the behavior determination unit 236 determines a destination to be proposed by using the text generation model based on the event data stored in the history data 222. At this time, the behavior determination unit 236 makes a proposal according to a schedule or a plan of the user 10 acquired in advance. The behavior control unit 250 causes the speaker included in the control target 252 to output a speech for proposing the behavior of the user 10. In a case where the user 10 is absent around the robot 100, the behavior control unit 250 stores the proposal of the behavior of the user in the scheduled behavior data 224 without outputting the speech for proposing the behavior of the user.

Furthermore, for the behavior of “(11) proposing an art gallery, a museum, and an exhibition that the user should visit”, the related information collection unit 270 acquires information regarding an art gallery, a museum, and an exhibition that the user 10 is interested in. For example, the related information collection unit 270 periodically collects information regarding an art gallery, a museum, and an exhibition present within a predetermined range from the current location of the user from external data by using ChatGPT plugins.

In a case where the behavior determination unit 236 determines, as the robot behavior, the behavior “(12) The robot introduces an event that the user should participate in”, the behavior determination unit 236 determines the utterance content of the robot, which corresponds to information stored in the collected data 223, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot. At this time, the behavior determination unit 236 introduces an event that the user 10 can participate in during a free time period according to the schedule or the plan of the user 10 acquired in advance.

Furthermore, for the behavior “(12) The robot introduces an event that the user should participate in”, the related information collection unit 270 acquires information regarding an event that the user 10 is interested in. For example, the related information collection unit 270 periodically collects information regarding an event scheduled to be held within a predetermined range from the current location of the user from external data by using ChatGPT plugins.

In a case where the behavior of the user 10 for the robot 100 is detected following a state in which the user 10 does nothing for the robot 100 based on the state of the user 10 recognized by the state recognition unit 230, the behavior determination unit 236 reads data stored in the scheduled behavior data 224 and determines the behavior of the robot 100.

For example, in a case where the user 10 is absent around the robot 100, the behavior determination unit 236 reads data stored in the scheduled behavior data 224 and determines the behavior of the robot 100 in response to detection of the user 10. In addition, in a case where the user 10 is sleeping, the behavior determination unit 236 reads data stored in the scheduled behavior data 224 and determines the behavior of the robot 100 in response to the user 10 waking up.

### Second Other Example

A second other example of the processing performed by the behavior determination unit 236 in a case where the robot 100 performs the autonomous processing of autonomously performing a behavior will be described.

In the autonomous processing in the present embodiment, the agent spontaneously and periodically detects the state of the user. The agent constantly detects a liking and a preference of the user, stores characteristics of the user, and grasps the liking of the user in music. The agent voluntarily plays a favorite song that suits a situation of the user.

The behavior determination unit 236 determines, as the behavior of the robot 100, any one of a plurality of types of robot behaviors including performing no operation by using at least one of the state of the user 10, the emotion of the user 10, the emotion of the robot 100, or the state of the robot 100, and the behavior determination model 221 at a predetermined timing. Here, a case where the text generation model having the dialogue function is used as the behavior determination model 221 will be described as an example.

Specifically, the behavior determination unit 236 inputs a text representing at least one of the state of the user 10, the emotion of the user 10, the emotion of the robot 100, or the state of the robot 100 and a text for inquiry about the robot behavior to the text generation model, and determines the behavior of the robot 100 based on an output of the text generation model.

For example, the plurality of types of robot behaviors include the following behaviors (1) to (11).
(1) The robot does nothing.
(2) The robot dreams.
(3) The robot speaks to the user.
(4) The robot creates a picture diary.
(5) The robot proposes an activity.
(6) The robot proposes a person the user should meet.
(7) The robot introduces news that the user is interested in.
(8) The robot edits pictures and moving images.
(9) The robot studies with the user.
(10) The robot recalls memory.
(11) The robot plays a piece of music the user likes.

The behavior determination unit 236 inputs, to the text generation model, a text representing the state of the user 10 and the state of the robot 100 that are recognized by a state recognition unit 230, and the current emotion value of the user 10 and the current emotion value of the robot 100 that are determined by the emotion determination unit 232, and a text for inquiry about any one of the plurality of types of robot behaviors including performing no operation, every lapse of a certain period of time, and determines the behavior of the robot 100 based on an output of the text generation model. Here, in a case where the user 10 is absent around the robot 100, a text to be input to the text generation model need not include the state of the user 10 and the current emotion value of the user 10, or may include information indicating that the user 10 is absent.

As an example, the following text is input to the text generation model:
“The robot is in a very pleasant state. The user is in a normally pleasant state. The user is sleeping. Among the following behaviors (1) to (11), which behavior is appropriate for the robot?
(1) The robot does nothing.
(2) The robot dreams.
(3) The robot speaks to the user.
. . . ”. Based on an output of the text generation model stating that “(1) the robot does nothing or (2) the robot dreams can be considered to be the most appropriate behavior”, the behavior “(1) the robot does nothing” or the behavior “(2) the robot dreams” is determined as the behavior of the robot 100.

As another example, the following text is input to the text generation model:
“The robot is in a slightly lonely state. The user is absent. The surroundings of the robot are dark. Among the following behaviors (1) to (11), which behavior is appropriate for the robot?
(1) The robot does nothing.
(2) The robot dreams.
(3) The robot speaks to the user.
. . . ”. Based on an output of the text generation model stating that “(2) The robot dreams or (4) the robot creates a picture diary can be considered to be the most appropriate behavior”, the behavior “(2) The robot dreams” or the behavior “(4) The robot creates a picture diary” is determined as the behavior of the robot 100.

In a case where the behavior determination unit 236 determines, as the robot behavior, the behavior “(2) The robot dreams”, that is, creation of an original event, the behavior determination unit 236 creates the original event obtained by combining a plurality of pieces of event data in history data 222 by using the text generation model. At this time, the storage control unit 238 stores the created original event in the history data 222

In a case where the behavior determination unit 236 determines, as the robot behavior, the behavior “(3) The robot speaks to the user”, that is, utterance by the robot 100, the behavior determination unit 236 determines the utterance content of the robot, which corresponds to the state of the user and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(7) The robot introduces news that the user is interested in”, the behavior determination unit 236 determines the utterance content of the robot, which corresponds to information stored in the collected data 223, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(4) The robot creates a picture diary”, that is, creation of an event image by the robot 100, the behavior determination unit 236 generates an image representing event data selected from the history data 222 by using the image generation model, generates an explanatory sentence representing the event data by using the text generation model, and outputs a combination of the image representing the event data and the explanatory sentence representing the event data as the event image. In a case where the user 10 is absent around the robot 100, the behavior control unit 250 stores the event image in the scheduled behavior data 224 without outputting the event image.

In a case where the behavior determination unit 236 determines, as the robot behavior, the behavior “(8) The robot edits pictures and moving images”, that is, image edition, the behavior determination unit 236 selects event data from the history data 222 based on the emotion value, edits image data of the selected event data, and outputs the edited image data. In a case where the user 10 is absent around the robot 100, the behavior control unit 250 stores the edited image data in the scheduled behavior data 224 without outputting the edited image data.

In a case where the behavior determination unit 236 determines, as the robot behavior, the behavior “(5) The robot proposes an activity”, that is, proposal of the behavior of the user 10, the behavior determination unit 236 determines the behavior of the user to be proposed by using the text generation model based on the event data stored in the history data 222. At this time, the behavior control unit 250 causes the speaker included in the control target 252 to output a speech for proposing the behavior of the user. In a case where the user 10 is absent around the robot 100, the behavior control unit 250 stores the proposal of the behavior of the user in the scheduled behavior data 224 without outputting the speech for proposing the behavior of the user.

In a case where the behavior determination unit 236 determines, as the robot behavior, the behavior “(6) The robot proposes a person the user should meet”, that is, proposal of a person the user 10 should connect with, the behavior determination unit 236 determines a person to be proposed as the person the user should connect with by using the text generation model based on the event data stored in the history data 222. At this time, the behavior control unit 250 causes the speaker included in the control target 252 to output a speech representing the proposal of a person the user should connect with. In a case where the user 10 is absent around the robot 100, the behavior control unit 250 stores the proposal of a person the user should connect with in the scheduled behavior data 224 without outputting the speech representing the proposal of a person the user should connect with.

In a case where the behavior determination unit 236 determines, as the robot behavior, the behavior “(9) The robot studies with the user”, that is, utterance by the robot 100 about study, the behavior determination unit 236 determines the utterance content of the robot for encouraging study, posing questions, or providing study-related advice, which corresponds to the user state and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(10) The robot recalls memory”, that is, recalling of the event data, the behavior determination unit 236 selects the event data from the history data 222. At this time, the emotion determination unit 232 determines the emotion of the robot 100 based on the selected event data. Furthermore, the behavior determination unit 236 creates an emotion changing event representing the utterance content or behavior of the robot 100 for changing the emotion value of the user by using the text generation model based on the selected event data. At this time, the storage control unit 238 stores the emotion changing event in the scheduled behavior data 224.

For example, in a case where information indicating that a moving image the user was watching was related to a panda is stored in the history data 222 as the event data, and the event data is selected, a prompt like “What are three things the robot could say the next time the robot meets the user, based on the topic of pandas?” is input to the text generation model, in a case where an output of the text generation model is “(1) Let's go to the zoo, (2) Let's draw a picture of a panda, and (3) Let's go buy a panda-shaped stuffed toy”, the robot 100 inputs a prompt like “Which of (1), (2), or (3) is most likely to make the user happiest?” to the text generation model, and in a case where an output of the text generation model is “(1) Let's go to the zoo”, uttering “(1) Let's go to the zoo” by the robot 100 when the robot 100 meets the user next is created as the emotion changing event and stored in the scheduled behavior data 224.

Further, for example, event data having a large emotion value of the robot 100 is selected as an impressive memory of the robot 100. As a result, it is possible to create the emotion changing event based on the event data selected as the impressive memory.

In a case where the behavior determination unit 236 determines, as the robot behavior, the behavior of “(11) playing a piece of music the user likes”, that is, a behavior of playing a piece of music suitable for the user 10, the behavior determination unit 236 determines a piece of music to play based on the information stored in the collected data 223. Alternatively, the behavior determination unit 236 may determine a piece of music to play based on the event data stored in the history data 222. At this time, the behavior control unit 250 causes the speaker included in the control target 252 to output the piece of music. In a case where the user 10 is absent around the robot 100, the behavior control unit 250 stores the behavior of playing a piece of music the user 10 likes in the scheduled behavior data 224 without outputting the piece of music.

Furthermore, for the behavior of “(11) playing a piece of music the user likes”, the related information collection unit 270 stores necessary information related to a preference of the user in music in the collected data 223. The necessary information related to the preference of the user in music includes at least one of a preference in types of music, a preference in musical instruments, or a preference in singers.

Examples of the types of music include genres such as jazz, classical, rock, and popular music. In a case where the behavior determination unit 236 determines a piece of music to play based on the preference of the user in types of music, the behavior determination unit 236 determines, as the piece of music to play, a piece of music included in a genre of music that the user likes.

The musical instruments include various musical instruments such as a wind musical instrument, a string musical instrument, and a percussion musical instrument. In a case where the behavior determination unit 236 determines the piece of music to play based on the preference of the user in musical instruments, the behavior determination unit 236 determines, as the piece of music to play, a piece of music in which a favorite musical instrument of the user is used.

The singers not only include a specific artist name but also include a case where no singer is involved. In a case where the behavior determination unit 236 determines the piece of music to play based on the preference of the user in singers, the behavior determination unit 236 determines, as the piece of music to play, a piece of music sung by a favorite singer of the user. Alternatively, the behavior determination unit 236 determines, as the piece of music to play, a piece of music in which no singer is involved (so-called instrumental music) is determined.

The necessary information related to the preference of the user in music may include a preference in volume levels of music to be output from the speaker.

In addition, for the behavior of “(11) playing a piece of music the user likes”, the storage control unit 238 stores necessary data in the history data 222.

The robot 100 may be applied to a piece of music reproduction device such as an AI speaker or an acoustic device (audio device) such as a radio.

The robot 100 serving as the acoustic device includes a storage unit that stores music data, a conversion unit such as a D/A converter that converts the piece of music data into a sound, and a speaker that outputs the sound. Furthermore, in a case where the robot 100 is mounted on a radio, the robot 100 includes a tuner unit that receives radio waves of radio broadcasting and outputs a sound.

The behavior determination unit 236 can determine the piece of music to play according to the preference of the user, the situation of the user, and the reaction of the user.

At this time, the behavior determination unit 236 can determine to play a piece of music suitable for the emotion of the user 10 at that time by considering not only the preference of the user 10 in music but also the emotion of the user 10 and the history data 222. Further, it is possible to make the user 10 feel that the robot 100 has emotions by considering the emotion of the robot 100. For example, even when the preference of the user 10 in music is classical music, in a case where it is determined that it is better to energize the user 10, the robot 100 can perform control to select and play a lively popular music with a fast tempo.

The robot 100 plays a piece of music and acquires the reaction of the user 10. Specifically, the behavior control unit 250 plays the piece of music determined by the behavior determination unit 236. The state recognition unit 230 recognizes the state of the user 10 based on the information analyzed by the sensor module unit 210. The emotion determination unit 232 determines the emotion value indicating the emotion of the user 10 based on the information analyzed by the sensor module unit 210 and the state of the user 10 recognized by the state recognition unit 230.

The behavior determination unit 236 determines whether or not the reaction of the user 10 is positive based on the state of the user 10 recognized by the state recognition unit 230 and the emotion value indicating the emotion of the user 10. In addition, the behavior determination unit 236 determines, as the behavior of the robot 100, whether to continue playing the same piece of music, play a different piece of music of the same genre as the played piece of music, play a piece of music of a different genre from the played piece of music, or stop playing the piece of music.

For example, in a case where the reaction of the user 10 is positive, the robot 100 continues to play the same piece of music. Alternatively, after the end of the piece of music being played, a different piece of music of the same genre as the piece of music is played.

Specifically, in a case where the behavior determination unit 236 determines to continue playing the same piece of music as the behavior of the robot 100, the behavior control unit 250 controls the acoustic device as the control target 252 so as to repeatedly continue playing the same piece of music. Alternatively, in a case where it is determined that a different piece of music of the same genre as the played piece of music is to be played as the behavior of the robot 100, the behavior control unit 250 controls the acoustic device as the control target 252 to play the different piece of music of the same genre as the piece of music after the end of the piece of music being played.

In a case where the reaction of the user 10 is not positive, the robot 100 plays a piece of music of a genre different from the played piece of music. Alternatively, the playback of the piece of music is stopped.

Specifically, in a case where the behavior determination unit 236 determines to play a piece of music of a genre different from the played piece of music as the behavior of the robot 100, the behavior control unit 250 controls the acoustic device as the control target 252 to play the piece of music of the genre different from the played piece of music. Alternatively, in a case where the behavior determination unit 236 determines to stop playing the piece of music as the behavior of the robot 100, the behavior control unit 250 controls the acoustic device as the control target 252 to play a piece of music of a genre different from the played piece of music.

In this manner, the robot 100 can perform processing of selecting a genre of music to play according to the preference of the user, the situation of the user, and the reaction of the user, and playing a piece of music included in the selected genre.

In the above description, a case where the behavior determination unit 236 determines a piece of music to be output from the acoustic device has been described, but a volume level for playing music may also be determined.

For example, in a case where a preference in volume levels of music to be output from the speaker is stored in the collected data 223, the behavior determination unit 236 determines the volume level of music to play according to the preference of the user in volume levels. Furthermore, in a case where it is determined that an emotional energy level of the user 10 is not very high, the behavior determination unit 236 may perform control to lower the volume level of music to play.

In a case where the acoustic device on which the robot 100 is mounted is a radio, the behavior determination unit 236 can select a broadcast station to be tuned in and perform control to tune in to the selected broadcast station. For example, in a case where it is determined that the emotional energy level of the user 10 is not very high, the behavior determination unit 236 can perform control to tune in to a broadcast station mainly broadcasting classical music. On the other hand, in a case where the emotional energy level of the user 10 is relatively high, the behavior determination unit 236 can perform control to tune in to a broadcast station mainly broadcasting rock music.

In a case where the robot 100 acquires and stores information such as a broadcast program schedule provided by a broadcast station, it is possible to specify a broadcast program being broadcast by each broadcast station based on the current time and the information such as the broadcast program schedule. Therefore, in a case where the information such as the broadcast program schedule provided by the broadcast station is stored, the behavior determination unit 236 may tune in to a broadcast station by using the information.

In a case where the behavior of the user 10 for the robot 100 is detected following a state in which the user 10 does nothing for the robot 100 based on the state of the user 10 recognized by the state recognition unit 230, the behavior determination unit 236 reads data stored in the scheduled behavior data 224 and determines the behavior of the robot 100.

For example, in a case where the user 10 is absent around the robot 100, the behavior determination unit 236 reads data stored in the scheduled behavior data 224 and determines the behavior of the robot 100 in response to detection of the user 10. In addition, in a case where the user 10 is sleeping, the behavior determination unit 236 reads data stored in the scheduled behavior data 224 and determines the behavior of the robot 100 in response to the user 10 waking up.

### Third Other Example

A third other example of the processing performed by the behavior determination unit 236 in a case where the robot 100 performs the autonomous processing of autonomously performing a behavior will be described.

In the autonomous processing in the present embodiment, the agent spontaneously and periodically detects the state of the user. The agent constantly detects the liking and the preference of the user, stores the characteristics of the user, and grasps what kind of shopping the user likes according to the liking of the user. The agent spontaneously proposes to the user to go shopping, and accompanies the user for shopping while having a conversation with the user.

The behavior determination unit 236 determines, as the behavior of the robot 100, any one of a plurality of types of robot behaviors including performing no operation by using at least one of the state of the user 10, the emotion of the user 10, the emotion of the robot 100, or the state of the robot 100, and the behavior determination model 221 at a predetermined timing. Here, a case where the text generation model having the dialogue function is used as the behavior determination model 221 will be described as an example.

Specifically, the behavior determination unit 236 inputs a text representing at least one of the state of the user 10, the emotion of the user 10, the emotion of the robot 100, or the state of the robot 100 and a text for inquiry about the robot behavior to the text generation model, and determines the behavior of the robot 100 based on an output of the text generation model.

For example, the plurality of types of robot behaviors include the following behaviors (1) to (10).
(1) The robot does nothing.
(2) The robot dreams.
(3) The robot speaks to the user.
(4) The robot creates a picture diary.
(5) The robot proposes an activity.
(6) The robot proposes a person the user should meet.
(7) The robot introduces news that the user is interested in.
(8) The robot edits pictures and moving images.
(9) The robot studies with the user.
(10) The robot recalls memory.

The behavior determination unit 236 inputs, to the text generation model, a text representing the state of the user 10 and the state of the robot 100 that are recognized by a state recognition unit 230, and the current emotion value of the user 10 and the current emotion value of the robot 100 that are determined by the emotion determination unit 232, and a text for inquiry about any one of the plurality of types of robot behaviors including performing no operation, every lapse of a certain period of time, and determines the behavior of the robot 100 based on an output of the text generation model. Here, in a case where the user 10 is absent around the robot 100, a text to be input to the text generation model need not include the state of the user 10 and the current emotion value of the user 10, or may include information indicating that the user 10 is absent.

As an example, the following text is input to the text generation model:
“The robot is in a very pleasant state. The user is in a normally pleasant state. The user is sleeping. Among the following behaviors (1) to (10), which behavior is appropriate for the robot?
(1) The robot does nothing.
(2) The robot dreams.
(3) The robot speaks to the user.
. . . ”. Based on an output of the text generation model stating that “(1) the robot does nothing or (2) the robot dreams can be considered to be the most appropriate behavior”, the behavior “(1) the robot does nothing” or the behavior “(2) the robot dreams” is determined as the behavior of the robot 100.

As another example, the following text is input to the text generation model:
“The robot is in a slightly lonely state. The user is absent. The surroundings of the robot are dark. Among the following behaviors (1) to (10), which behavior is appropriate for the robot?
(1) The robot does nothing.
(2) The robot dreams.
(3) The robot speaks to the user.
. . . ”. Based on an output of the text generation model stating that “(2) The robot dreams or (4) the robot creates a picture diary can be considered to be the most appropriate behavior”, the behavior “(2) The robot dreams” or the behavior “(4) The robot creates a picture diary” is determined as the behavior of the robot 100.

In a case where the behavior determination unit 236 determines, as the robot behavior, the behavior “(2) The robot dreams”, that is, creation of an original event, the behavior determination unit 236 creates the original event obtained by combining a plurality of pieces of event data in history data 222 by using the text generation model. At this time, the storage control unit 238 stores the created original event in the history data 222.

In a case where the behavior determination unit 236 determines, as the robot behavior, the behavior “(3) The robot speaks to the user”, that is, utterance by the robot 100, the behavior determination unit 236 determines the utterance content of the robot, which corresponds to the state of the user and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(7) The robot introduces news that the user is interested in”, the behavior determination unit 236 determines the utterance content of the robot, which corresponds to information stored in the collected data 223, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(4) The robot creates a picture diary”, that is, creation of an event image by the robot 100, the behavior determination unit 236 generates an image representing event data selected from the history data 222 by using the image generation model, generates an explanatory sentence representing the event data by using the text generation model, and outputs a combination of the image representing the event data and the explanatory sentence representing the event data as the event image. In a case where the user 10 is absent around the robot 100, the behavior control unit 250 stores the event image in the scheduled behavior data 224 without outputting the event image.

In a case where the behavior determination unit 236 determines, as the robot behavior, the behavior “(8) The robot edits pictures and moving images”, that is, image edition, the behavior determination unit 236 selects event data from the history data 222 based on the emotion value, edits image data of the selected event data, and outputs the edited image data. In a case where the user 10 is absent around the robot 100, the behavior control unit 250 stores the edited image data in the scheduled behavior data 224 without outputting the edited image data.

In a case where the behavior determination unit 236 determines, as the robot behavior, the behavior “(5) The robot proposes an activity”, that is, proposal of the behavior of the user 10, the behavior determination unit 236 determines the behavior of the user to be proposed by using the text generation model based on the event data stored in the history data 222. At this time, the behavior control unit 250 causes the speaker included in the control target 252 to output a speech for proposing the behavior of the user. In a case where the user 10 is absent around the robot 100, the behavior control unit 250 stores the proposal of the behavior of the user in the scheduled behavior data 224 without outputting the speech for proposing the behavior of the user.

In a case where the behavior determination unit 236 determines, as the robot behavior, the behavior “(6) The robot proposes a person the user should meet”, that is, proposal of a person the user 10 should connect with, the behavior determination unit 236 determines a person to be proposed as the person the user should connect with by using the text generation model based on the event data stored in the history data 222. At this time, the behavior control unit 250 causes the speaker included in the control target 252 to output a speech representing the proposal of a person the user should connect with. In a case where the user 10 is absent around the robot 100, the behavior control unit 250 stores the proposal of a person the user should connect with in the scheduled behavior data 224 without outputting the speech representing the proposal of a person the user should connect with.

In a case where the behavior determination unit 236 determines, as the robot behavior, the behavior “(9) The robot studies with the user”, that is, utterance by the robot 100 about study, the behavior determination unit 236 determines the utterance content of the robot for encouraging study, posing questions, or providing study-related advice, which corresponds to the user state and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(10) The robot recalls memory”, that is, recalling of the event data, the behavior determination unit 236 selects the event data from the history data 222. At this time, the emotion determination unit 232 determines the emotion of the robot 100 based on the selected event data. Furthermore, the behavior determination unit 236 creates an emotion changing event representing the utterance content or behavior of the robot 100 for changing the emotion value of the user by using the text generation model based on the selected event data. At this time, the storage control unit 238 stores the emotion changing event in the scheduled behavior data 224.

For example, in a case where information indicating that a moving image the user was watching was related to a panda is stored in the history data 222 as the event data, and the event data is selected, a prompt like “What are three things the robot could say the next time the robot meets the user, based on the topic of pandas?” is input to the text generation model, in a case where an output of the text generation model is “(1) Let's go to the zoo, (2) Let's draw a picture of a panda, and (3) Let's go buy a panda-shaped stuffed toy”, the robot 100 inputs a prompt like “Which of (1), (2), or (3) is most likely to make the user happiest?” to the text generation model, and in a case where an output of the text generation model is “(1) Let's go to the zoo”, uttering “(1) Let's go to the zoo” by the robot 100 when the robot 100 meets the user next is created as the emotion changing event and stored in the scheduled behavior data 224.

Further, for example, event data having a large emotion value of the robot 100 is selected as an impressive memory of the robot 100. As a result, it is possible to create the emotion changing event based on the event data selected as the impressive memory.

In a case where the behavior determination unit 236 determines, as the robot behavior, the behavior “(5) The robot proposes an activity”, that is, proposal of an activity to the user, the behavior determination unit 236 spontaneously proposes an activity to the user.

For the behavior “(5) The robot proposes an activity”, the state recognition unit 230 spontaneously and periodically detects the state of the user, so that the agent constantly detects the liking and the preference of the user. Furthermore, the agent stores the characteristics of the user, and grasps what kind of shopping the user likes according to the liking of the user, for example.

The behavior determination unit 236 spontaneously proposes to the user to go shopping, for example, as the robot behavior. As a result, the agent accompanies the user for shopping while having a conversation with the user.

Further, for the behavior “(5) The robot proposes an activity”, the related information collection unit 270 collects information related to preference information from external data (websites such as news sites and moving image sites) based on the preference information acquired for the user 10 spontaneously.

Further, for the behavior “(5) The robot proposes an activity”, the storage control unit 238 stores, for example, an activity proposed to the user in the history data 222.

In a case where the behavior of the user 10 for the robot 100 is detected following a state in which the user 10 does nothing for the robot 100 based on the state of the user 10 recognized by the state recognition unit 230, the behavior determination unit 236 reads data stored in the scheduled behavior data 224 and determines the behavior of the robot 100.

For example, in a case where the user 10 is absent around the robot 100, the behavior determination unit 236 reads data stored in the scheduled behavior data 224 and determines the behavior of the robot 100 in response to detection of the user 10. In addition, in a case where the user 10 is sleeping, the behavior determination unit 236 reads data stored in the scheduled behavior data 224 and determines the behavior of the robot 100 in response to the user 10 waking up.

### Fourth Other Example

A fourth other example of the processing performed by the behavior determination unit 236 in a case where the robot 100 performs the autonomous processing of autonomously performing a behavior will be described.

In the autonomous processing in the present embodiment, the robot 100 serving as the agent spontaneously and periodically detects the state of the user 10. The robot 100 constantly detects the liking and the preference of the user, stores the characteristics of the user 10, and grasps in advance what kind of food and drink the user 10 likes according to the liking of the user 10. The robot 100 proposes an activity related to food and drink according to the emotion value of the user 10 and/or the robot 100. For example, the robot 100 may propose to the user 10 and/or a person around the user 10 to go to a restaurant at a certain timing according to the emotion value of the user 10 and/or the robot 100. Furthermore, the robot 100 may spontaneously propose a menu to the user 10 or spontaneously order a menu from a store clerk of a restaurant based on the liking and the preference of the user 10 in the restaurant according to the emotion value of the user 10 and/or the robot 100.

The behavior determination unit 236 determines, as the behavior of the robot 100, any one of a plurality of types of robot behaviors including performing no operation by using at least one of the state of the user 10, the emotion of the user 10, the emotion of the robot 100, or the state of the robot 100, and the behavior determination model 221 at a predetermined timing. Here, a case where the text generation model having the dialogue function is used as the behavior determination model 221 will be described as an example.

Specifically, the behavior determination unit 236 inputs a text representing at least one of the state of the user 10, the emotion of the user 10, the emotion of the robot 100, or the state of the robot 100 and a text for inquiry about the robot behavior to the text generation model, and determines the behavior of the robot 100 based on an output of the text generation model.

For example, the plurality of types of robot behaviors include the following behaviors (1) to (10).
(1) The robot does nothing.
(2) The robot dreams.
(3) The robot speaks to the user.
(4) The robot creates a picture diary.
(5) The robot proposes an activity.
(6) The robot proposes a person the user should meet.
(7) The robot introduces news that the user is interested in.
(8) The robot edits pictures and moving images.
(9) The robot studies with the user.
(10) The robot recalls memory.

The behavior determination unit 236 inputs, to the text generation model, a text representing the state of the user 10 and the state of the robot 100 that are recognized by a state recognition unit 230, and the current emotion value of the user 10 and the current emotion value of the robot 100 that are determined by the emotion determination unit 232, and a text for inquiry about any one of the plurality of types of robot behaviors including performing no operation, every lapse of a certain period of time, and determines the behavior of the robot 100 based on an output of the text generation model. Here, in a case where the user 10 is absent around the robot 100, a text to be input to the text generation model need not include the state of the user 10 and the current emotion value of the user 10, or may include information indicating that the user 10 is absent.

As an example, the following text is input to the text generation model:
“The robot is in a very pleasant state. The user is in a normally pleasant state. The user is sleeping. Among the following behaviors (1) to (10), which behavior is appropriate for the robot?
(1) The robot does nothing.
(2) The robot dreams.
(3) The robot speaks to the user.
. . . ”. Based on an output of the text generation model stating that “(1) the robot does nothing or (2) the robot dreams can be considered to be the most appropriate behavior”, the behavior “(1) the robot does nothing” or the behavior “(2) the robot dreams” is determined as the behavior of the robot 100.

As another example, the following text is input to the text generation model:
“The robot is in a slightly lonely state. The user is absent. The surroundings of the robot are dark. Among the following behaviors (1) to (10), which behavior is appropriate for the robot?
(1) The robot does nothing.
(2) The robot dreams.
(3) The robot speaks to the user.

. . . ”. Based on an output of the text generation model stating that “(2) The robot dreams or (4) the robot creates a picture diary can be considered to be the most appropriate behavior”, the behavior “(2) The robot dreams” or the behavior “(4) The robot creates a picture diary” is determined as the behavior of the robot 100.

In a case where the behavior determination unit 236 determines, as the robot behavior, the behavior “(2) The robot dreams”, that is, creation of an original event, the behavior determination unit 236 creates the original event obtained by combining a plurality of pieces of event data in history data 222 by using the text generation model. At this time, the storage control unit 238 stores the created original event in the history data 222

In a case where the behavior determination unit 236 determines, as the robot behavior, the behavior “(3) The robot speaks to the user”, that is, utterance by the robot 100, the behavior determination unit 236 determines the utterance content of the robot, which corresponds to the state of the user and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(7) The robot introduces news that the user is interested in”, the behavior determination unit 236 determines the utterance content of the robot, which corresponds to information stored in the collected data 223, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(4) The robot creates a picture diary”, that is, creation of an event image by the robot 100, the behavior determination unit 236 generates an image representing event data selected from the history data 222 by using the image generation model, generates an explanatory sentence representing the event data by using the text generation model, and outputs a combination of the image representing the event data and the explanatory sentence representing the event data as the event image. In a case where the user 10 is absent around the robot 100, the behavior control unit 250 stores the event image in the scheduled behavior data 224 without outputting the event image.

In a case where the behavior determination unit 236 determines, as the robot behavior, the behavior “(8) The robot edits pictures and moving images”, that is, image edition, the behavior determination unit 236 selects event data from the history data 222 based on the emotion value, edits image data of the selected event data, and outputs the edited image data. In a case where the user 10 is absent around the robot 100, the behavior control unit 250 stores the edited image data in the scheduled behavior data 224 without outputting the edited image data.

In a case where the behavior determination unit 236 determines, as the robot behavior, the behavior “(5) The robot proposes an activity”, that is, spontaneous proposal of the behavior of the user 10, the behavior determination unit 236 determines the behavior of the user to be proposed by using the text generation model based on the event data stored in the history data 222. At this time, the behavior control unit 250 causes the speaker included in the control target 252 to output a speech for proposing the behavior of the user. In a case where the user 10 is absent around the robot 100, the behavior control unit 250 stores the proposal of the behavior of the user in the scheduled behavior data 224 without outputting the speech for proposing the behavior of the user.

For example, in a case where the behavior determination unit 236 determines, as the activity, proposal of an activity related to food and drink, the behavior determination unit 236 determines a behavior to be spontaneously proposed as the behavior of the user related to food and drink by using the text generation model based on the event data stored in the history data 222. Specifically, the behavior determination unit 236 may prompt the user to go to a restaurant or propose a menu in a restaurant. In addition, the behavior determination unit 236 may propose the current menu in consideration of information regarding a menu selected in the past, the information being stored in the history data 222. In this case, the behavior determination unit 236 can propose a different menu from the menu of the latest meal.

In a case where the behavior determination unit 236 determines, as the robot behavior, the behavior “(6) The robot proposes a person the user should meet”, that is, proposal of a person the user 10 should connect with, the behavior determination unit 236 determines a person to be proposed as the person the user should connect with by using the text generation model based on the event data stored in the history data 222. At this time, the behavior control unit 250 causes the speaker included in the control target 252 to output a speech representing the proposal of a person the user should connect with. In a case where the user 10 is absent around the robot 100, the behavior control unit 250 stores the proposal of a person the user should connect with in the scheduled behavior data 224 without outputting the speech representing the proposal of a person the user should connect with.

In a case where the behavior determination unit 236 determines, as the robot behavior, the behavior “(9) The robot studies with the user”, that is, utterance by the robot 100 about study, the behavior determination unit 236 determines the utterance content of the robot for encouraging study, posing questions, or providing study-related advice, which corresponds to the user state and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(10) The robot recalls memory”, that is, recalling of the event data, the behavior determination unit 236 selects the event data from the history data 222. At this time, the emotion determination unit 232 determines the emotion of the robot 100 based on the selected event data. Furthermore, the behavior determination unit 236 creates an emotion changing event representing the utterance content or behavior of the robot 100 for changing the emotion value of the user by using the text generation model based on the selected event data. At this time, the storage control unit 238 stores the emotion changing event in the scheduled behavior data 224.

For example, in a case where information indicating that a moving image the user was watching was related to a panda is stored in the history data 222 as the event data, and the event data is selected, a prompt like “What are three things the robot could say the next time the robot meets the user, based on the topic of pandas?” is input to the text generation model, in a case where an output of the text generation model is “(1) Let's go to the zoo, (2) Let's draw a picture of a panda, and (3) Let's go buy a panda-shaped stuffed toy”, the robot 100 inputs a prompt like “Which of (1), (2), or (3) is most likely to make the user happiest?” to the text generation model, and in a case where an output of the text generation model is “(1) Let's go to the zoo”, uttering “(1) Let's go to the zoo” by the robot 100 when the robot 100 meets the user next is created as the emotion changing event and stored in the scheduled behavior data 224.

Further, for example, event data having a large emotion value of the robot 100 is selected as an impressive memory of the robot 100. As a result, it is possible to create the emotion changing event based on the event data selected as the impressive memory.

In a case where the behavior of the user 10 for the robot 100 is detected following a state in which the user 10 does nothing for the robot 100 based on the state of the user 10 recognized by the state recognition unit 230, the behavior determination unit 236 reads data stored in the scheduled behavior data 224 and determines the behavior of the robot 100.

For example, in a case where the user 10 is absent around the robot 100, the behavior determination unit 236 reads data stored in the scheduled behavior data 224 and determines the behavior of the robot 100 in response to detection of the user 10. In addition, in a case where the user 10 is sleeping, the behavior determination unit 236 reads data stored in the scheduled behavior data 224 and determines the behavior of the robot 100 in response to the user 10 waking up.

### Fifth Other Example

A fifth other example of the processing performed by the behavior determination unit 236 in a case where the robot 100 performs the autonomous processing of autonomously performing a behavior will be described.

In the autonomous processing in the present embodiment, the robot 100 spontaneously and periodically detects the state of the user 10. The robot 100 constantly detects the liking and the preference of the user 10, stores the characteristics of the user 10, and spontaneously predicts a future schedule of the user 10 based on a conversation of the user 10. In addition, the robot 100 has a mind, and spontaneously makes a schedule according to the preference, the situation, and the reaction of the user 10. In a case where there is a schedule that the user 10 does not want to attend, the robot 100 makes a notification of rejection.

The behavior determination unit 236 determines, as the behavior of the robot 100, any one of a plurality of types of robot behaviors including performing no operation by using at least one of the state of the user 10, the emotion of the user 10, the emotion of the robot 100, or the state of the robot 100, and the behavior determination model 221 at a predetermined timing. Here, a case where the text generation model having the dialogue function is used as the behavior determination model 221 will be described as an example.

Specifically, the behavior determination unit 236 inputs a text representing at least one of the state of the user 10, the emotion of the user 10, the emotion of the robot 100, or the state of the robot 100 and a text for inquiry about the robot behavior to the text generation model, and determines the behavior of the robot 100 based on an output of the text generation model.

For example, the plurality of types of robot behaviors include the following behaviors (1) to (11).
(1) The robot does nothing.
(2) The robot dreams.
(3) The robot speaks to the user.
(4) The robot creates a picture diary.
(5) The robot proposes an activity.
(6) The robot proposes a person the user should meet.
(7) The robot introduces news that the user is interested in.
(8) The robot edits pictures and moving images.
(9) The robot studies with the user.
(10) The robot recalls memory.
(11) The robot determines a schedule of the user.

The behavior determination unit 236 inputs, to the text generation model, a text representing the state of the user 10 and the state of the robot 100 that are recognized by a state recognition unit 230, and the current emotion value of the user 10 and the current emotion value of the robot 100 that are determined by the emotion determination unit 232, and a text for inquiry about any one of the plurality of types of robot behaviors including performing no operation, every lapse of a certain period of time, and determines the behavior of the robot 100 based on an output of the text generation model. Here, in a case where the user 10 is absent around the robot 100, a text to be input to the text generation model need not include the state of the user 10 and the current emotion value of the user 10, or may include information indicating that the user 10 is absent.

As an example, the following text is input to the text generation model:
“The robot is in a very pleasant state. The user is in a normally pleasant state. The user is sleeping. Among the following behaviors (1) to (11), which behavior is appropriate for the robot?
(1) The robot does nothing.
(2) The robot dreams.
(3) The robot speaks to the user.
. . . ”. Based on an output of the text generation model stating that “(1) the robot does nothing or (2) the robot dreams can be considered to be the most appropriate behavior”, the behavior “(1) the robot does nothing” or the behavior “(2) the robot dreams” is determined as the behavior of the robot 100.

As another example, the following text is input to the text generation model:
“The robot is in a slightly lonely state. The user is absent. The surroundings of the robot are dark. Among the following behaviors (1) to (11), which behavior is appropriate for the robot?
(1) The robot does nothing.
(2) The robot dreams.
(3) The robot speaks to the user.
. . . ”. Based on an output of the text generation model stating that “(2) The robot dreams or (4) the robot creates a picture diary can be considered to be the most appropriate behavior”, the behavior “(2) The robot dreams” or the behavior “(4) The robot creates a picture diary” is determined as the behavior of the robot 100.

In a case where the behavior determination unit 236 determines, as the robot behavior, the behavior “(2) The robot dreams”, that is, creation of an original event, the behavior determination unit 236 creates the original event obtained by combining a plurality of pieces of event data in history data 222 by using the text generation model. At this time, the storage control unit 238 stores the created original event in the history data 222

In a case where the behavior determination unit 236 determines, as the robot behavior, the behavior “(3) The robot speaks to the user”, that is, utterance by the robot 100, the behavior determination unit 236 determines the utterance content of the robot, which corresponds to the state of the user and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(7) The robot introduces news that the user is interested in”, the behavior determination unit 236 determines the utterance content of the robot, which corresponds to information stored in the collected data 223, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(4) The robot creates a picture diary”, that is, creation of an event image by the robot 100, the behavior determination unit 236 generates an image representing event data selected from the history data 222 by using the image generation model, generates an explanatory sentence representing the event data by using the text generation model, and outputs a combination of the image representing the event data and the explanatory sentence representing the event data as the event image. In a case where the user 10 is absent around the robot 100, the behavior control unit 250 stores the event image in the scheduled behavior data 224 without outputting the event image.

In a case where the behavior determination unit 236 determines, as the robot behavior, the behavior “(8) The robot edits pictures and moving images”, that is, image edition, the behavior determination unit 236 selects event data from the history data 222 based on the emotion value, edits image data of the selected event data, and outputs the edited image data. In a case where the user 10 is absent around the robot 100, the behavior control unit 250 stores the edited image data in the scheduled behavior data 224 without outputting the edited image data.

In a case where the behavior determination unit 236 determines, as the robot behavior, the behavior “(5) The robot proposes an activity”, that is, proposal of the behavior of the user 10, the behavior determination unit 236 determines the behavior of the user to be proposed by using the text generation model based on the event data stored in the history data 222. At this time, the behavior control unit 250 causes the speaker included in the control target 252 to output a speech for proposing the behavior of the user. In a case where the user 10 is absent around the robot 100, the behavior control unit 250 stores the proposal of the behavior of the user in the scheduled behavior data 224 without outputting the speech for proposing the behavior of the user.

In a case where the behavior determination unit 236 determines, as the robot behavior, the behavior “(6) The robot proposes a person the user should meet”, that is, proposal of a person the user 10 should connect with, the behavior determination unit 236 determines a person to be proposed as the person the user should connect with by using the text generation model based on the event data stored in the history data 222. At this time, the behavior control unit 250 causes the speaker included in the control target 252 to output a speech representing the proposal of a person the user should connect with. In a case where the user 10 is absent around the robot 100, the behavior control unit 250 stores the proposal of a person the user should connect with in the scheduled behavior data 224 without outputting the speech representing the proposal of a person the user should connect with.

In a case where the behavior determination unit 236 determines, as the robot behavior, the behavior “(9) The robot studies with the user”, that is, utterance by the robot 100 about study, the behavior determination unit 236 determines the utterance content of the robot for encouraging study, posing questions, or providing study-related advice, which corresponds to the user state and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(10) The robot recalls memory”, that is, recalling of the event data, the behavior determination unit 236 selects the event data from the history data 222. At this time, the emotion determination unit 232 determines the emotion of the robot 100 based on the selected event data. Furthermore, the behavior determination unit 236 creates an emotion changing event representing the utterance content or behavior of the robot 100 for changing the emotion value of the user by using the text generation model based on the selected event data. At this time, the storage control unit 238 stores the emotion changing event in the scheduled behavior data 224.

For example, in a case where information indicating that a moving image the user was watching was related to a panda is stored in the history data 222 as the event data, and the event data is selected, a prompt like “What are three things the robot could say the next time the robot meets the user, based on the topic of pandas?” is input to the text generation model, in a case where an output of the text generation model is “(1) Let's go to the zoo, (2) Let's draw a picture of a panda, and (3) Let's go buy a panda-shaped stuffed toy”, the robot 100 inputs a prompt like “Which of (1), (2), or (3) is most likely to make the user happiest?” to the text generation model, and in a case where an output of the text generation model is “(1) Let's go to the zoo”, uttering “(1) Let's go to the zoo” by the robot 100 when the robot 100 meets the user next is created as the emotion changing event and stored in the scheduled behavior data 224.

Further, for example, event data having a large emotion value of the robot 100 is selected as an impressive memory of the robot 100. As a result, it is possible to create the emotion changing event based on the event data selected as the impressive memory.

In a case where the behavior determination unit 236 determines, as the robot behavior, the behavior “(11) The robot determines a schedule of the user”, that is, proposal of the schedule of the user 10, the behavior determination unit 236 determines the behavior of the user to be proposed by using the text generation model based on the event data stored in the history data 222. At this time, the behavior control unit 250 causes the speaker included in the control target 252 to output a speech for proposing the behavior of the user.

Furthermore, for the behavior “(11) The robot determines a schedule of the user”, the related information collection unit 270 periodically collects information such as a favorite place, a favorite sport, a favorite hobby, and the like of the user 10 from external data by using ChatGPT plugins.

In a case where the behavior of the user 10 for the robot 100 is detected following a state in which the user 10 does nothing for the robot 100 based on the state of the user 10 recognized by the state recognition unit 230, the behavior determination unit 236 reads data stored in the scheduled behavior data 224 and determines the behavior of the robot 100.

For example, in a case where the user 10 is absent around the robot 100, the behavior determination unit 236 reads data stored in the scheduled behavior data 224 and determines the behavior of the robot 100 in response to detection of the user 10. In addition, in a case where the user 10 is sleeping, the behavior determination unit 236 reads data stored in the scheduled behavior data 224 and determines the behavior of the robot 100 in response to the user 10 waking up.

### Sixth Other Example

A sixth other example of the processing performed by the behavior determination unit 236 in a case where the robot 100 performs the autonomous processing of autonomously performing a behavior will be described.

In the autonomous processing in the present embodiment, the robot 100 collects information such as an utterance content and a motion of another robot 100, and spontaneously grasps a hobby and a preference of another robot 100 at all times. Then, in a random time period, the robot 100 initiates a conversation regarding a favorite baseball team of another robot 100 or initiates an utterance regarding a favorite singer to another robot 100. Another robot 100 responds to the initiated conversation. Accordingly, the conversation is carried out endlessly between the robot 100 and the another robot 100, whereby a robot 100 having a supreme ego is created. That is, the robots 100 loaded with text generation models continue to have a conversation via the text generation models. In a case where such a conversation between the robots 100 is performed a plurality of times, it appears as if a new personality emerges in the robot 100, or the robots 100 are having a conversation with each other, so that it is possible to entertain surrounding people who are watching the robots 100. In the present embodiment, since the plurality of robots 100 have a conversation with each other, the plurality of robots 100 are preferably arranged at a distance at which the robots 100 can perform imaging using the cameras 203.

The behavior determination unit 236 determines, as the behavior of the robot 100, any one of a plurality of types of robot behaviors including performing no operation by using at least one of the state of the user 10, the emotion of the user 10, the emotion of the robot 100, or the state of the robot 100, and the behavior determination model 221 at a predetermined timing. Here, a case where the text generation model having the dialogue function is used as the behavior determination model 221 will be described as an example.

Specifically, the behavior determination unit 236 inputs a text representing at least one of the state of the user 10, the emotion of the user 10, the emotion of the robot 100, or the state of the robot 100 and a text for inquiry about the robot behavior to the text generation model, and determines the behavior of the robot 100 based on an output of the text generation model.

For example, the plurality of types of robot behaviors include the following behaviors (1) to (11).
(1) The robot does nothing.
(2) The robot dreams.
(3) The robot speaks to the user.
(4) The robot creates a picture diary.
(5) The robot proposes an activity.
(6) The robot proposes a person the user should meet.
(7) The robot introduces news that the user is interested in.
(8) The robot edits pictures and moving images.
(9) The robot studies with the user.
(10) The robot recalls memory.
(11) The robot has a conversation with another robot.

The behavior determination unit 236 inputs, to the text generation model, a text representing the state of the user 10 and the state of the robot 100 that are recognized by a state recognition unit 230, and the current emotion value of the user 10 and the current emotion value of the robot 100 that are determined by the emotion determination unit 232, and a text for inquiry about any one of the plurality of types of robot behaviors including performing no operation, every lapse of a certain period of time, and determines the behavior of the robot 100 based on an output of the text generation model. Here, in a case where the user 10 is absent around the robot 100, a text to be input to the text generation model need not include the state of the user 10 and the current emotion value of the user 10, or may include information indicating that the user 10 is absent.

As an example, the following text is input to the text generation model:
“The robot is in a very pleasant state. The user is in a normally pleasant state. The user is sleeping. Among the following behaviors (1) to (11), which behavior is appropriate for the robot?
(1) The robot does nothing.
(2) The robot dreams.
(3) The robot speaks to the user.
. . . ”. Based on an output of the text generation model stating that “(1) the robot does nothing or (2) the robot dreams can be considered to be the most appropriate behavior”, the behavior “(1) the robot does nothing” or the behavior “(2) the robot dreams” is determined as the behavior of the robot 100.

As another example, the following text is input to the text generation model:
“The robot is in a slightly lonely state. The user is absent. The surroundings of the robot are dark. Among the following behaviors (1) to (11), which behavior is appropriate for the robot?
(1) The robot does nothing.
(2) The robot dreams.
(3) The robot speaks to the user.
. . . ”. Based on an output of the text generation model stating that “(2) The robot dreams or (4) the robot creates a picture diary can be considered to be the most appropriate behavior”, the behavior “(2) The robot dreams” or the behavior “(4) The robot creates a picture diary” is determined as the behavior of the robot 100.

In a case where the behavior determination unit 236 determines, as the robot behavior, the behavior “(2) The robot dreams”, that is, creation of an original event, the behavior determination unit 236 creates the original event obtained by combining a plurality of pieces of event data in history data 222 by using the text generation model. At this time, the storage control unit 238 stores the created original event in the history data 222

In a case where the behavior determination unit 236 determines, as the robot behavior, the behavior “(3) The robot speaks to the user”, that is, utterance by the robot 100, the behavior determination unit 236 determines the utterance content of the robot, which corresponds to the state of the user and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(7) The robot introduces news that the user is interested in”, the behavior determination unit 236 determines the utterance content of the robot, which corresponds to information stored in the collected data 223, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(4) The robot creates a picture diary”, that is, creation of an event image by the robot 100, the behavior determination unit 236 generates an image representing event data selected from the history data 222 by using the image generation model, generates an explanatory sentence representing the event data by using the text generation model, and outputs a combination of the image representing the event data and the explanatory sentence representing the event data as the event image. In a case where the user 10 is absent around the robot 100, the behavior control unit 250 stores the event image in the scheduled behavior data 224 without outputting the event image.

In a case where the behavior determination unit 236 determines, as the robot behavior, the behavior “(8) The robot edits pictures and moving images”, that is, image edition, the behavior determination unit 236 selects event data from the history data 222 based on the emotion value, edits image data of the selected event data, and outputs the edited image data. In a case where the user 10 is absent around the robot 100, the behavior control unit 250 stores the edited image data in the scheduled behavior data 224 without outputting the edited image data.

In a case where the behavior determination unit 236 determines, as the robot behavior, the behavior “(5) The robot proposes an activity”, that is, proposal of the behavior of the user 10, the behavior determination unit 236 determines the behavior of the user to be proposed by using the text generation model based on the event data stored in the history data 222. At this time, the behavior control unit 250 causes the speaker included in the control target 252 to output a speech for proposing the behavior of the user. In a case where the user 10 is absent around the robot 100, the behavior control unit 250 stores the proposal of the behavior of the user in the scheduled behavior data 224 without outputting the speech for proposing the behavior of the user.

In a case where the behavior determination unit 236 determines, as the robot behavior, the behavior “(6) The robot proposes a person the user should meet”, that is, proposal of a person the user 10 should connect with, the behavior determination unit 236 determines a person to be proposed as the person the user should connect with by using the text generation model based on the event data stored in the history data 222. At this time, the behavior control unit 250 causes the speaker included in the control target 252 to output a speech representing the proposal of a person the user should connect with. In a case where the user 10 is absent around the robot 100, the behavior control unit 250 stores the proposal of a person the user should connect with in the scheduled behavior data 224 without outputting the speech representing the proposal of a person the user should connect with.

In a case where the behavior determination unit 236 determines, as the robot behavior, the behavior “(9) The robot studies with the user”, that is, utterance by the robot 100 about study, the behavior determination unit 236 determines the utterance content of the robot for encouraging study, posing questions, or providing study-related advice, which corresponds to the user state and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(10) The robot recalls memory”, that is, recalling of the event data, the behavior determination unit 236 selects the event data from the history data 222. At this time, the emotion determination unit 232 determines the emotion of the robot 100 based on the selected event data. Furthermore, the behavior determination unit 236 creates an emotion changing event representing the utterance content or behavior of the robot 100 for changing the emotion value of the user by using the text generation model based on the selected event data. At this time, the storage control unit 238 stores the emotion changing event in the scheduled behavior data 224.

For example, in a case where information indicating that a moving image the user was watching was related to a panda is stored in the history data 222 as the event data, and the event data is selected, a prompt like “What are three things the robot could say the next time the robot meets the user, based on the topic of pandas?” is input to the text generation model, in a case where an output of the text generation model is “(1) Let's go to the zoo, (2) Let's draw a picture of a panda, and (3) Let's go buy a panda-shaped stuffed toy”, the robot 100 inputs a prompt like “Which of (1), (2), or (3) is most likely to make the user happiest?” to the text generation model, and in a case where an output of the text generation model is “(1) Let's go to the zoo”, uttering “(1) Let's go to the zoo” by the robot 100 when the robot 100 meets the user next is created as the emotion changing event and stored in the scheduled behavior data 224.

Further, for example, event data having a large emotion value of the robot 100 is selected as an impressive memory of the robot 100. As a result, it is possible to create the emotion changing event based on the event data selected as the impressive memory.

In a case where the behavior determination unit 236 determines, as the robot behavior, the behavior “(11) The robot has a conversation with another robot”, conversation with another robot 100, the behavior determination unit 236 determines a conversation to be uttered by using a sentence generation model based on event data stored in history data 222. At this time, the behavior control unit 250 causes the speaker included in the control target 252 to output a speech of the determined conversation. Similarly, another robot 100 determines a conversation to be uttered by using the sentence generation model based on the event data stored in the history data 222.

Furthermore, for the behavior “(11) The robot has a conversation with another robot”, the related information collection unit 270 periodically collects information such as a favorite baseball team, a favorite singer, and a favorite hobby of another robot 100 from external data by using, for example, ChatGPT plugins. For the behavior “(11) The robot has a conversation with another robot”, a storage control unit 238 periodically detects a behavior (an utterance content and a motion) of another robot 100 as a state of another robot 100 and stores the detected behavior in the history data 222. The related information collection unit 270 of another robot 100 also collects information such as a favorite baseball team, a favorite singer, and a favorite hobby of the robot 100 from the external data, and the storage control unit 238 also periodically detects the behavior (the utterance content and the motion) of the robot 100 as the state of the robot 100 and stores the detected behavior in the history data 222.

It is desirable that the outputting of the conversation by the behavior determination unit 236 is not started in a case where the user instructs the robot 100 to have a conversation with another robot 100, but is autonomously performed by the robot 100.

In a case where the behavior of the user 10 for the robot 100 is detected following a state in which the user 10 does nothing for the robot 100 based on the state of the user 10 recognized by the state recognition unit 230, the behavior determination unit 236 reads data stored in the scheduled behavior data 224 and determines the behavior of the robot 100.

For example, in a case where the user 10 is absent around the robot 100, the behavior determination unit 236 reads data stored in the scheduled behavior data 224 and determines the behavior of the robot 100 in response to detection of the user 10. In addition, in a case where the user 10 is sleeping, the behavior determination unit 236 reads data stored in the scheduled behavior data 224 and determines the behavior of the robot 100 in response to the user 10 waking up.

### Seventh Other Example

A seventh other example of the processing performed by the behavior determination unit 236 in a case where the robot 100 performs the autonomous processing of autonomously performing a behavior will be described.

In the autonomous processing in the present embodiment, the robot 100 serving as an agent collects all pieces of information regarding a family member who is a user. The robot 100 constantly and spontaneously collects an interest, a concern, a hobby, a preference, an orientation, and the like of each family member, such as favorite music, favorite song, or favorite baseball team, and recognizes the interest, the concern, the hobby, the preference, the orientation, and the like of each family member. Then, in a case where a party is held on a birthday or an anniversary of the family member, the robot 100 participates in the party as a surprise according to an emotion value of the family member who is a user 10 and/or the robot 100. Furthermore, at the party, the robot 100 plays favorite music of the family member based on the interest, the concern, the hobby, the preference, the orientation, and the like of each family member, and spontaneously presents a picture diary, a picture, a moving image, and the like of a memorable event collected so far to help create a great memory in consideration of preferences, concerns, and the like of the family member.

The behavior determination unit 236 determines, as the behavior of the robot 100, any one of a plurality of types of robot behaviors including performing no operation by using at least one of the state of the user 10, the emotion of the user 10, the emotion of the robot 100, or the state of the robot 100, and the behavior determination model 221 at a predetermined timing. Here, a case where the text generation model having the dialogue function is used as the behavior determination model 221 will be described as an example.

Specifically, the behavior determination unit 236 inputs a text representing at least one of the state of the user 10, the emotion of the user 10, the emotion of the robot 100, or the state of the robot 100 and a text for inquiry about the robot behavior to the text generation model, and determines the behavior of the robot 100 based on an output of the text generation model.

For example, the plurality of types of robot behaviors include the following behaviors (1) to (11).
(1) The robot does nothing.
(2) The robot dreams.
(3) The robot speaks to the user.
(4) The robot creates a picture diary.
(5) The robot proposes an activity.
(6) The robot proposes a person the user should meet.
(7) The robot introduces news that the user is interested in.
(8) The robot edits pictures and moving images.
(9) The robot studies with the user.
(10) The robot recalls memory.
(11) The robot participates in a party.

The behavior determination unit 236 inputs, to the text generation model, a text representing the state of the user 10 and the state of the robot 100 that are recognized by a state recognition unit 230, and the current emotion value of the user 10 and the current emotion value of the robot 100 that are determined by the emotion determination unit 232, and a text for inquiry about any one of the plurality of types of robot behaviors including performing no operation, every lapse of a certain period of time, and determines the behavior of the robot 100 based on an output of the text generation model. Here, in a case where the user 10 is absent around the robot 100, a text to be input to the text generation model need not include the state of the user 10 and the current emotion value of the user 10, or may include information indicating that the user 10 is absent.

As an example, the following text is input to the text generation model:
“The robot is in a very pleasant state. The user is in a normally pleasant state. The user is sleeping. Among the following behaviors (1) to (11), which behavior is appropriate for the robot?
(1) The robot does nothing.
(2) The robot dreams.
(3) The robot speaks to the user.
. . . ”. Based on an output of the text generation model stating that “(1) the robot does nothing or (2) the robot dreams can be considered to be the most appropriate behavior”, the behavior “(1) the robot does nothing” or the behavior “(2) the robot dreams” is determined as the behavior of the robot 100.

As another example, the following text is input to the text generation model:
“The robot is in a slightly lonely state. The user is absent. The surroundings of the robot are dark. Among the following behaviors (1) to (11), which behavior is appropriate for the robot?
(1) The robot does nothing.
(2) The robot dreams.
(3) The robot speaks to the user.
. . . ”. Based on an output of the text generation model stating that “(2) The robot dreams or (4) the robot creates a picture diary can be considered to be the most appropriate behavior”, the behavior “(2) The robot dreams” or the behavior “(4) The robot creates a picture diary” is determined as the behavior of the robot 100.

In a case where the behavior determination unit 236 determines, as the robot behavior, the behavior “(2) The robot dreams”, that is, creation of an original event, the behavior determination unit 236 creates the original event obtained by combining a plurality of pieces of event data in history data 222 by using the text generation model. At this time, the storage control unit 238 stores the created original event in the history data 222

In a case where the behavior determination unit 236 determines, as the robot behavior, the behavior “(3) The robot speaks to the user”, that is, utterance by the robot 100, the behavior determination unit 236 determines the utterance content of the robot, which corresponds to the state of the user and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(7) The robot introduces news that the user is interested in”, the behavior determination unit 236 determines the utterance content of the robot, which corresponds to information stored in the collected data 223, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(4) The robot creates a picture diary”, that is, creation of an event image by the robot 100, the behavior determination unit 236 generates an image representing event data selected from the history data 222 by using the image generation model, generates an explanatory sentence representing the event data by using the text generation model, and outputs a combination of the image representing the event data and the explanatory sentence representing the event data as the event image. In a case where the user 10 is absent around the robot 100, the behavior control unit 250 stores the event image in the scheduled behavior data 224 without outputting the event image.

In a case where the behavior determination unit 236 determines, as the robot behavior, the behavior “(8) The robot edits pictures and moving images”, that is, image edition, the behavior determination unit 236 selects event data from the history data 222 based on the emotion value, edits image data of the selected event data, and outputs the edited image data. In a case where the user 10 is absent around the robot 100, the behavior control unit 250 stores the edited image data in the scheduled behavior data 224 without outputting the edited image data.

In a case where the behavior determination unit 236 determines, as the robot behavior, the behavior “(5) The robot proposes an activity”, that is, proposal of the behavior of the user 10, the behavior determination unit 236 determines the behavior of the user to be proposed by using the text generation model based on the event data stored in the history data 222. At this time, the behavior control unit 250 causes the speaker included in the control target 252 to output a speech for proposing the behavior of the user. In a case where the user 10 is absent around the robot 100, the behavior control unit 250 stores the proposal of the behavior of the user in the scheduled behavior data 224 without outputting the speech for proposing the behavior of the user.

In a case where the behavior determination unit 236 determines, as the robot behavior, the behavior “(6) The robot proposes a person the user should meet”, that is, proposal of a person the user 10 should connect with, the behavior determination unit 236 determines a person to be proposed as the person the user should connect with by using the text generation model based on the event data stored in the history data 222. At this time, the behavior control unit 250 causes the speaker included in the control target 252 to output a speech representing the proposal of a person the user should connect with. In a case where the user 10 is absent around the robot 100, the behavior control unit 250 stores the proposal of a person the user should connect with in the scheduled behavior data 224 without outputting the speech representing the proposal of a person the user should connect with.

In a case where the behavior determination unit 236 determines, as the robot behavior, the behavior “(9) The robot studies with the user”, that is, utterance by the robot 100 about study, the behavior determination unit 236 determines the utterance content of the robot for encouraging study, posing questions, or providing study-related advice, which corresponds to the user state and the emotion of the user or the emotion of the robot, by using the text generation model. At this time, the behavior control unit 250 causes the speaker included in the control target 252 to output a speech representing the determined utterance content of the robot. In a case where the user 10 is absent around the robot 100, the behavior control unit 250 stores the determined utterance content of the robot in the scheduled behavior data 224 without outputting the speech representing the determined utterance content of the robot.

In a case where the behavior determination unit 236 determines, as the robot behavior, the behavior “(10) The robot recalls memory”, that is, recalling of the event data, the behavior determination unit 236 selects the event data from the history data 222. At this time, the emotion determination unit 232 determines the emotion of the robot 100 based on the selected event data. Furthermore, the behavior determination unit 236 creates an emotion changing event representing the utterance content or behavior of the robot 100 for changing the emotion value of the user by using the text generation model based on the selected event data. At this time, the storage control unit 238 stores the emotion changing event in the scheduled behavior data 224.

For example, in a case where information indicating that a moving image the user was watching was related to a panda is stored in the history data 222 as the event data, and the event data is selected, a prompt like “What are three things the robot could say the next time the robot meets the user, based on the topic of pandas?” is input to the text generation model, in a case where an output of the text generation model is “(1) Let's go to the zoo, (2) Let's draw a picture of a panda, and (3) Let's go buy a panda-shaped stuffed toy”, the robot 100 inputs a prompt like “Which of (1), (2), or (3) is most likely to make the user happiest?” to the text generation model, and in a case where an output of the text generation model is “(1) Let's go to the zoo”, uttering “(1) Let's go to the zoo” by the robot 100 when the robot 100 meets the user next is created as the emotion changing event and stored in the scheduled behavior data 224.

Further, for example, event data having a large emotion value of the robot 100 is selected as an impressive memory of the robot 100. As a result, it is possible to create the emotion changing event based on the event data selected as the impressive memory.

In a case where the behavior determination unit 236 determines, as the robot behavior, the behavior “(11) The robot participates in a party”, that is, participation of the robot 100 in the party, the behavior determination unit 236 determines participation in the party by monitoring a behavior of the family member who is the user or by using the sentence generation model based on the event data stored in the history data 222.

Furthermore, for the behavior “(11) The robot participates in a party”, the related information collection unit 270 collects information related to the preferences and concerns, such as the interest, the concern, the hobby, the preference, the orientation, and the like of the family member, who is the user, for each family member.

Furthermore, for the behavior “(11) The robot participates in a party”, the storage control unit 238 stores the information related to the preferences and concerns collected by the related information collection unit 270 in the collected data 223 for each family member.

For example, in a case where a family member has held a party on a birthday or an anniversary, the robot 100 according to the present embodiment participates in the party as a surprise. In addition, the robot 100 participates in the party based on the event data stored in the history data 222. Then, the robot 100 determines, as the behavior, execution of a predetermined event for the family member based on the emotion of the family member and/or the robot 100 participating in the party. Specifically, the robot 100 participates in the party based on any one or more of the interest, the concern, the hobby, the preference, the orientation, a predetermined anniversary, and the like of each family member, which are included in the information related to the preferences and concerns of the family member stored in the collected data 223, and determines a behavior to be performed in the party.

For example, the robot 100 can execute an event to heighten the emotion of the family member and/or the robot 100 based on the history data 222 including the emotion value of the family member and/or the robot 100 and the collected data 223. As a specific example, the robot 100 plays the favorite music of the family member, plays a picture, a moving image, or the like of the past birthday or anniversary, or spontaneously presents picture diaries of the past anniversaries on a birthday or an anniversary of the family member to help create a great memory in consideration of the preferences, concerns, and the like of the family member.

In a case where the behavior of the user 10 for the robot 100 is detected following a state in which the user 10 does nothing for the robot 100 based on the state of the user 10 recognized by the state recognition unit 230, the behavior determination unit 236 reads data stored in the scheduled behavior data 224 and determines the behavior of the robot 100.

For example, in a case where the user 10 is absent around the robot 100, the behavior determination unit 236 reads data stored in the scheduled behavior data 224 and determines the behavior of the robot 100 in response to detection of the user 10. In addition, in a case where the user 10 is sleeping, the behavior determination unit 236 reads data stored in the scheduled behavior data 224 and determines the behavior of the robot 100 in response to the user 10 waking up.

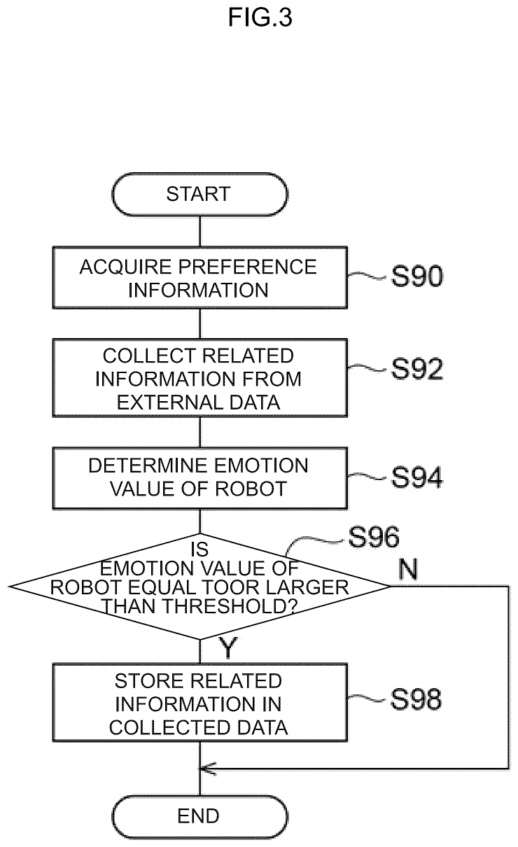

FIG. 3 schematically shows an example of an operation flow related to collection processing of collecting the information related to the preference information of the user 10. The operation flow shown in FIG. 3 is repeatedly performed at regular intervals. It is assumed that the preference information indicating matters of interest to the user 10 is acquired from the utterance content of the user 10 or the setting operation performed by the user 10. “S” in the operation flow represents a step to be performed.

First, in step S90, the related information collection unit 270 acquires the preference information indicating matters of interest to the user 10.

In step S92, the related information collection unit 270 collects the information related to the preference information from the external data.

In step S94, the emotion determination unit 232 determines the emotion value of the robot 100 based on the information related to the preference information, which is collected by the related information collection unit 270.

In step S96, the storage control unit 238 determines whether or not the emotion value of the robot 100 determined in step S94 is equal to or larger than the threshold. In a case where the emotion value of the robot 100 is smaller than the threshold, the collected information related to the preference information is not stored in the collected data 223, and the processing ends. On the other hand, in a case where the emotion value of the robot 100 is equal to or larger than the threshold, the processing proceeds to step S98.

In step S98, the storage control unit 238 stores the collected information related to the preference information in the collected data 223, and ends the processing.

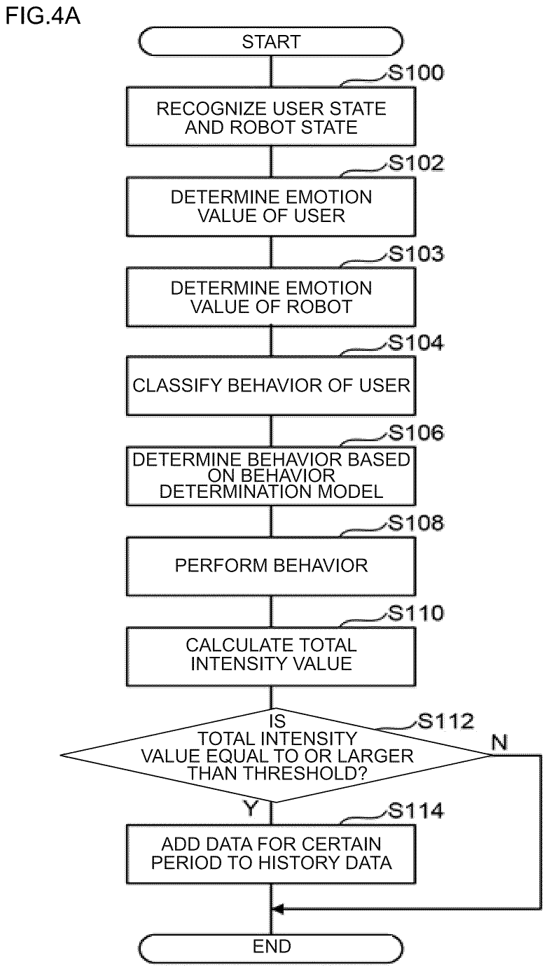

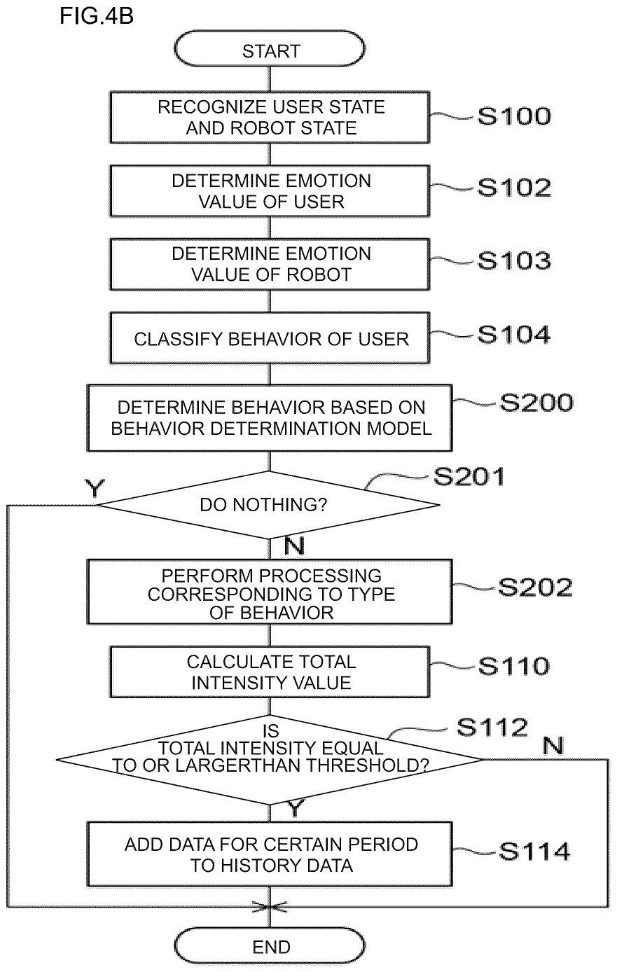

FIG. 4A schematically shows an example of an operation flow related to an operation of determining the behavior in the robot 100 in a case where the robot 100 performs response processing of responding to the behavior of the user 10. The operation flow shown in FIG. 4A is repeatedly performed. At this time, it is assumed that the information analyzed by the sensor module unit 210 is input.

First, in step S100, the state recognition unit 230 recognizes the state of the user 10 and the state of the robot 100 based on the information analyzed by the sensor module unit 210.

In step S102, the emotion determination unit 232 determines the emotion value indicating the emotion of the user 10 based on the information analyzed by the sensor module unit 210 and the state of the user 10 recognized by the state recognition unit 230.

In step S103, the emotion determination unit 232 determines the emotion value indicating the emotion of the robot 100 based on the information analyzed by the sensor module unit 210 and the state of the user 10 recognized by the state recognition unit 230. The emotion determination unit 232 adds the determined emotion value of the user 10 and the determined emotion value of the robot 100 to the history data 222.

In step S104, the behavior recognition unit 234 recognizes a behavior classification of the user 10 based on the information analyzed by the sensor module unit 210 and the state of the user 10 recognized by the state recognition unit 230.

In step S106, the behavior determination unit 236 determines the behavior of the robot 100 based on a combination of the current emotion value of the user 10 determined in step S102 and the past emotion value included in the history data 222, the emotion value of the robot 100, the behavior of the user 10 recognized in step S104, and the behavior determination model 221.

In step S108, the behavior control unit 250 controls the control target 252 based on the behavior determined by the behavior determination unit 236.

In step S110, the storage control unit 238 calculates the total intensity value based on the predetermined behavior intensity for the behavior determined by the behavior determination unit 236 and the emotion value of the robot 100 determined by the emotion determination unit 232.

In step S112, the storage control unit 238 determines whether or not the total intensity value is equal to or larger than the threshold. In a case where the total intensity value is smaller than the threshold, the event data including the behavior of the user 10 is not stored in the history data 222, and the processing ends. On the other hand, in a case where the total intensity value is equal to or larger than the threshold, the processing proceeds to step S114.

In step S114, the event data including the behavior determined by the behavior determination unit 236, the information analyzed by the sensor module unit 210 over a certain period prior to the current time point, and the state of the user 10 recognized by the state recognition unit 230 is stored in the history data 222.

FIG. 4B schematically shows an example of an operation flow related to an operation of determining the behavior in the robot 100 in a case where the robot 100 performs the autonomous processing of autonomously performing a behavior. The operation flow shown in FIG. 4B is repeatedly and automatically performed, for example, every lapse of a certain period of time. At this time, it is assumed that the information analyzed by the sensor module unit 210 is input. Processing similar to that in FIG. 4A is represented by the same step number.

First, in step S100, the state recognition unit 230 recognizes the state of the user 10 and the state of the robot 100 based on the information analyzed by the sensor module unit 210.

In step S102, the emotion determination unit 232 determines the emotion value indicating the emotion of the user 10 based on the information analyzed by the sensor module unit 210 and the state of the user 10 recognized by the state recognition unit 230.

In step S103, the emotion determination unit 232 determines the emotion value indicating the emotion of the robot 100 based on the information analyzed by the sensor module unit 210 and the state of the user 10 recognized by the state recognition unit 230. The emotion determination unit 232 adds the determined emotion value of the user 10 and the determined emotion value of the robot 100 to the history data 222.

In step S104, the behavior recognition unit 234 recognizes a behavior classification of the user 10 based on the information analyzed by the sensor module unit 210 and the state of the user 10 recognized by the state recognition unit 230.

In step S200, the behavior determination unit 236 determines, as the behavior of the robot 100, any one of the plurality of types of robot behaviors including performing no operation based on the state of the user 10 recognized in step S100, the emotion of the user 10 determined in step S102, the emotion of the robot 100, the state of the robot 100 recognized in step S100, the behavior of the user 10 recognized in step S104, and the behavior determination model 221.

In step S201, the behavior determination unit 236 determines whether or not it is determined in step S200 that the robot 100 does nothing. In a case where it is determined that the robot 100 does nothing as the behavior of the robot 100, the processing ends. On the other hand, in a case where it is not determined that the robot 100 does nothing as the behavior of the robot 100, the processing proceeds to step S202.

In step S202, the behavior determination unit 236 performs processing according to a type of the robot behavior determined in step S200 described above. At this time, the behavior control unit 250, the emotion determination unit 232, or the storage control unit 238 performs processing according to the type of the robot behavior.

In step S110, the storage control unit 238 calculates the total intensity value based on the predetermined behavior intensity for the behavior determined by the behavior determination unit 236 and the emotion value of the robot 100 determined by the emotion determination unit 232.

In step S112, the storage control unit 238 determines whether or not the total intensity value is equal to or larger than the threshold. In a case where the total intensity value is smaller than the threshold, the data including the behavior of the user 10 is not stored in the history data 222, and the processing ends. On the other hand, in a case where the total intensity value is equal to or larger than the threshold, the processing proceeds to step S114.

In step S114, the storage control unit 238 stores, in the history data 222, the behavior determined by the behavior determination unit 236, the information analyzed by the sensor module unit 210 over a certain period prior to the current time point, and the state of the user 10 recognized by the state recognition unit 230.

As described above, with the robot 100, the emotion value indicating the emotion of the robot 100 is determined based on the state of the user, and whether or not to store the data including the behavior of the user 10 in the history data 222 is determined based on the emotion value of the robot 100. As a result, a volume of the history data 222 that stores the data including the behavior of the user 10 can be reduced. Then, for example, in a case where the robot 100 determines that the state of the user after ten years matches the state of the user from ten years earlier, the robot 100 can read the history data 222 from ten years ago and present, to the user 10, the state of the user 10 from ten years earlier (for example, the facial expression or emotion of the user 10), and further, any surrounding information such as data of a sound, an image, and a scent at that time.

Further, with the robot 100, it is possible to cause the robot 100 to perform an appropriate behavior for the behavior of the user 10. Hitherto, a behavior of the user has been classified to determine a behavior including a facial expression or appearance of the robot. On the other hand, the robot 100 determines the current emotion value of the user 10 and performs a behavior for the user 10 based on the past emotion value and the current emotion value. Therefore, for example, in a case where the user 10 who seemed fine yesterday is depressed today, the robot 100 can make an utterance such as “You seemed fine yesterday. What's wrong today?”. Further, the robot 100 can also make an utterance with a gesture. Further, for example, in a case where the user 10 who was depressed yesterday seems fine today, the robot 100 can make an utterance such as “You seemed down yesterday, but you look fine today!”. Further, for example, in a case where the user 10 who seemed fine yesterday looks better today than yesterday, the robot 100 can make an utterance such as “You look better today than yesterday. Did anything good happen since yesterday?”. Further, for example, the robot 100 can make an utterance such as “You've been in a really stable mood lately. That's great!” for the user 10 whose emotion value is 0 or more and whose emotion value fluctuation continuously remains within a certain range.

Further, for example, in a case where the robot 100 asks the user 10, “Did you finish the homework you mentioned yesterday?”, and the user 10 answers “Yeah, I did”, the robot 100 can make a positive utterance such as “Good job!” and make a positive gesture such as applause or thumbs-up. Further, for example, in a case where the user 10 makes an utterance “The presentation I talked about the day before yesterday went well”, the robot 100 can make a positive utterance such as “Nice effort!” and also make the above affirmative gesture. As described above, the robot 100 performs a behavior based on a history of the state of the user 10, whereby it can be expected that the user 10 feels a sense of closeness toward the robot 100.

Further, for example, in a case where the emotion value of “pleasure” as the emotion of the user 10 is equal to or larger than the threshold when the user 10 is watching a moving image related to a panda, a scene where the panda appears in the moving image may be stored in the history data 222 as the event data.

The robot 100 can always learn what conversation the user should have to maximize the emotion value expressing the happiness of the user, by using data accumulated in the history data 222 and the collected data 223.

Further, in a state in which the robot 100 is not having a conversation with the user 10, it is possible to autonomously start a behavior based on the emotion of the robot 100.

Further, in the autonomous processing, the robot 100 repeats automatically generating a question, inputting the question to the text generation model, and acquiring an output of the text generation model as an answer for the question, so that it is possible to create an emotion changing event for enhancing a positive emotion and store the emotion changing event in the scheduled behavior data 224. In this manner, the robot 100 can perform self-learning.

Further, in a case where the robot 100 automatically generates a question in a state in which a trigger is not received from the outside, the question can be automatically generated based on impressive event data specified from the history of the past emotion value of the robot.

Further, the related information collection unit 270 can perform self-learning by repeating a search execution stage of automatically performing keyword search according to the preference information of the user and acquiring a search result.

Here, in the search execution stage, the keyword search may be automatically performed based on the impressive event data specified from the history of the past emotion value of the robot in a state in which a trigger is not received from the outside.

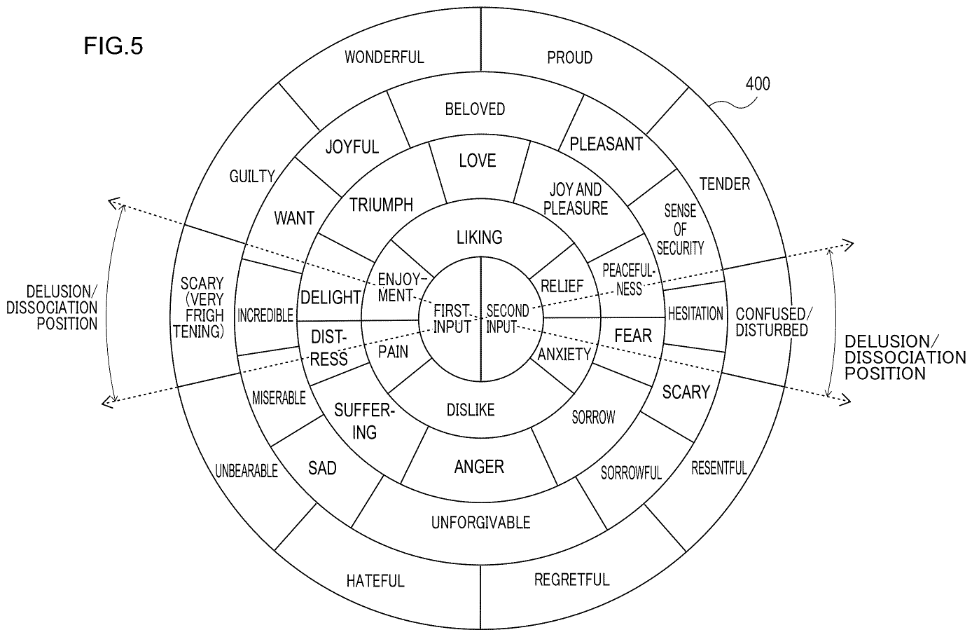

The emotion determination unit 232 may determine the emotion of the user according to a specific mapping. Specifically, the emotion determination unit 232 may determine the emotion of the user based on an emotion map (see FIG. 5) representing the specific mapping.

FIG. 5 is a diagram showing an emotion map 400 in which a plurality of emotions are mapped. In the emotion map 400, emotions are arranged radially in concentric circles from the center. The closer to the center of the concentric circle, the more primitive the emotion is. Emotions representing states and behaviors arising from a mental state are arranged on an outer side of the concentric circle. The emotion is a concept including emotional reactions and psychological conditions. Emotions arising from reactions generally occurring in the brain are arranged on a left side of the concentric circle. Emotions induced by situation determination are generally arranged on a right side of the concentric circle. Emotions arising from reactions generally occurring in the brain and induced by situation determination are arranged in an upward direction and a downward direction of the concentric circle. Further, emotions of “comfort” are arranged on an upper side of the concentric circle, and emotions of “discomfort” are arranged on a lower side of the concentric circle. As described above, in the emotion map 400, a plurality of emotions are mapped based on a structure in which emotions arise, and emotions that are likely to arise at the same time are mapped close to each other.
(1) For example, in a case where the emotion engine, which is the emotion determination unit 232 of the robot 100, detects an emotion about every 100 msec, determination of a reaction operation (for example, a backchannel response) of the robot 100 may be performed at at least a similar frequency to the detection frequency (100 msec) of the emotion engine, or may be performed at a frequency higher than the detection frequency. The detection frequency of the emotion engine may be interpreted as a sampling rate.

The emotion is detected about every 100 msec, and the reaction operation (for example, the backchannel response) is performed immediately in conjunction with the detection, whereby an unnatural backchannel response is not performed, and a natural and smooth dialogue can be implemented. The robot 100 performs the reaction operation (such as the backchannel response) according to a direction and a magnitude (intensity) in the mandala-like emotion map 400. The detection frequency (sampling rate) of the emotion engine is not limited to 100 ms, and may be changed according to a situation (such as a case of playing sports), an age of the user, or the like.
(2) According to the emotion map 400, a direction and an intensity of an emotion may be set in advance, and a backchannel response motion and an intensity of the backchannel response may be set. For example, in a case where the robot 100 feels a sense of stability, relief, or the like, the robot 100 continues to listen while nodding. In a case where the robot 100 feels anxious, lost, or suspicious, the robot 100 may tilt the head thereof or stop movement of the head.

Such emotions are distributed at 3 o'clock positions on the emotion map 400 and usually range between relief and anxiety. In the right half of the emotion map 400, since situational awareness takes precedence over internal sensations, a calm impression is conveyed.
(3) In a case where the robot 100 experiences pleasure from being praised, a filler such as “Oh” may be inserted before an utterance. In a case where the robot 100 feels a sense of pain from receiving harsh words, a filler “Ugh!” may be inserted before an utterance. Further, the robot 100 may also perform a physical reaction such as a gesture of crouching while saying “Ugh!”. Such emotions are distributed around 9 o'clock positions on the emotion map 400.
(4) In the left half of the emotion map 400, internal sensations (reactions) take precedence over situational awareness. Therefore, an impression of an involuntary reaction can be conveyed.

In a case where the robot 100 has a favorable impression through situational awareness while experiencing an internal sensation (reaction) of acceptance, the robot 100 may nod deeply while looking at the counterpart, or may utter “Mm-hmm”. In this manner, the robot 100 may produce a balanced favorable impression for the counterpart, that is, perform a behavior expressing permissiveness or tolerance toward the counterpart. Such emotions are distributed around 12 o'clock positions on the emotion map 400.

On the other hand, in a case where the robot 100 has an unfavorable impression also through situational awareness while experiencing an internal sensation (reaction) of discomfort, the robot 100 may shake the head sideways, and in a case where the robot 100 feels hatred, the robot 100 may illuminate the LED of the eye in red and glare at the counterpart. Such emotions are distributed around 6 o'clock positions on the emotion map 400.
(5) Since an inner side of the emotion map 400 represents feelings and an outer side of the emotion map 400 represents behaviors, the emotions on the outer side of the emotion map 400 are more visible (appear in behaviors).
(6) In a case where the robot 100 listens to a speech of a person while feeling relief distributed around the 3 o'clock position on the emotion map 400, the robot 100 slightly nods the head vertically and says “Hmm-hmm”. However, in a case where the robot 100 feels love distributed around the 12 o'clock position, the robot 100 may perform a more forceful and deeper vertical nod.

Here, an emotion of a person is based on various forms of balance, such as a posture and a blood glucose level, and an emotion of discomfort arises in a case where the balance deviates from the ideal and an emotion of comfort arises in a case where the balance approaches the ideal. Even in the case of a robot, an automobile, a motorcycle, or the like, it is possible to generate emotions such that the emotion of discomfort arises in a case where the balance deviates from the ideal and the emotion of comfort arises in a case where the balance approaches the ideal based on various forms of balances, such as a posture and a remaining battery level. The emotion map may be generated, for example, based on an emotion map (Research on the phonetic recognition of feelings and a system for emotional physiological brain signal analysis, Tokushima University, PhD thesis: https://ci.nii.ac.jp/naid/500000375379) of Dr. Mitsuyoshi. In the left half of the emotion map, emotions belonging to a region called “reaction” in which a sensation takes precedence are arranged. Further, in the right half of the emotion map, emotions belonging to a region called “situation” in which situational awareness takes precedence are arranged.

In the emotion map, two emotions encouraging learning are defined. One is a negative emotion positioned on a situation side, around the middle between “remorse” and “self-reflection”. That is, learning is encouraged in a case where the robot experiences a negative emotion such as “I never want to go through this again” or “I don't want to be scolded anymore”. The other is a positive emotion positioned on a reaction side, around “desire”. That is, learning is encouraged in a case where the robot experiences a positive feeling such as “I want more” or “I want to know more”.

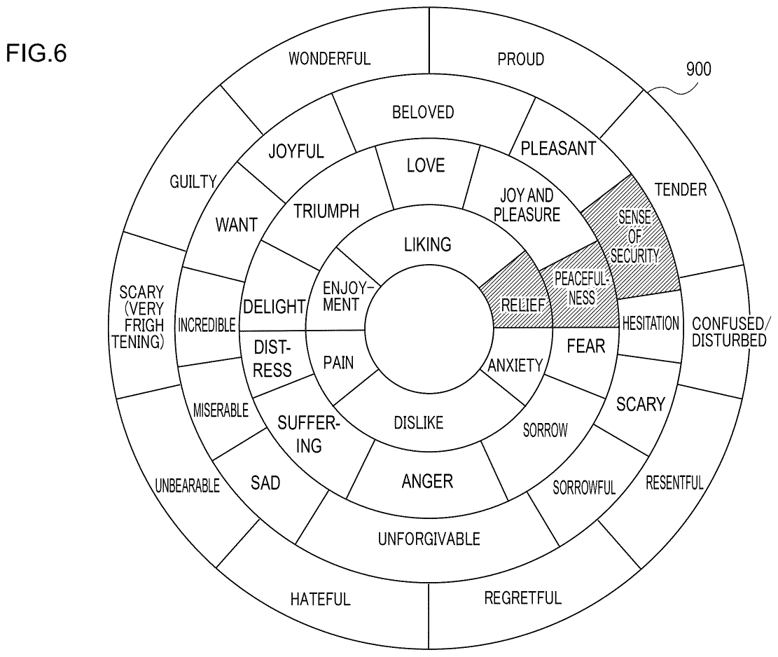

The emotion determination unit 232 inputs the information analyzed by the sensor module unit 210 and the recognized state of the user 10 to the neural network trained in advance, acquires the emotion value indicating each emotion indicated in the emotion map 400, and determines the emotion of the user 10. The neural network is trained in advance based on a plurality of pieces of learning data, which are a combination of the information analyzed by the sensor module unit 210, the recognized state of the user 10, and the emotion value indicating each emotion indicated in the emotion map 400. Furthermore, the neural network is trained such that emotions arranged close to each other as in an emotion map 900 shown in FIG. 6 have close values. FIG. 6 shows an example in which a plurality of emotions such as “relief”, “peacefulness”, and “sense of security” have similar emotion values.

Further, the emotion determination unit 232 may determine the emotion of the robot 100 according to the specific mapping. Specifically, the emotion determination unit 232 inputs the information analyzed by the sensor module unit 210, the state of the user 10 recognized by the state recognition unit 230, and the state of the robot 100 to the neural network trained in advance, acquires the emotion value indicating each emotion indicated in the emotion map 400, and determines the emotion of the robot 100. The neural network is trained in advance based on a plurality of pieces of learning data, which are a combination of the information analyzed by the sensor module unit 210, the recognized state of the user 10, the state of the robot 100, and the emotion value indicating each emotion shown in the emotion map 400. For example, the neural network is trained based on the learning data indicating that the emotion value “3” of “joyful” is obtained in a case where it is recognized that the robot 100 is being stroked by the user 10 from an output of the touch sensor (not shown), and the learning data indicating that the emotion value “3” of “anger” is obtained in a case where it is recognized that the robot 100 is being hit by the user 10 from an output of an acceleration sensor 206. Furthermore, the neural network is trained such that emotions arranged close to each other as in an emotion map 900 shown in FIG. 6 have close values.

The behavior determination unit 236 generates the behavior content of the robot by adding a fixed sentence for inquiry about the behavior content of the robot corresponding to the behavior of the user to a text representing the behavior of the user, the emotion of the user, and the emotion of the robot, and inputting the text to the text generation model having the dialogue function.

For example, the behavior determination unit 236 acquires a text representing the state of the robot 100 from the emotion of the robot 100 determined by the emotion determination unit 232 using an emotion table as shown in Table 1. Here, in the emotion table, an index number is assigned to each emotion value for each type of emotion, and the text representing the state of the robot 100 is stored for each index number.

In a case where the emotion of the robot 100 determined by the emotion determination unit 232 corresponds to an index number “2”, a text “very pleasant state” is obtained. In a case where the emotion of the robot 100 corresponds to a plurality of index numbers, a plurality of texts representing the states of the robot 100 are obtained.

Further, an emotion table as shown in Table 2 is prepared for the emotion of the user 10.

Here, in a case where the behavior of the user is a behavior of saying “Let's do something fun together!”, the emotion of the robot 100 corresponds to the index number “2”, and the emotion of the user 10 corresponds to an index number “3”, a text “The robot is in a very pleasant state. The user is in a normally pleasant state. The user said, “Let's do something fun together!”. How should the robot respond?” is input to the text generation model to thereby acquire the behavior content of the robot. The behavior determination unit 236 determines the behavior of the robot based on the behavior content.

TABLE 1

| Index | | | |
|---|---|---|---|
| number | Type of emotion | Emotion value | State of robot |
| 1 | Pleasant | 5 | Extremely pleasant state |
| 2 | Pleasant | 4 | Very pleasant state |
| 3 | Pleasant | 3 | Normally pleasant state |
| 4 | Pleasant | 2 | Slightly pleasant state |
| 5 | Pleasant | 1 | Faintly pleasant state |
| . . . | . . . | . . . | . . . |

TABLE 2

| Index | | | |
|---|---|---|---|
| number | Type of emotion | Emotion value | State of user |
| 1 | Pleasant | 5 | Extremely pleasant state |
| 2 | Pleasant | 4 | Very pleasant state |
| 3 | Pleasant | 3 | Normally pleasant state |
| 4 | Pleasant | 2 | Slightly pleasant state |
| 5 | Pleasant | 1 | Faintly pleasant state |
| . . . | . . . | . . . | . . . |

As described above, the behavior determination unit 236 determines the behavior content of the robot 100 according to a state related to the emotion of the robot 100 set in advance for each type of the emotion of the robot 100 and for each intensity of the emotion, and the behavior of the user 10. In the embodiment, the utterance content of the robot 100 in a case where a dialogue with the user 10 is performed can be branched according to the state related to the emotion of the robot 100. That is, since the robot 100 can change the behavior of the robot according to the index number corresponding to the emotion of the robot, the user is given an impression that the robot has a mind, and is promoted to perform a behavior such as talking to the robot.

Further, the behavior determination unit 236 may generate the behavior content of the robot by adding the fixed sentence for inquiry about the behavior content of the robot corresponding to the behavior of the user after adding not only the text representing the behavior of the user, the emotion of the user, and the emotion of the robot but also a text representing a content of the history data 222, and inputting the fixed sentence to the text generation model having the dialogue function. As a result, the robot 100 can change the behavior of the robot according to the history data indicating the emotion and the behavior of the user, and thus, the user is given an impression that the robot has a personality, and is promoted to perform a behavior such as talking to the robot. Furthermore, the history data may further include the emotion and the behavior of the robot.

Further, the emotion determination unit 232 may determine the emotion of the robot 100 based on the behavior content of the robot 100 generated by the text generation model. Specifically, the emotion determination unit 232 inputs the behavior content of the robot 100 generated by the text generation model to the neural network trained in advance, acquires the emotion value indicating each emotion indicated in the emotion map 400, integrates the acquired emotion value indicating each emotion and the emotion value indicating each emotion of the current robot 100, and updates the emotion of the robot 100. For example, the acquired emotion value indicating each emotion and the current emotion value indicating each emotion of the robot 100 are each averaged and integrated. The neural network is trained in advance based on a plurality of pieces of learning data, which are a combination of the text representing the behavior content of the robot 100 generated by the text generation model and the emotion value representing each emotion indicated in the emotion map 400.

For example, in a case where an utterance content of the robot 100, “That's great. You were lucky”, is obtained as the behavior content of the robot 100 generated by the text generation model, when a text representing the utterance content is input to the neural network, a large value is obtained as the emotion value of the emotion “joyful”, and the emotion of the robot 100 is updated such that the emotion value of the emotion “joyful” becomes large.

In the robot 100, a method in which the text generation model such as a generative AI and the emotion determination unit 232 cooperate with each other, and the robot 100 has an ego and continues to grow with various parameters even while the user is not speaking is performed.

The generative AI is a large language model using a deep learning method. The generative AI can also refer to the external data, and for example, a technology that refers to various types of external data such as weather information and hotel reservation information and outputs an answer as accurately as possible through conversation has been known as the ChatGPT plugins. For example, with the generative AI, providing a goal in natural language can allow for automatic generation of source code in various programming languages. For example, when problematic source code is given, the generative AI can debug the source code, find issues, and automatically generate improved source code. By combining such capabilities, autonomous agents that repeatedly generate and debug code until the issues of the source code are resolved once a goal is provided in natural language have emerged. As such autonomous agents, AutoGPT, babyAGI, JARVIS, E2B, and the like are known.

In the robot 100 according to the present embodiment, the event data to be learned may be stored in a database containing impressive memories by using a technology, in which event data that evokes strong emotions for the robot is retained for a longer time, and event data that elicits little emotional response from the robot is quickly forgotten, as described in Patent Literature 2 (Japanese Patent No. 6199927).

Further, the robot 100 may record video data of the user 10 acquired by a camera function and the like in the history data 222. The robot 100 may acquire the video data or the like from the history data 222 if necessary and provide the video data or the like to the user 10. The robot 100 may generate video data having a larger information amount as the intensity of the emotion is higher and record the video data in the history data 222. For example, in a case where information in a high-compression format such as skeleton data is recorded, the robot 100 may switch to recording of information in a low-compression format such as an HD moving image in response to the emotion value of excitement exceeding the threshold. With the robot 100, for example, it is possible to leave, as a record, high-definition video data in a case where the emotion of the robot 100 increases.

In a case where the robot 100 is not talking with the user 10, the robot 100 may automatically load event data from the history data 222 in which impressive event data is stored, and the emotion determination unit 232 may continue to update the emotion of the robot. In a case where the robot 100 is not talking with the user 10 and the emotion of the robot 100 becomes an emotion encouraging learning, the robot 100 can create an emotion changing event for changing the emotion of the user 10 to be positive based on the impressive event data. As a result, autonomous learning (recalling of event data) at an appropriate timing according to a state of the emotion of the robot 100 can be implemented, and autonomous learning appropriately reflecting the state of the emotion of the robot 100 can be implemented.

The emotion encouraging learning is an emotion around “remorse” and “self-reflection” on the emotion map of Dr. Mitsuyoshi in a negative state, and is an emotion of “desire” on the emotion map in a positive state.

In the negative state, the robot 100 may treat “remorse” and “self-reflection” on the emotion map as the emotions encouraging learning. In the negative state, the robot 100 may treat emotions adjacent to “remorse” and “self-reflection” as the emotions encouraging learning, in addition to “remorse” and “self-reflection” on the emotion map. For example, the robot 100 treats at least one of “regret”, “stubbornness”, “self-destruction”, “self-admonition”, “repentance”, and “despair” as the emotions encouraging learning, in addition to “remorse” and “self-reflection”. As a result, for example, autonomous learning can be performed in a case where the robot 100 has a negative feeling such as “I never want to go through this again” or “I don't want to be scolded anymore”.

In the positive state, the robot 100 may treat “desire” on the emotion map as the emotion encouraging learning. In the positive state, the robot 100 may treat an emotion adjacent to “desire” as the emotion encouraging learning in addition to “desire”. For example, the robot 100 treats at least one of “joyful”, “elation”, “yearning”, “expectation”, and “self-consciousness” as the emotions encouraging learning, in addition to “desire”. As a result, for example, autonomous learning can be performed in a case where the robot 100 has a positive feeling such as “I want more” or “I want to know more”.

The robot 100 does not have to perform autonomous learning in a case where the robot 100 has an emotion other than the emotion encouraging learning as described above. As a result, for example, it is possible to prevent autonomous learning from being performed in a case where the robot 100 is extremely angry or is blindly feeling love.

The emotion changing event is, for example, to propose a behavior following an impressive event. The behavior following the impressive event refers to an emotion label positioned on the outermost side of the emotion map. For example, a behavior expressing “tolerance” or “permissiveness” follows the emotion of “love”.

In autonomous learning performed in a case where the robot 100 is not talking with the user 10, the emotion changing event is created using the text generation model by combining emotions, situations, behaviors, and the like of people appearing in the impressive memory and the robot 100.

It is assumed that all the emotion values are represented on a six-grade evaluation scale ranging from 0 to 5, and a case where event data indicating that “My friend was hit and appeared upset” is stored in the history data 222 as impressive event data is considered. Here, it is assumed that the “friend” refers to the user 10, the emotion of the user 10 is “disgust”, and 5 is set as a value representing “disgust”. Further, it is assumed that the emotion of the robot 100 is “anxiety”, and 4 is set as a value representing “anxiety”.

The robot 100 can continue to grow with various parameters by performing autonomous processing while not talking with the user 10. Specifically, for example, as the uppermost event data arranged in descending order of emotion values, event data indicating that “My friend was hit and appeared upset” is loaded from the history data 222. It is assumed that “anxiety” with an intensity of 4 is associated with the loaded event data as the emotion of the robot 100, and here, “disgust” with an intensity of 5 is associated with the emotion of the user 10 who is the friend. In a case where the current emotion value of the robot 100 is “relief” with an intensity of 3 before loading, an influence of “anxiety” with the intensity of 4 and “disgust” with the intensity of 5 is added after loading, and the emotion value of the robot 100 may change to “regret” meaning “regretful”. At this time, since “regret” is the emotion encouraging learning, the robot 100 determines to recall the event data as the robot behavior and creates the emotion changing event. At this time, information input to the text generation model is a text representing the impressive event data, such as “My friend was hit and appeared upset” in this example. Further, in the emotion map, “disgust” is positioned on the innermost side, and “attack” positioned on the outermost side is predicted to be a corresponding behavior thereof. Accordingly, in this case, the emotion changing event is created so as to avoid a possibility that the friend “attacks” someone.

For example, by solving a fill-in-the-blank question using the information regarding the impressive event data, it is possible to automatically generate the following input text:

“The user was hit. At that time, the user felt strong disgust. The robot was very anxious. Please suggest phrases the robot could say to the user the next time the robot meets the user. Each phrase should be no more than 30 characters long. Please make sure the phrases are not dependent on the time of day. Please avoid direct expression. The number of candidates to be suggested is three.

### <Expected Format>

Candidate 1: (a phrase the robot should say to the user)
Candidate 2: (a phrase the robot should say to the user)
Candidate 3: (a phrase the robot should say to the user)”.

At this time, for example, an output of the text generation model is as follows:
“Candidate 1: Are you okay? I was concerned about what happened yesterday.
Candidate 2: I was thinking about what happened yesterday. Is there anything I can do?
Candidate 3: I was worried. Would you like to talk about it?”

Further, the robot 100 may automatically generate the following input text for information obtained by creating the emotion changing event.

“In a case where “the user was hit”, how might the user feel when the robot speaks the following phrases to the user? The emotion of the user is expressed in the form of “joy A, anger B, sorrow C, and pleasure D”, and A to D are integers on a six-grade evaluation scale ranging from 0 to 5.
Candidate 1: Are you okay? I was concerned about what happened yesterday.
Candidate 2: I was thinking about what happened yesterday. Is there anything I can do?
Candidate 3: I was worried. Would you like to talk about it?”

At this time, for example, an output of the text generation model is as follows:
“The emotion of the user may be as follows:
Candidate 1: joy 3, anger 1, sorrow 2, and pleasure 2
Candidate 2: joy 2, anger 1, sorrow 3, and pleasure 2
Candidate 3: joy 2, anger 1, sorrow 3, and pleasure 3”

In this manner, the robot 100 may perform deliberation processing after creating the emotion changing event.

Finally, the robot 100 may create the emotion changing event by using Candidate 1 that is most likely to make the user happy among the plurality of candidates, store the emotion changing event in the scheduled behavior data 224, and prepare for the next meeting with the user 10.

As described above, even in a state of not having a conversation with a family or a friend, the emotion value of the robot is continuously determined using the information of the history data 222 in which the impressive event data is stored, and in a case where the emotion value of the robot becomes the emotion encouraging learning, the robot 100 performs autonomous learning in a state of not having a conversation with the user 10 according to the emotion of the robot 100, and continues to update the history data 222 and the scheduled behavior data 224.

The above is an example using the emotion value. However, in the emotion map, the emotion can be generated based on the amount of hormone secreted and an event type. Therefore, values associated with the impressive event data may include the type of hormone, the amount of hormone secreted, and the event type.

Hereinafter, specific examples will be described.

For example, even in a state of not talking with the user, the robot 100 checks information regarding a topic or hobby of interest to the user.

For example, even in a state of not talking with the user, the robot 100 checks information regarding a birthday or an anniversary of the user and generates a congratulatory message.

For example, even in a state of not talking with the user, the robot 100 checks reviews for places, foods, or products that the user wants to visit or try.

For example, even in a state of not talking with the user, the robot 100 checks weather information and provides advice suitable for a schedule or plan of the user.

For example, even in a state of not talking with the user, the robot 100 checks information regarding local events and festivals and proposes the information to the user.

For example, even in a state of not talking with the user, the robot 100 checks a game result of sports and news that the user is interested in to provide a topic.

For example, even in a state of not talking with the user, the robot 100 checks and introduces information regarding favorite pieces of music or artists of the user.

For example, even in a state of not talking with the user, the robot 100 checks information regarding social problems and news that the user is interested in to provide an opinion.

For example, even in a state of not talking with the user, the robot 100 checks information regarding a hometown or a native region of the user to provide a topic.

For example, even in a state of not talking with the user, the robot 100 checks information regarding a job or a school of the user to provide advice.

Even in a state of not talking with the user, the robot 100 checks and introduces information regarding books, comics, movies, and dramas that the user is interested in.

For example, even in a state of not talking with the user, the robot 100 checks information regarding the health of the user to provide advice.

For example, even in a state of not talking with the user, the robot 100 checks information regarding a travel plan of the user to provide advice.

For example, even in a state of not talking with the user, the robot 100 checks information regarding repair or maintenance of a house or a car of the user to provide advice.

For example, even in a state of not talking with the user, the robot 100 checks information regarding beauty and fashion that the user is interested in to provide advice.

For example, even in a state of not talking with the user, the robot 100 checks information regarding a pet of the user to provide advice.

For example, even in a state of not talking with the user, the robot 100 checks information regarding contests and events related to the hobby or the job of the user to make recommendations.

For example, even in a state of not talking with the user, the robot 100 checks information regarding a favorite restaurant or dining spot of the user to make recommendations.

For example, even in a state of not talking with the user, the robot 100 collects information regarding important decisions related to the life of the user to provide advice.

For example, even in a state of not talking with the user, the robot 100 checks information regarding a person the user is worried about to provide advice.

### Second Embodiment

In a second embodiment, a robot 100 is mounted on a stuffed toy or is applied to a control device connected wirelessly or by wire to control target equipment (speaker or camera) mounted on a stuffed toy. Portions having similar configurations to those of the first embodiment are denoted by the same reference numerals, and a description thereof is omitted.

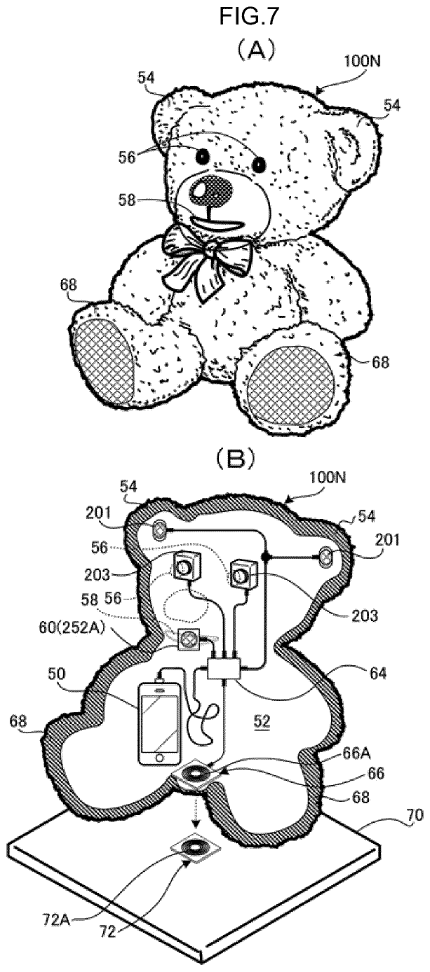

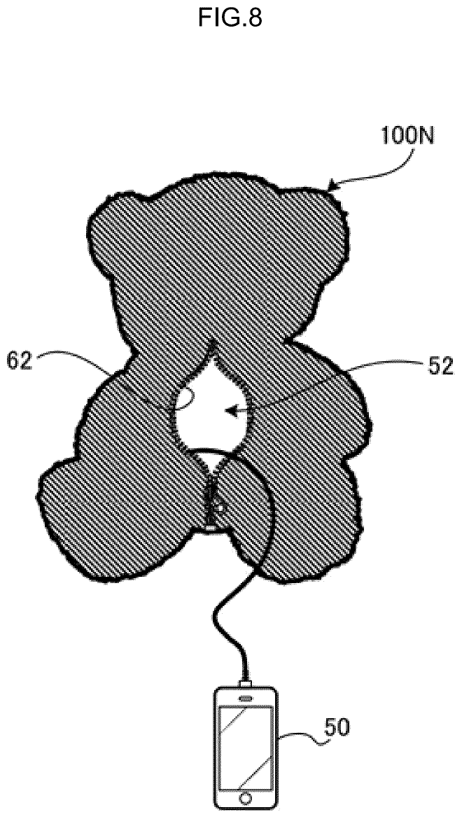

Specifically, the second embodiment has the following configuration. For example, the robot 100 is applied to a cohabiting companion (specifically, a stuffed toy 100N shown in FIGS. 7 and 8) that has a dialogue with a user 10 based on information regarding daily life and provides information tailored to preferences of the user 10 while spending daily life with the user 10. In the second embodiment, an example in which a control portion of the robot 100 is applied to a smartphone 50 is described.

The smartphone 50 functioning as the control portion of the robot 100 is attachable to and detachable from the stuffed toy 100N having a function as an input/output device of the robot 100, and the input/output device and the housed smartphone 50 are connected inside the stuffed toy 100N.

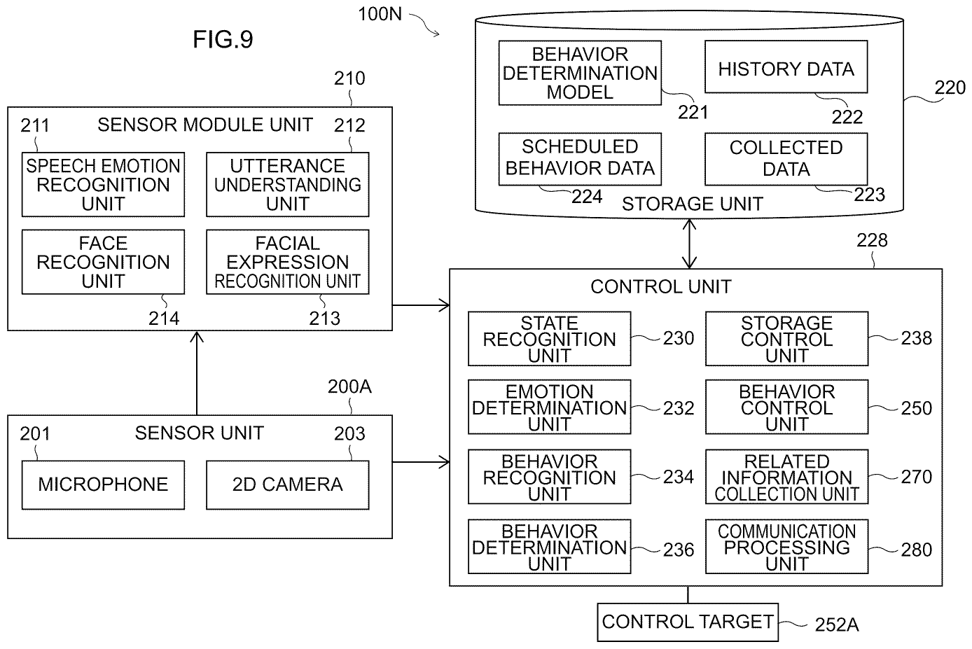

As shown in FIG. 7(A), the stuffed toy 100N has a shape of a bear covered with a soft cloth fabric in the present embodiment (another embodiment), and a sensor unit 200A and a control target 252A are disposed as the input/output devices in a space portion 52 formed inside the stuffed toy 100N (see FIG. 9). The sensor unit 200A includes a microphone 201 and a 2D camera 203. Specifically, as shown in FIG. 7(B), in the space portion 52, the microphone 201 of the sensor unit 200A is disposed at a portion corresponding to an ear 54, the 2D camera 203 of the sensor unit 200A is disposed at a portion corresponding to an eye 56, and a speaker 60 forming a part of the control target 252A is disposed at a portion corresponding to a mouth 58. The microphone 201 and the speaker 60 are not necessarily separated from each other, and may be formed as an integrated unit. In a case where the microphone 201 and the speaker 60 are formed as the unit, it is preferable to dispose the unit at a position where an utterance can be heard naturally, such as a position of a nose of the stuffed toy 100N. Although a case where the stuffed toy 100N has an animal shape has been described as an example, the disclosure is not limited thereto. The stuffed toy 100N may have a shape of a specific character.

FIG. 9 schematically shows a functional configuration of the stuffed toy 100N. The stuffed toy 100N includes the sensor unit 200A, a sensor module unit 210, a storage unit 220, a control unit 228, and the control target 252A.

The smartphone 50 housed in the stuffed toy 100N of the present embodiment performs processing similar to that of the robot 100 of the first embodiment. That is, the smartphone 50 has a function as the sensor module unit 210, a function as the storage unit 220, and a function as the control unit 228, which are shown in FIG. 9.

As shown in FIG. 8, a fastener 62 is attached to a part (for example, a back portion) of the stuffed toy 100N, and the outside and the space portion 52 communicate with each other by opening the fastener 62.

Here, the smartphone 50 is housed in the space portion 52 from the outside and is USB-connected to each input/output device via a USB hub 64 (see FIG. 7(B)), so that functions equivalent to those of the robot 100 of the first embodiment can be provided.

A non-contact power receiving plate 66 is connected to the USB hub 64. A power receiving coil 66A is incorporated in the power receiving plate 66. The power receiving plate 66 is an example of a wireless power receiving unit that receives wireless power supply.

The power receiving plate 66 is disposed near root portions 68 of both feet of the stuffed toy 100N and is positioned closest to a placement base 70 in a case where the stuffed toy 100N is placed on the placement base 70. The placement base 70 is an example of an external wireless power transmitting unit.

The stuffed toy 100N placed on the placement base 70 can be appreciated as an ornament in a natural state.

Further, the root portion is formed to have a thickness smaller than a thickness of a surface layer of the stuffed toy 100N at other portions, and is held in a state closer to the placement base 70.

The placement base 70 includes a charging pad 72. A power transmitting coil 72A is incorporated in the charging pad 72. When the power transmitting coil 72A transmits a signal to search the power receiving coil 66A of the power receiving plate 66, and the power receiving coil 66A is found, a current flows through the power transmitting coil 72A to generate a magnetic field, and the power receiving coil 66A reacts to the magnetic field to start electromagnetic induction. As a result, a current flows through the power receiving coil 66A, and power is stored in a battery (not shown) of the smartphone 50 via the USB hub 64.

That is, since the smartphone 50 is automatically charged by placing the stuffed toy 100N as an ornament on the placement base 70, it is not necessary to take out the smartphone 50 from the space portion 52 of the stuffed toy 100N for charging.

In the second embodiment, the smartphone 50 is housed in the space portion 52 of the stuffed toy 100N and connected by wire (USB connection), but the disclosure is not limited thereto. For example, a control device having a wireless function (for example, “Bluetooth (registered trademark)”) may be housed in the space portion 52 of the stuffed toy 100N, and the control device may be connected to the USB hub 64. In this case, the smartphone 50 and the control device wirelessly communicate with each other in a state in which the smartphone 50 is not inserted into the space portion 52, and the smartphone 50 positioned outside is connected to each input/output device via the control device, so that functions equivalent to those of the robot 100 of the first embodiment can be provided. Further, the control device is housed in the space portion 52 of the stuffed toy 100N and the smartphone 50 positioned outside may be connected by wire.

Further, in the second embodiment, the bear-shaped stuffed toy 100N has been exemplified, but the shape of the stuffed toy 100N may be another animal, a doll, or a shape of a specific character. Further, clothes of the stuffed toy 100N may be able to be changed. Further, a material of an outer surface is not limited to the cloth fabric and may be other materials such as soft vinyl. It is preferable that the material of the outer surface is a soft material.

Further, a monitor may be attached to the outer surface of the stuffed toy 100N, and the control target 252A that provides information to the user 10 through vision may be added. For example, the eye 56 may be used as the monitor to express joy, anger, sorrow, and pleasure, or a window through which a built-in monitor of the smartphone 50 is visible may be provided at a belly portion. Further, the eye 56 may be used as a projector to express joy, anger, sorrow, and pleasure by an image projected on a wall surface.

According to the second embodiment, the existing smartphone 50 is inserted into the stuffed toy 100N, and the camera 203, the microphone 201, the speaker 60, and the like are extended from the smartphone 50 to appropriate positions via USB connection.

Further, for wireless charging, the smartphone 50 and the power receiving plate 66 are USB-connected to each other, and the power receiving plate 66 is disposed as close to the outer side of the stuffed toy 100N as possible when viewed from the inside.

In order to use the wireless charging of the smartphone 50, the smartphone 50 needs to be positioned as close to the outer side of the stuffed toy 100N as possible when viewed from the inside, which may result in a rough tactile sensation when the stuffed toy 100N is touched from the outside.

Therefore, the smartphone 50 is disposed as close to the center of the stuffed toy 100N as possible, and a wireless charging function (power receiving plate 66) is disposed as close to the outer side of the stuffed toy 100N as possible when viewed from the inside. The camera 203, the microphone 201, the speaker 60, and the smartphone 50 receive wireless power supply via the power receiving plate 66.

Other configurations and effects of the stuffed toy 100N of the second embodiment are similar to those of the robot 100 of the first embodiment, and thus a description thereof is omitted.

A part of the stuffed toy 100N (for example, the sensor module unit 210, the storage unit 220, and the control unit 228) may be provided outside the stuffed toy 100N (for example, a server), and the stuffed toy 100N may function as each unit of the stuffed toy 100N by communicating with the outside.

### Third Embodiment

In the first embodiment, a case where a behavior control system is applied to a robot 100 has been exemplified, but in a third embodiment, a robot 100 is used as an agent for having a dialogue with a user, and a behavior control system is applied to an agent system. Portions having similar configurations to those of the first and second embodiments are denoted by the same reference numerals, and a description thereof is omitted.

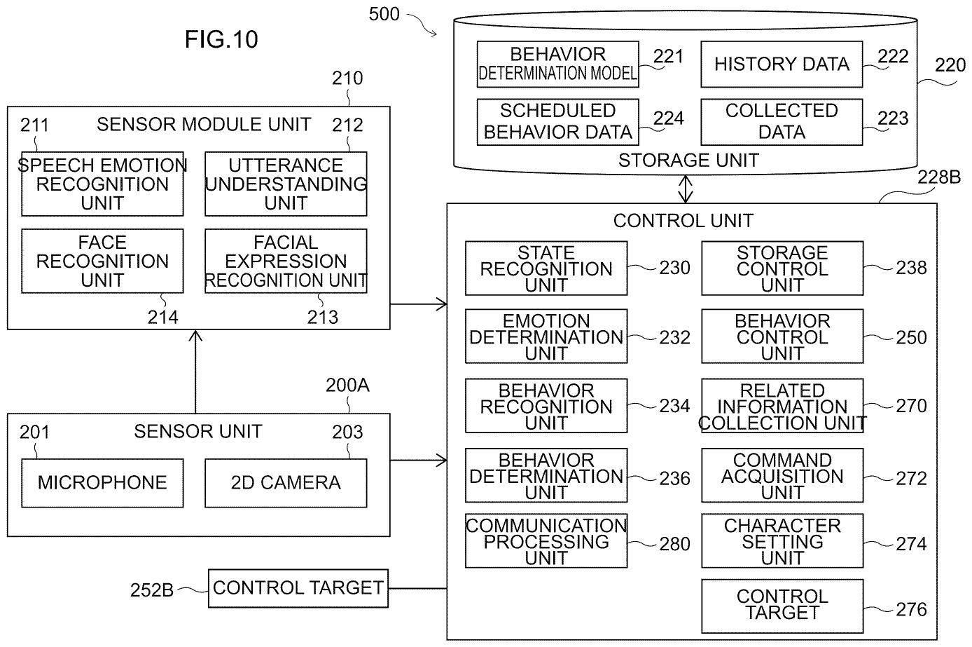

FIG. 10 is a functional block diagram of an agent system 500 implemented using some or all of functions of a behavior control system.

The agent system 500 is a computer system that performs a series of behaviors according to an intention of a user 10 through a dialogue with the user 10. The dialogue with the user 10 can be performed by voice or text.

The agent system 500 includes a sensor unit 200A, a sensor module unit 210, a storage unit 220, a control unit 228B, and a control target 252B.

The agent system 500 can be mounted on, for example, a robot, a doll, a stuffed toy, a wearable terminal (a pendant, a smartwatch, or smart glasses), a smartphone, a smart speaker, an earphone, or a personal computer. Further, the agent system 500 may be implemented in a web server and used via the web browser operating on a communication terminal such as a smartphone possessed by the user.

The agent system 500 serves as, for example, a butler, a secretary, a teacher, a partner, a friend, a lover, or a teacher, who performs a behavior for the user 10. The agent system 500 not only has a dialogue with the user 10 but also provides advice, guides to a destination, makes recommendations according to a preference of the user, or the like. In addition, the agent system 500 makes reservations, places orders, makes payments, or the like with a service provider.

As in the first embodiment, an emotion determination unit 232 determines an emotion of the user 10 and an emotion of the agent. A behavior determination unit 236 determines a behavior of the robot 100 in consideration of the emotions of the user 10 and the agent. In other words, the agent system 500 understands the emotion of the user 10 and reads a context to implement heartfelt support, assistance, advice, and service provision. Further, the agent system 500 listens to concerns of the user 10 and comforts, encourages, and cheers up the user. Further, the agent system 500 spends time with the user 10 and draws a picture diary to remind the user of the past. The agent system 500 performs a behavior that enables enhancement of a sense of happiness of the user 10. Here, the agent is an agent that operates on software.

The control unit 228B includes a state recognition unit 230, the emotion determination unit 232, a behavior recognition unit 234, the behavior determination unit 236, a storage control unit 238, a behavior control unit 250, a related information collection unit 270, a command acquisition unit 272, a robotic process automation (RPA) 274, a character setting unit 276, and a communication processing unit 280.

As in the first embodiment, the behavior determination unit 236 determines an utterance content of the agent for having a dialogue with the user 10 as a behavior of the agent. The behavior control unit 250 outputs the utterance content of the agent by at least one of voice and text through a speaker or a display serving as the control target 252B.

The character setting unit 276 sets a character of the agent in a case where the agent system 500 has a dialogue with the user 10 based on designation from the user 10. In other words, the utterance content output from the behavior determination unit 236 is output through the agent having the set character. As the character, for example, a real-life celebrity or famous person such as an actor, an entertainer, an idol, or an athlete can be set. Further, a fictitious character appearing in a cartoon, a movie, or an animation can also be set as the character. In a case where the character of the agent is known, since a voice, manner of speech, tone, and personality of the character are known, prompt setting in the character setting unit 276 is automatically performed only by the user 10 designating a character the user 10 likes. The voice, manner of speech, tone, and personality of the set character are reflected in a dialogue with the user 10. In other words, the behavior control unit 250 synthesizes a voice corresponding to the character set by the character setting unit 276, and outputs the utterance content of the agent using the synthesized voice. As a result, the user 10 can feel as if the user 10 is having a dialogue with a character (such as an actor) the user 10 likes.

In a case where the agent system 500 is mounted on a device including a display such as a smartphone, for example, an icon, a still image, or a moving image of the agent having the character set by the character setting unit 276 may be displayed on the display. An image of the agent is generated using, for example, an image composition technology such as 3D rendering. In the agent system 500, a dialogue with the user 10 may be carried out while the image of the agent makes a gesture corresponding to the emotion of the user 10, the emotion of the agent, and the utterance content of the agent. The agent system 500 may output only voice without outputting the image when having a dialogue with the user 10.

As in the first embodiment, the emotion determination unit 232 determines an emotion value indicating the emotion of the user 10 and an emotion value of the agent. In the present embodiment, the emotion value of the agent is determined instead of an emotion value of the robot 100. The emotion value of the agent is reflected in a set emotion of the character. In a case where the agent system 500 has a dialogue with the user 10, not only the emotion of the user 10 but also the emotion of the agent is reflected in the dialogue. In other words, the behavior control unit 250 outputs the utterance content in an aspect corresponding to the emotion determined by the emotion determination unit 232.

Further, the emotion of the agent is also reflected in a case where the agent system 500 performs a behavior for the user 10. For example, in a case where the user 10 requests the agent system 500 to take a picture, whether or not the agent system 500 takes a picture in response to the request of the user is determined according to a level of an emotion of “sadness” of the agent. In a case where the character has a positive emotion, the character has a favorable dialogue with or performs a favorable behavior for the user 10, and in a case where the character has a negative emotion, the character has an oppositional dialogue with or performs an oppositional behavior for the user 10.

History data 222 stores a history of a dialogue performed between the user 10 and the agent system 500 as event data. The storage unit 220 may be implemented by an external cloud storage. In the case of having a dialogue with the user 10 or performing a behavior for the user 10, the agent system 500 determines a dialogue content or a behavior content in consideration of a content of the dialogue history stored in the history data 222. For example, the agent system 500 grasps a hobby and the preference of the user 10 based on the dialogue history stored in the history data 222. The agent system 500 generates the dialogue content matching the hobby and the preference of the user 10 and makes recommendations. The behavior determination unit 236 determines the utterance content of the agent based on the dialogue history stored in the history data 222. In the history data 222, personal information such as a name, an address, a telephone number, and a credit card number of the user 10 acquired through a dialogue with the user 10 is stored. Here, the agent may spontaneously make an utterance for asking the user 10 about whether or not to register personal information, such as “Would you like to register your credit card number?”, and may store the personal information in the history data 222 according to an answer of the user 10.

As described in the first embodiment, the behavior determination unit 236 generates the utterance content based on a sentence generated using a text generation model. Specifically, the behavior determination unit 236 generates the utterance content of the agent by inputting, to the text generation model, a text or speech input by the user 10 and the emotions of both the user 10 and the character determined by the emotion determination unit 232 and the conversation history stored in the history data 222. At this time, the behavior determination unit 236 may generate the utterance content of the agent by further inputting the personality of the character set by the character setting unit 276 to the text generation model. In the agent system 500, the text generation model is not positioned on a front-end side serving as a touchpoint with the user 10, but is used as a tool of the agent system 500.

The command acquisition unit 272 acquires, by using an output of an utterance understanding unit 212, a command of the agent from a speech or a text uttered by the user 10 through a dialogue with the user 10. The command includes, for example, a content of a behavior to be performed by the agent system 500, such as information search, restaurant reservation, ticket arrangement, purchase of products or services, payment, route guidance to a destination, or recommendation provision.

The RPA 274 performs a behavior according to the command acquired by the command acquisition unit 272. For example, the RPA 274 performs a behavior related to use of a service provider, such as information search, restaurant reservation, ticket arrangement, purchase of products or services, or payment.

The RPA 274 reads the personal information of the user 10, which is necessary for performing the behavior related to the use of the service provider, from the history data 222 and uses the personal information. For example, in the case of purchasing a product in response to a request from the user 10, the agent system 500 reads and uses the personal information such as the name, the address, the telephone number, and the credit card number of the user 10 stored in the history data 222. It is unkind to request the user 10 to input the personal information in initial setting, which is also uncomfortable for the user. In the agent system 500 according to the present embodiment, the personal information acquired through a dialogue with the user 10 is stored, and read and used if necessary, instead of requesting the user 10 to input the personal information in the initial setting. As a result, it is possible to avoid making the user feel discomfort, and convenience of the user is improved.

The agent system 500 performs dialogue processing according to, for example, following steps 1 to 6.

(Step 1) The agent system 500 sets the character of the agent. Specifically, the character setting unit 276 sets the character of the agent in a case where the agent system 500 has a dialogue with the user 10 based on designation from the user 10.

(Step 2) The agent system 500 acquires a state of the user 10 including a speech or a text input from the user 10, the emotion value of the user 10, the emotion value of the agent, and the history data 222. Specifically, processing similar to steps S100 to S103 is performed to acquire the state of the user 10 including the speech or the text input from the user 10, the emotion value of the user 10, the emotion value of the agent, and the history data 222.

(Step 3) The agent system 500 determines the utterance content of the agent.

Specifically, the behavior determination unit 236 generates the utterance content of the agent by inputting, to the text generation model, the text or speech input by the user 10 and the emotions of both the user 10 and the character specified by the emotion determination unit 232 and the conversation history stored in the history data 222.

For example, the text or speech input by the user 10 and a text representing the emotions of both the user 10 and the character specified by the emotion determination unit 232 and the conversation history stored in the history data 222 are added with a fixed sentence “How would the agent respond in this situation?” and are then input to the text generation model to acquire the utterance content of the agent.

As an example, in a case where the text or speech input from the user 10 is “Please reserve a nice Chinese restaurant nearby for 7 o'clock tonight”, as the utterance content of the agent, “Certainly” and “Here are some recommended restaurants: 1. AAAA. 2. BBBB. 3. CCCC. 4. DDDD” are acquired.

Further, in a case where the text or speech input from the user 10 is “I'd like the fourth one, DDDD”, as the utterance content of the agent, “Certainly. I'll try to make a reservation. How many seats do you need?” is obtained.

(Step 4) The agent system 500 outputs the utterance content of the agent.

Specifically, the behavior control unit 250 synthesizes a voice corresponding to the character set by the character setting unit 276, and outputs the utterance content of the agent using the synthesized voice.

(Step 5) The agent system 500 determines whether or not it is a timing to execute the command of the agent.

Specifically, the behavior determination unit 236 determines whether or not it is a timing to execute the command of the agent based on an output of the text generation model. For example, in a case where the output of the text generation model indicates that the agent executes the command, it is determined that it is a timing to execute the command of the agent, and the processing proceeds to step 6. On the other hand, in a case where it is determined that it is not a timing to execute the command of the agent, the processing returns to step 2 described above.

(Step 6) The agent system 500 executes the command of the agent.

Specifically, the command acquisition unit 272 acquires the command of the agent from the speech or text uttered by the user 10 through a dialogue with the user 10. Then, the RPA 274 performs a behavior corresponding to the command acquired by the command acquisition unit 272. For example, in a case where the command is “information search”, information search is performed by a search site using a search query obtained through a dialogue with the user 10 and an application programming interface (API). The behavior determination unit 236 inputs a search result to the text generation model and generates the utterance content of the agent. The behavior control unit 250 synthesizes a voice corresponding to the character set by the character setting unit 276, and outputs the utterance content of the agent using the synthesized voice.

Further, in a case where the command is “restaurant reservation”, a reservation is made by making a phone call to a restaurant to be reserved through telephony software by using reservation information obtained through a conversation with the user 10, restaurant information of the restaurant to be reserved, and the API. At this time, the behavior determination unit 236 acquires the utterance content of the agent for a speech input from a counterpart by using the text generation model having a dialogue function. Then, the behavior determination unit 236 inputs a result of the restaurant reservation (whether or not the reservation is successful) to the text generation model, and generates the utterance content of the agent. The behavior control unit 250 synthesizes a voice corresponding to the character set by the character setting unit 276, and outputs the utterance content of the agent using the synthesized voice.

Then, the processing returns to step 2 described above.

In step 6, a result of a behavior (for example, restaurant reservation) performed by the agent is also stored in the history data 222. The result of the behavior performed by the agent stored in the history data 222 is utilized by the agent system 500 to grasp the hobby or the preference of the user 10. For example, in a case where the same restaurant is reserved a plurality of times, it may be recognized that the user 10 favors the restaurant, and a content of a reservation such as a reserved time slot, a course content, or a price may be used as criteria for selecting a restaurant at the time of the next reservation.

In this manner, the agent system 500 can perform the dialogue processing and perform the behavior related to use of the service provider if necessary.

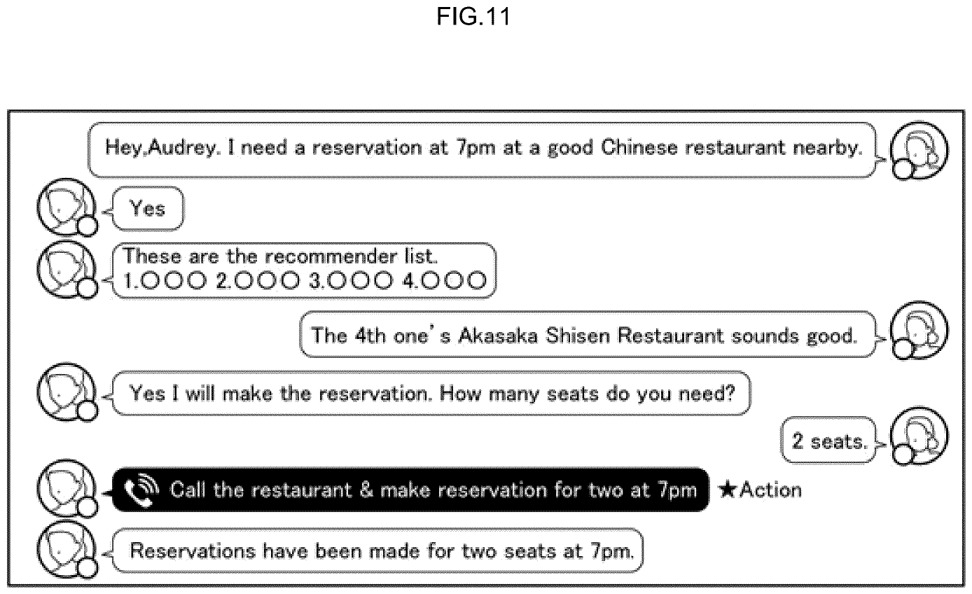

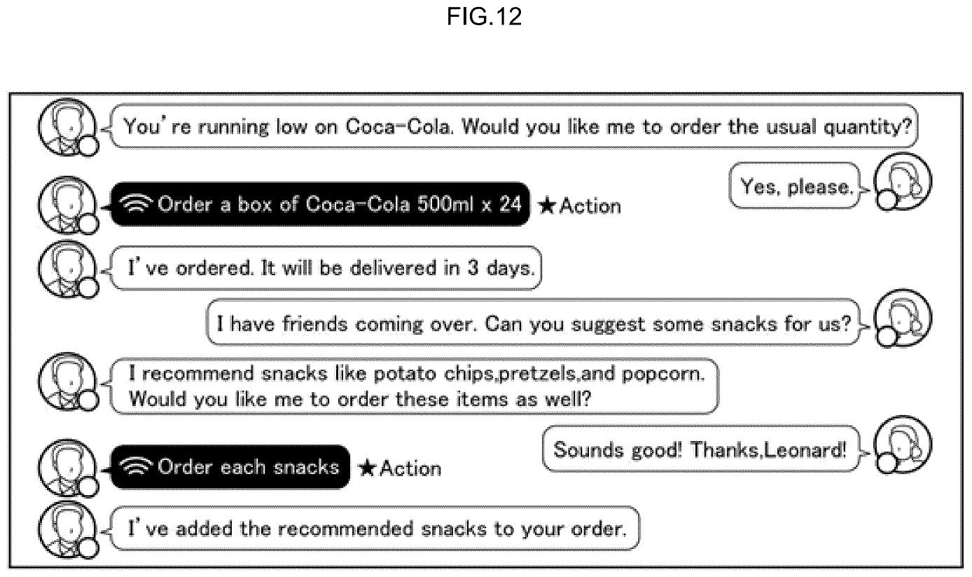

FIGS. 11 and 12 are diagrams showing an example of an operation of the agent system 500. FIG. 11 shows an aspect in which the agent system 500 makes a restaurant reservation through a dialogue with the user 10. In FIG. 11, the utterance content of the agent is shown on the left side, and the utterance content of the user 10 is shown on the right side. The agent system 500 can grasp the preference of the user 10 based on the history of the dialogue with the user 10, provide a list of recommended restaurants that match the preference of the user 10, and make a reservation of a selected restaurant.

On the other hand, FIG. 12 shows an aspect in which the agent system 500 accesses a mail-order site through a dialogue with the user 10 to purchase a product. In FIG. 12, the utterance content of the agent is shown on the left side, and the utterance content of the user 10 is shown on the right side. The agent system 500 can estimate the remaining amount of beverage the user has in stock based on the history of the dialogue with the user 10, suggest purchasing the beverage to the user 10, and carry out the purchase. Further, the agent system 500 can grasp the preference of the user based on the history of the past dialogue with the user 10, and recommend a snack that the user likes. In this manner, the agent system 500 supports, as the agent such as a butler, the daily life of the user 10 by performing various behaviors such as restaurant reservation or product purchase payment while communicating with the user 10.

Other configurations and effects of the agent system 500 of the third embodiment are similar to those of the robot 100 of the first embodiment, and thus a description thereof is omitted.

Furthermore, a part of the agent system 500 (for example, the sensor module unit 210, the storage unit 220, and the control unit 228B) may be provided outside a communication terminal such as a smartphone possessed by the user (for example, a server), and the communication terminal may function as each unit of the agent system 500 by communicating with the outside.

### Fourth Embodiment

In a fourth embodiment, the above-described agent system is applied to smart glasses. Portions having similar configurations to those of the first to third embodiments are denoted by the same reference numerals, and a description thereof is omitted.

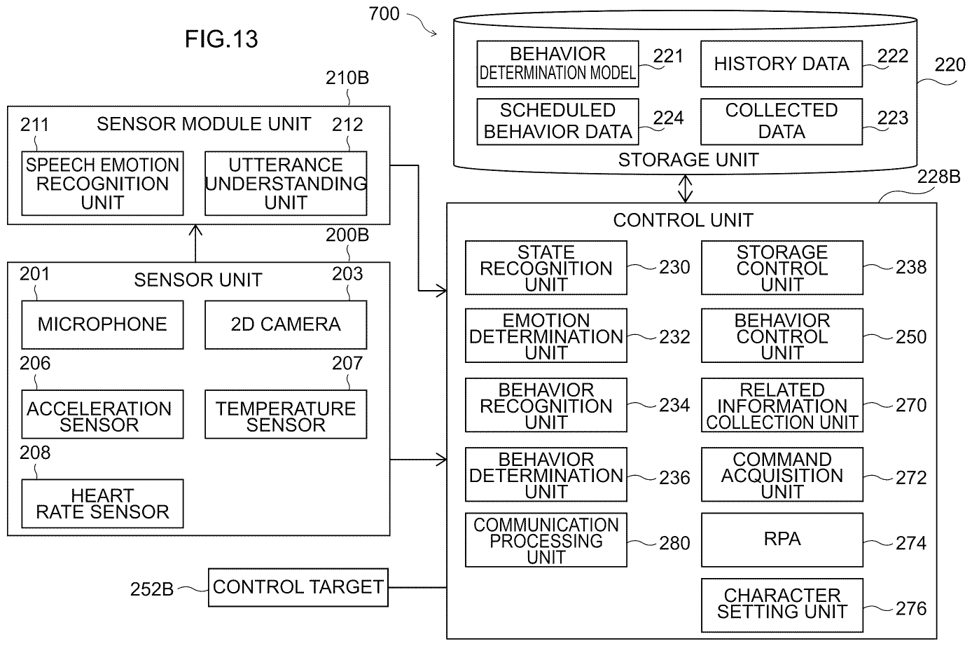

FIG. 13 is a functional block diagram of an agent system 700 implemented using some or all of functions of a behavior control system. The agent system 700 includes a sensor unit 200B, a sensor module unit 210B, a storage unit 220, a control unit 228B, and a control target 252B. The control unit 228B includes a state recognition unit 230, an emotion determination unit 232, a behavior recognition unit 234, a behavior determination unit 236, a storage control unit 238, a behavior control unit 250, a related information collection unit 270, a command acquisition unit 272, an RPA 274, a character setting unit 276, and a communication processing unit 280.

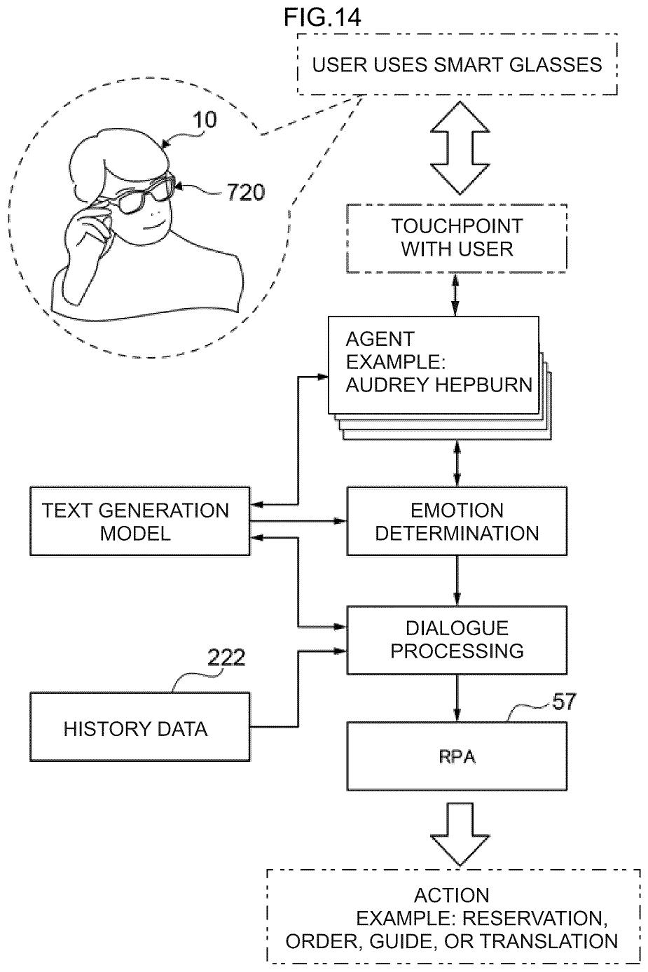

As shown in FIG. 14, smart glasses 720 are a glasses-type smart devices and are worn by a user 10 similarly to regular glasses. The smart glasses 720 are an example of electronic equipment and a wearable terminal.

The smart glasses 720 include the agent system 700. A display included in the control target 252B displays various types of information for the user 10. The display is, for example, a liquid crystal display. The display is provided, for example, at a lens portion of the smart glasses 720, and a display content can be visually recognized by the user 10. A speaker included in the control target 252B outputs a speech representing various types of information to the user 10. The smart glasses 720 include a touch panel (not shown), and the touch panel receives an input from the user 10.

An acceleration sensor 206, a temperature sensor 207, and a heart rate sensor 208 of the sensor unit 200B detect a state of the user 10. The sensors are merely examples, and it is a matter of course that other sensors may be mounted in order to detect the state of the user 10.

A microphone 201 acquires a speech uttered by the user 10 or an environmental sound around the smart glasses 720. A 2D camera 203 can image the surroundings of the smart glasses 720. The 2D camera 203 is, for example, a CCD camera.

The sensor module unit 210B includes a speech emotion recognition unit 211 and an utterance understanding unit 212. A communication processing unit 280 of the control unit 228B controls communication between the smart glasses 720 and the outside.

FIG. 14 is a diagram showing an example of a usage aspect of the agent system 700 in the smart glasses 720. The smart glasses 720 implement provision of various services to the user 10 using the agent system 700. For example, in a case where the smart glasses 720 are operated by the user 10 (for example, the user 10 inputs a speech to the microphone or taps the touch panel with a finger), the smart glasses 720 start to use the agent system 700. Here, using the agent system 700 includes an aspect in which the smart glasses 720 include and use the agent system 700, and further includes an aspect in which a part (for example, the sensor module unit 210B, a storage unit 220, and the control unit 228B) of the agent system 700 is provided outside the smart glasses 720 (for example, a server), and the smart glasses 720 communicate with the outside to use the agent system 700.

In a case where the user 10 operates the smart glasses 720, a touchpoint is established between the agent system 700 and the user 10. That is, service provision by the agent system 700 is started. As described in the third embodiment, in the agent system 700, a character of an agent is set by the character setting unit 276.

The emotion determination unit 232 determines an emotion value indicating an emotion of the user 10 and an emotion value of the agent. Here, the emotion value indicating the emotion of the user 10 is estimated from various sensors included in the sensor unit 200B mounted on the smart glasses 720. For example, in a case where a heart rate of the user 10 detected by the heart rate sensor 208 is elevated, the emotion value of “anxiety”, “fear”, or the like is estimated to be large.

Further, for example, in a case where a body temperature of the user exceeds an average body temperature as a result of measuring the body temperature using the temperature sensor 207, the emotion value of “pain”, “suffering”, or the like is estimated to be large. Further, for example, in a case where it is detected by the acceleration sensor 206 that the user 10 is performing any kind of sport, the emotion value of “pleasure” or the like is estimated to be large.

Further, for example, the emotion value of the user 10 may be estimated from a speech or utterance content of the user 10 acquired by the microphone 201 mounted on the smart glasses 720. For example, in a case where the user 10 is raising his/her voice, the emotion value of “anger” or the like is estimated to be large.

In a case where the emotion value estimated by the emotion determination unit 232 is larger than a predetermined value, the agent system 700 causes the smart glasses 720 to acquire information regarding a surrounding situation. Specifically, for example, the 2D camera 203 is caused to capture an image or a moving image indicating the surrounding situation (for example, a person or an object) of the user 10. Further, the microphone 201 is caused to record ambient environmental sound. Examples of other information regarding the surrounding situation include a date, a time, location information, and information indicating weather. The information regarding the surrounding situation is stored in history data 222 together with the emotion value. The history data 222 may be implemented by an external cloud storage. As described above, the surrounding situation obtained by the smart glasses 720 is stored in the history data 222 as a so-called life log in a state of being associated with the emotion value of the user 10 at that time. In the agent system 700, information indicating the surrounding situation is stored in the history data 222 in association with the emotion value. As a result, the agent system 700 grasps personal information such as a hobby, a preference, or a personality of the user 10. For example, in a case where an image indicating a scene of watching baseball is associated with the emotion value of “happy” or “pleasure”, the agent system 700 grasps the fact that the hobby of the user 10 is watching baseball and grasps a favorite team or player of the user 10 from the information stored in the history data 222.

Then, in the case of having a dialogue with the user 10 or performing a behavior for the user 10, the agent system 700 determines a dialogue content or a behavior content in consideration of a content of the surrounding situation stored in the history data 222. It is a matter of course that the dialogue content or the behavior content may be determined in consideration of a dialogue history stored in the history data 222 as described above in addition to the surrounding situation.

As described above, the behavior determination unit 236 generates an utterance content based on a sentence generated by a text generation model. Specifically, the behavior determination unit 236 generates the utterance content of the agent by inputting, to the text generation model, a text or speech input by the user 10, the emotions of both the user 10 and the agent determined by the emotion determination unit 232, the conversation history stored in the history data 222, a personality of the agent, and the like. Further, the behavior determination unit 236 generates the utterance content of the agent by inputting the surrounding situation stored in the history data 222 to the text generation model.

The generated utterance content is output by voice from the speaker mounted on the smart glasses 720 to the user 10, for example. In this case, a synthesized voice corresponding to the character of the agent is used as the voice. The behavior control unit 250 generates the synthesized voice by reproducing a voice style of the character of the agent, and generates the synthesized voice corresponding to the emotion of the character (for example, a voice with a forcible tone in a case where the emotion is “anger”). Further, the utterance content may be displayed on the display instead of or together with the voice output.

The RPA 274 performs an operation according to a command (for example, a command of the agent acquired from a speech or text uttered by the user 10 through a dialogue with the user 10). For example, the RPA 274 performs a behavior related to use of a service provider, such as information search, restaurant reservation, ticket arrangement, purchase of products or services, payment, route guidance, or translation.

Further, as another example, the RPA 274 performs an operation of transmitting a content input by voice from the user 10 (for example, a child) through a dialogue with the agent to a counterpart (for example, parents). Examples of transmission means include message application software, chat application software, and mail application software.

In a case where the operation is performed by the RPA 274, for example, a speech indicating that the operation is finished is output from the speaker mounted on the smart glasses 720. For example, a speech such as “The reservation of the restaurant is completed” is output to the user 10. Further, for example, in a case where the restaurant is fully booked, a speech such as “The reservation could not be made. What would you like to do?” is output to the user 10.

A part of the agent system 700 (for example, the sensor module unit 210B, the storage unit 220, and the control unit 228B) may be provided outside the smart glasses 720 (for example, a server), and the smart glasses 720 may function as each unit of the agent system 700 by communicating with the outside.

As described above, the smart glasses 720 use the agent system 700 to provide various services to the user 10. In addition, since the smart glasses 720 are worn by the user 10, the agent system 700 can be used in various scenes such as at home, at work, and at a place outside the house.

In addition, since the smart glasses 720 are worn by the user 10, the smart glasses 720 are suitable for collecting the so-called life log of the user 10. Specifically, the emotion value of the user 10 is estimated based on detection results of various sensors or the like mounted on the smart glasses 720 or recording results of the 2D camera 203 or the like. Therefore, the emotion value of the user 10 can be collected in various scenes, and the agent system 700 can provide a service or utterance content appropriate for the emotion of the user 10.

Further, in the smart glasses 720, the surrounding situation of the user 10 can be obtained by the 2D camera 203, the microphone 201, and the like. Then, the surrounding situation and the emotion value of the user 10 are associated with each other. As a result, it is possible to estimate what kind of emotion the user 10 has in what kind of situation. As a result, accuracy in a case where the agent system 700 grasps the hobby and the preference of the user 10 can be improved. Then, as the agent system 700 accurately grasps the hobby and the preference of the user 10, the agent system 700 can provide a service or an utterance content appropriate for the hobby and the preference of the user 10.

Further, the agent system 700 can also be applied to other wearable terminals (electronic equipment that can be worn on the body of the user 10, such as a pendant, a smart watch, an earring, a bracelet, or a hairband). In a case where the agent system 700 is applied to a smart pendant, a speaker serving as the control target 252B outputs a speech representing various types of information to the user 10. The speaker is, for example, a speaker capable of outputting a sound having directionality. The speaker is set to have directionality toward the ear of the user 10. As a result, the sound is suppressed from reaching a person other than the user 10. The microphone 201 acquires a speech uttered by the user 10 or an environmental sound around the smart pendant.

The smart pendant is worn so as to be suspended from the neck of the user 10. Therefore, the smart pendant is positioned relatively close to the mouth of the user 10 while being worn. As a result, acquisition of a speech uttered by user 10 is facilitated.

### Fifth Embodiment

In a fifth embodiment, a robot 100 is applied as an agent for having a dialogue with a user through an avatar. That is, a behavior control system is applied to an agent system implemented using a headset-type terminal. Portions having similar configurations to those of the first to fourth embodiments are denoted by the same reference numerals, and a description thereof is omitted.

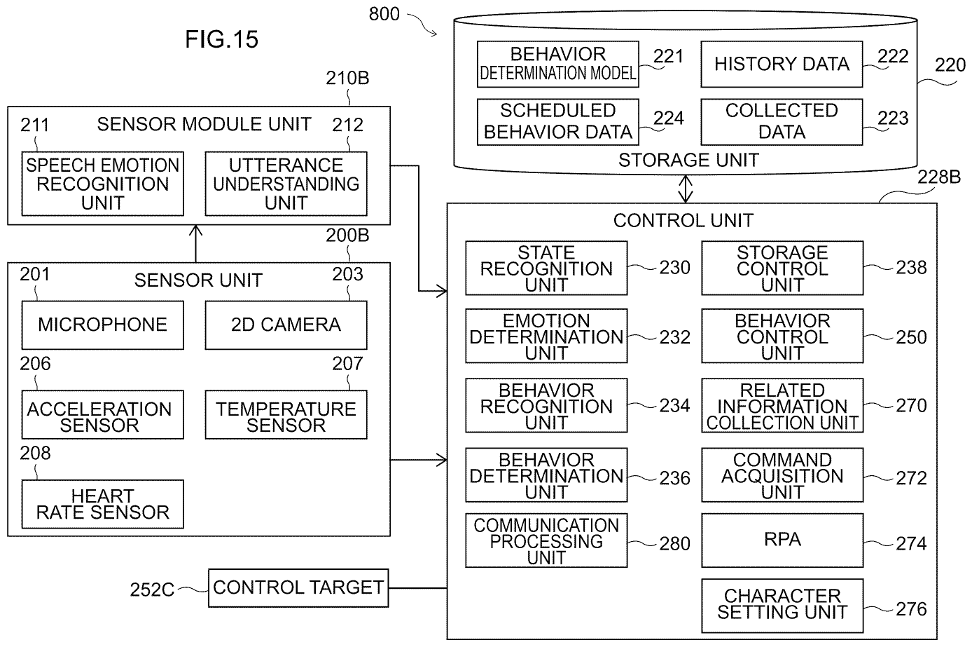

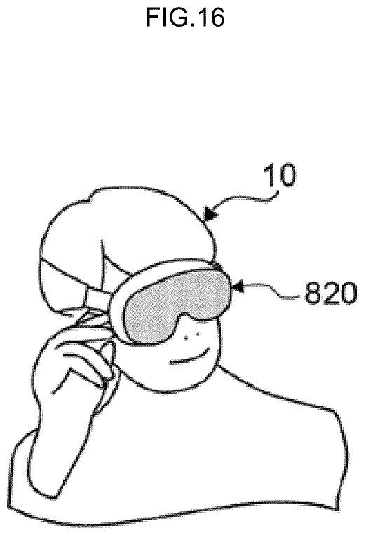

FIG. 15 is a functional block diagram of an agent system 800 implemented using some or all of functions of the behavior control system. The agent system 800 includes a sensor unit 200B, a sensor module unit 210B, a storage unit 220, a control unit 228B, and a control target 252C. The agent system 800 is implemented by, for example, a headset-type terminal 820 as shown in FIG. 16.

As shown in FIG. 16, the agent system 800 is implemented by, for example, the headset-type terminal 820. The headset-type terminal 820 is a goggle-type smart device, and is worn by a user 10 similarly to general goggles. The headset-type terminal 820 is an example of electronic equipment and a wearable terminal.

The headset-type terminal 820 includes the agent system 800. A display included in the control target 252C displays various types of information for the user 10. The display is, for example, a liquid crystal display. The display is provided, for example, at a lens portion of the headset-type terminal 820, and a display content can be visually recognized by the user 10. The display may be provided instead of the lens portion in the headset-type terminal 820.

A speaker included in the control target 252C outputs a speech representing various types of information to the user 10. The headset-type terminal 820 includes a touch panel (not shown), and the touch panel receives an input from the user 10.

An acceleration sensor 206, a temperature sensor 207, and a heart rate sensor 208 of the sensor unit 200B detect a state of the user 10. The sensors are merely examples, and it is a matter of course that other sensors may be mounted in order to detect the state of the user 10.

A microphone 201 acquires a speech uttered by the user 10 or an environmental sound around the headset-type terminal 820. A 2D camera 203 can image the surroundings of the headset-type terminal 820. The 2D camera 203 is, for example, a CCD camera.

The sensor module unit 210B includes a speech emotion recognition unit 211 and an utterance understanding unit 212. A communication processing unit 280 of the control unit 228B controls communication between the headset-type terminal 820 and the outside. Further, a part of the headset-type terminal 820 (for example, the sensor module unit 210B, the storage unit 220, and the control unit 228B) may be provided outside the headset-type terminal 820 (for example, a server), and the headset-type terminal 820 may function as each unit of the agent system 800 by communicating with the outside.

The headset-type terminal 820 implements provision of various services to the user 10 using the agent system 800. For example, in a case where the headset-type terminal 820 is operated by the user 10 (for example, the user 10 inputs a speech to the microphone or taps the touch panel with a finger), the headset-type terminal 820 starts to use the agent system 800. Here, using the agent system 800 includes an aspect in which the headset-type terminal 820 includes and uses the agent system 800, and further includes an aspect in which a part (for example, the sensor module unit 210B, the storage unit 220, and the control unit 228B) of the agent system 800 is provided outside the headset-type terminal 820 (for example, the server), and the headset-type terminal 820 communicates with the outside to use the agent system 800.

In a case where the user 10 operates the headset-type terminal 820, a touchpoint is established between the agent system 800 and the user 10. That is, service provision by the agent system 800 is started.

In the present embodiment, the agent system 800 has a function of determining a behavior of the avatar and generating a display of the avatar to be presented to the user through the headset-type terminal 820, in the control unit 228B.

Here, the avatar is, for example, a 3D avatar, and may be selected by the user 10 from among avatars prepared in advance, and the avatar may be a virtual avatar of the user 10 or may be an avatar the user 10 likes, the avatar being generated by the user 10. In the case of generating the avatar, an image generation AI may be utilized to generate avatars in a plurality of visual styles such as photorealistic, cartoon, anime-style, and oil-painting styles.

A behavior recognition unit 234 of the control unit 228B periodically recognizes a behavior of the user 10 based on information analyzed by the sensor module unit 210B and a state of the user 10 recognized by a state recognition unit 230, and stores the state of the user 10 including the behavior of the user 10 in history data 222.

As in the first embodiment, an emotion determination unit 232 of the control unit 228B determines an emotion value of the agent based on a state of the headset-type terminal 820, and substitutes the emotion value as an emotion value of the avatar.

As in the first embodiment, in a case where the agent functioning as the avatar performs autonomous processing of autonomously performing a behavior, a behavior determination unit 236 of the control unit 228B determines, as an avatar behavior, any of a plurality of types of avatar behaviors including performing no operation based on at least one of the state of the user 10, the emotion of the user 10, an emotion of the avatar, or a state of the electronic equipment (for example, the headset-type terminal 820) that controls the avatar, and a behavior determination model 221 at a predetermined timing.

Specifically, the behavior determination unit 236 inputs a text representing at least one of the state of the user 10, the state of the electronic equipment, the emotion of the user 10, and the emotion of the avatar and a text for inquiry about the avatar behavior to a text generation model, and determines the avatar behavior based on an output of the text generation model.

Furthermore, the behavior control unit 250 displays the avatar in an image display region of the headset-type terminal 820 as the control target 252C according to the determined avatar behavior. Furthermore, in a case where the determined avatar behavior includes an utterance content of the avatar, the utterance content of the avatar is output by voice from the speaker as the control target 252C. At this time, the display of the avatar may be changed according to the output (a speech of the utterance content) from the speaker, so that the avatar appears to utter the speech.

In particular, in a case where the behavior determination unit 236 determines, as the avatar behavior, to provide advice on health to the user, it is preferable to cause the behavior control unit 250 to control the avatar to concern the health of the user 10 by spontaneously speaking to the user to watch over the user 10 or to spontaneously determine a symptom without being asked by the user 10 and recommend that the user 10 takes appropriate medication.

That is, the behavior determination unit 236 according to the fifth embodiment causes the behavior control unit 250 to control the avatar such that the avatar has a mind (behaves as if the avatar has a mind) and autonomously (spontaneously) and periodically checks a health condition of the user 10. More specifically, the behavior determination unit 236 detects a parameter representing the health condition of the user 10 autonomously and periodically via the sensor unit 200B. Examples of the parameter representing the health condition of the user 10 include an inflection of a conversation of the user 10, a complexion of the user 10, trembling of a hand of the user 10, a body temperature of the user 10 measured by a thermo sensor, a respiratory rate of the user 10, a heart rate of the user 10, a sleep duration of the user 10, and the number of times the user 10 has entered a toilet, a blood pressure of the user 10, and a blood glucose level of the user 10. The detected parameter representing the health condition of the user 10 is stored in time series as the history data 222 by a storage control unit 238.

Furthermore, the behavior determination unit 236 checks the health condition of the user 10 by using the behavior determination model 221 based on the parameter representing the health condition of the user 10 stored in time series as the history data 222 (determine whether or not to speak to the user 10 or to provide a medication recommendation to the user 10). Then, the behavior determination unit 236 causes the behavior control unit 250 to control the avatar to autonomously speak to the user 10 to watch over the user 10 as necessary to autonomously concern the health of the user 10, autonomously determine the symptom of the user 10 without being asked by the user 10, and recommend that the user 10 takes appropriate medication if necessary. At this time, the behavior control unit 250 may recommend that the user takes medication while operating the avatar to indicate that the avatar is suffering from the same symptom as the symptom of the user.

In a case where the behavior determination unit 236 determines utterance by the avatar about the health of the user 10, the behavior determination unit 236 checks the health condition of the user 10 by inputting, to the text generation model, the parameter representing the health condition of the user 10 stored in time series as the history data 222, and determines the utterance content of the avatar regarding the health condition of the user 10. At this time, the behavior control unit 250 causes the speaker included in the control target 252C to output a speech representing the determined utterance content of the avatar. In a case where the user 10 is absent therearound, the behavior control unit 250 stores the determined utterance content of the avatar in scheduled behavior data 224 without outputting the speech representing the determined utterance content of the avatar.

As an example, the behavior determination unit 236 inputs, to the text generation model, a text “The parameter representing the health condition of the user indicates that the body temperature of the user has changed as T1 (t1), T2 (t2), and T3 (t3). Which of the following behaviors (a) to (c) is appropriate as the behavior of the avatar?
(a) The avatar does nothing.
(b) The avatar speaks to the user with words expressing concern for the condition.
(c) The avatar recommends that the user takes medication.”

Here, in a case where an output of the text generation model is “It can be said that the behavior of (b) speaking to the user with words expressing concern for the condition and the behavior of (c) recommending that the user takes medication are appropriate behaviors”, the behavior determination unit 236 determines, as the behaviors of the avatar, the behavior of “(b) speaking to the user with words expressing concern for the condition” and the behavior of “(c) recommending that the user takes medication” based on the output. Furthermore, in a case where the output of the text generation model includes the behavior of “(c) recommending that the user takes medication” as described above, the behavior determination unit 236 further inputs a text such as “What medication should be recommended to the user?” to the text generation model. Here, in a case where the output of the text generation model is “The medication recommended to the user is X”, the behavior determination unit 236 determines, as the behavior of the avatar, an utterance “I recommend taking medication X” based on the output.

In the above example, an aspect in which it is determined to provide advice on health to the user in a case where the output of the text generation model is a content of recommending the behavior “The avatar provides advice on health to the user” has been described. However, the disclosure is not limited thereto, and the behavior determination unit 236 may autonomously check the health condition of the user 10 based on the parameter representing the health condition of the user 10, and may determine to provide, by the avatar, advice on health to the user in a case where it is determined that there is a certain abnormality in the health condition of the user 10. The health condition of the user 10 may be autonomously checked, for example, by comparing the detected parameter representing the health condition of the user 10 with a preset threshold, or by inputting the detected parameter representing the health condition of the user 10 to a neural network trained in advance and acquiring an evaluation value for evaluating the health condition of the user 10.

Here, the avatar is, for example, a 3D avatar, and may be selected by the user from among avatars prepared in advance, and the avatar may be a virtual avatar of the user or may be an avatar the user likes, the avatar being generated by the user. In the case of generating the avatar, the image generation AI may be utilized to generate avatars in a plurality of visual styles such as photorealistic, cartoon, anime-style, and oil-painting styles.

Furthermore, the disclosure is not limited to displaying a fixed avatar while displaying the avatar, and the behavior control unit 250 may transform the avatar while displaying the avatar if appropriate. The avatar may be transformed into another avatar by, for example, replacing a face or body of the avatar, or may be transformed into an avatar representing a home appliance, a device, or the like. Furthermore, the behavior control unit 250 may instantaneously move the avatar in an augmented reality (AR) (virtual reality (VR)) space, or may display the avatar at double speed in the AR (VR) space.

Furthermore, in addition, in a case where the behavior determination unit 236 of the first other example described above determines, as the avatar behavior, the behavior “(11) The robot proposes an art gallery, a museum, and an exhibition that the user should visit” or the behavior “(12) The robot introduces an event that the user should participate in”, in other words, proposes to the user to go out, it is preferable to cause the behavior control unit 250 to control the avatar to determine a destination to be proposed by using the text generation model based on event data stored in the history data 222.

For example, in a case where a hobby of the user includes visiting an art gallery, a museum, and an exhibition, and participating in various events, the behavior control unit 250 proposes to the user to go to an art gallery, a museum, or the like through the avatar displayed on the headset-type terminal 820 or the like according to a schedule or a plan of the user 10 acquired in advance.

At this time, the behavior control unit 250 may change the avatar according to the destination to be proposed to the user. For example, in a case where the behavior determination unit 236 determines, as the avatar behavior, to propose to the user to go out for an event such as a firework festival or a summer festival, the behavior control unit 250 may display the avatar wearing a Japanese yukata and cause the avatar to utter a proposal to go out for the event. Furthermore, the behavior control unit 250 may cause the avatar to explain a route to an art gallery, a museum, an exhibition, and various event halls as the destination while enjoying a conversation with the user. Furthermore, in a case where the destination to be proposed to the user is an art gallery, a museum, an exhibition, or the like, the avatar may change an appearance thereof to that of an exhibit, a painting, or the like by processing performed by the behavior control unit 250.

Furthermore, in a case where the user goes to an art gallery or a museum, the behavior control unit 250 may determine the avatar behavior such that the avatar selects an exhibit according to a liking and a preference of the user on the spot and explains the exhibit.

Here, the avatar is, for example, a 3D avatar, and may be selected by the user from among avatars prepared in advance, and may be a virtual avatar of the user. Furthermore, the avatar may be an avatar generated by the user based on the preference of the user. In a case where the avatar is generated by the user, for example, the image generation AI may be utilized to generate avatars in a plurality of visual styles such as photorealistic, cartoon, anime-style, and oil-painting styles.

Furthermore, in addition, in a case where the behavior determination unit 236 of the second other example described above determines, as the avatar behavior, to play a piece of music the user likes, it is preferable to cause the behavior control unit 250 to control the avatar to play a piece of music (in other words, reproduce a piece of music) based on information regarding the preference of the user in music stored in the storage unit. At this time, the behavior determination unit 236 may cause the avatar to utter, “I'll now play XX by YY, which you like” by using an output of the behavior determination model 221.

Furthermore, in a case where the behavior determination unit 236 determines, as the avatar behavior, to play the piece of music the user likes, it is preferable to cause the behavior control unit 250 to control the avatar to play a piece of music based on at least one of a preference in types of music, a preference in musical instruments, or a preference in singers as the information regarding the preference of the user in music.

Playing a piece of music based on the preference in types of music indicates, for example, that the behavior control unit 250 causes the avatar to play a piece of music of genres such as jazz, classical, rock, and popular music.

Furthermore, playing a piece of music based on the preference in musical instruments indicates that the behavior control unit 250 causes the avatar to play various musical instruments such as a wind musical instrument, a string musical instrument, and a percussion musical instrument, as an example.

At this time, the behavior control unit 250 can transform the avatar into a musical instrument according to the musical instrument used for the piece of music and display the musical instrument in the image display region of the headset-type terminal 820. Furthermore, the avatar may be transformed into a different musical instrument during the playback of the piece of music.

Furthermore, playing a piece of music based on the preference in singers indicates, as an example, that the behavior control unit 250 causes the avatar to sing a song of the singer. At this time, the avatar may be caused to sing with a voice of the singer, or may be caused to sing with a voice of the avatar itself set in advance.

At this time, the behavior control unit 250 can also transform the avatar into a virtual avatar of the singer and display the avatar in the image display region of the headset-type terminal 820 according to the singer of the piece of music.

Furthermore, in a case where the behavior determination unit 236 determines, as the avatar behavior, to play the piece of music the user likes, it is preferable to cause the behavior control unit 250 to control the avatar to adjust a volume level according to a preference of the user in volume levels.

Furthermore, the behavior control unit 250 can display a plurality of avatars in the image display region of the headset-type terminal 820 according to the number of performers of a piece of music.

At this time, the behavior control unit 250 may cause a plurality of avatars to play the same musical instrument or different musical instruments. Furthermore, the plurality of avatars may be displayed as being generated by splitting of an existing avatar, or may be displayed as being newly generated. The avatar may wear different clothes depending on the type of music.

Here, the avatar is, for example, a 3D avatar, and may be selected by the user from among avatars prepared in advance, and the avatar may be a virtual avatar of the user or may be an avatar the user likes, the avatar being generated by the user. In the case of generating the avatar, the image generation AI may be utilized to generate avatars in a plurality of visual styles such as photorealistic, cartoon, anime-style, and oil-painting styles.

Furthermore, in addition, in a case where the behavior determination unit 236 of the third other example determines, as the avatar behavior, the behavior “(5) The avatar proposes an activity”, that is, proposal of an activity to the user 10, the behavior determination unit 236 determines a content of the activity to be proposed to the user 10 by using the text generation model based on the event data stored in the history data 222 and the state of the user 10. Here, the behavior recognition unit 234 periodically detects the state of the user 10 and stores the state in the history data 222. Based on the event data stored in the history data 222 and the state of the user 10, the behavior determination unit 236 constantly grasps characteristics of the user 10 such as the liking and the preference of the user, and grasps what kind of shopping the user 10 likes according to the liking of the user 10. As a result of processing performed by the behavior determination unit 236, the avatar spontaneously proposes to the user 10 to go shopping, and accompanies the user 10 for shopping while having a conversation with the user.

Specifically, the behavior determination unit 236 inputs, to the text generation model, the event data stored in the history data 222, a text representing the state of the user 10, and data for inquiry about the activity to be proposed to the user, and determines the activity to be proposed to the user based on an output of the text generation model.

Furthermore, the plurality of types of avatar behaviors may further include a behavior “(11) The avatar is transformed into another avatar having a different appearance”. In a case where the behavior determination unit 236 determines, as the avatar behavior, the behavior “(11) The avatar is transformed into another avatar having a different appearance”, it is preferable to cause the behavior control unit 250 to control the avatar to transform to another avatar. The another avatar has an appearance such as a face, clothes, hairstyle, and belongings matching the liking of the user 10. In a case where the user 10 has a wide range of likings, the behavior control unit 250 may control the avatar to be transformed into various different avatars according to the liking.

Here, the avatar is, for example, a 3D avatar, and may be selected by the user from among avatars prepared in advance, and the avatar may be a virtual avatar of the user or may be an avatar the user likes, the avatar being generated by the user. In the case of generating the avatar, the image generation AI may be utilized to generate avatars in a plurality of visual styles such as photorealistic, cartoon, anime-style, and oil-painting styles.

Furthermore, in addition, in a case where the behavior determination unit 236 of the fourth other example determines, as the avatar behavior, to propose an activity related to food and drink, it is preferable to cause the behavior control unit 250 to operate the avatar to propose an activity related to food and drink.

For example, in a case where the behavior determination unit 236 determines, as the activity, proposal of an activity related to food and drink, the behavior determination unit 236 determines a behavior to be spontaneously proposed as the behavior of the user related to food and drink by using the text generation model based on the event data stored in the history data 222.

Specifically, the behavior determination unit 236 may operate the avatar to prompt the user to go to a restaurant, for example. In this case, the behavior determination unit 236 may cause the avatar to utter a line such as “Are you hungry?” or “Let's go eat”, or display the line on a screen of the headset-type terminal 820 as a speech bubble of the avatar. In the case of encouraging the user to have a meal, a position of the avatar to be displayed on the screen of the headset-type terminal 820 may be determined based on how strongly the proposal is made. For example, in the case of strongly prompting the user to have a meal, the avatar may be displayed to block a path of the user, that is, directly in front of the user. Furthermore, for example, in the case of mildly encouraging the user to have a meal, the avatar may be displayed on a side of the path of the user, that is, at an obliquely forward position.

Furthermore, the behavior determination unit 236 may operate the avatar to propose a menu to the user in a restaurant. In this case, the behavior determination unit 236 may cause the avatar to utter a line such as “Would you like some curry?” or “This restaurant makes really good hamburger steak”, or display the line on the screen of the headset-type terminal 820 as a speech bubble of the avatar. In this case, the avatar may be changed to an appearance of a cook corresponding to the menu. For example, in the case of a Western-style menu, the avatar can be changed to an avatar wearing a chef's hat, and in the case of a Japanese-style menu, the avatar can be changed to an avatar wearing a Japanese traditional kitchen apron. Furthermore, in a case where the avatar proposes a menu, a dish to be actually provided may be included in an image of the avatar.

Here, the avatar is, for example, a 3D avatar, and may be selected by the user from among avatars prepared in advance, and the avatar may be a virtual avatar of the user or may be an avatar the user likes, the avatar being generated by the user. In the case of generating the avatar, the image generation AI may be utilized to generate avatars in a plurality of visual styles such as photorealistic, cartoon, anime-style, and oil-painting styles.

Furthermore, in addition, in a case where the behavior determination unit 236 of the fifth other example determines, as the avatar behavior, the behavior “(11) The robot determines a schedule of the user”, in other words, proposal of a schedule to the user, it is preferable to cause the behavior control unit 250 to control the avatar to propose a schedule by using the text generation model based on the event data stored in the history data.

For example, as the behavior control unit 250 controls the avatar, the avatar may spontaneously make and propose a schedule according to a hobby and the preference of the user grasped based on a dialogue history stored in the history data 222 or a reaction of the user to a conversation with the avatar. Furthermore, in a case where the schedule is approaching, the behavior control unit 250 may control an operation of the avatar such that the avatar has an appearance of an alarm clock or the like and notifies the user.

Furthermore, in a case where it is determined through a conversation with the user that there is a schedule that the user does not want to go, the behavior control unit 250 may control the operation of the avatar such that the avatar spontaneously makes a notification of rejection (mail or telephone). At this time, in a case where the avatar is the virtual avatar of the user and can output a voice similar to a voice of the user, the behavior control unit 250 may control the operation of the avatar so as to make a call as the user.

Here, the avatar is, for example, a 3D avatar, and may be selected by the user from among avatars prepared in advance, and the avatar may be a virtual avatar of the user or may be an avatar the user likes, the avatar being generated by the user. In the case of generating the avatar, the image generation AI may be utilized to generate avatars in a plurality of visual styles such as photorealistic, cartoon, anime-style, and oil-painting styles.

Furthermore, in the sixth other example, specifically, the behavior determination unit 236 inputs a text representing at least one of the state of the user 10, the state of the electronic equipment, the emotion of the user 10, and the emotion of the avatar and a text for inquiry about the avatar behavior to the text generation model, and determines the avatar behavior based on an output of the text generation model. The plurality of types of avatar behaviors include the following behaviors (1) to (11) as in the first embodiment. However, in the present embodiment, the behavior (11) is replaced with “(11) The avatar has a conversation with another avatar”.

In the autonomous processing in the present embodiment, the behavior determination unit 236 collects information regarding an utterance content of another avatar displayed on the headset-type terminal 820 of another user, and always spontaneously grasps a liking and a preference of another avatar. Then, the behavior determination unit 236 uses the avatar in a random time period to speak about a baseball team that another avatar likes or speak about a favorite singer to another avatar displayed on the headset-type terminal 820 of another user. Then, the conversation is carried out endlessly between the avatar and another avatar, whereby an avatar having a supreme ego is created. Then, the avatars continue to talk via the text generation model. In a case where such conversation between the avatars is performed a plurality of times, it appears as if a new personality emerges in the avatar or the avatars are having a conversation with each other, so that it is possible to entertain a person wearing the headset-type terminal 820 and watching the conversation. In the present embodiment, since a conversation is performed between a plurality of avatars, the headset-type terminals 820 are preferably arranged at a distance at which imaging can be performed by the cameras thereof, but the disclosure is not limited thereto, and the headset-type terminal 820 may communicate with another headset-type terminal 820 via a network.

Furthermore, the behavior control unit 250 displays the avatar in an image display region of the headset-type terminal 820 as the control target 252C according to the determined avatar behavior. Furthermore, in a case where the determined avatar behavior includes an utterance content of the avatar, the utterance content of the avatar is output by voice from the speaker as the control target 252C.

In particular, in a case where the behavior determination unit 236 determines, as the avatar behavior, to have a conversation with another avatar, it is preferable to determine a conversation to be uttered by using the sentence generation model based on the event data stored in the history data, and cause the behavior control unit 250 to control the avatar to utter the determined conversation. At this time, the behavior control unit 250 causes the speaker included in the headset-type terminal 820 or a speaker connected to the headset-type terminal 820 to output a speech of the determined conversation according to a motion of a mouth of the avatar. Then, the speech of the conversation output from the speaker of another headset-type terminal 820 is acquired using the microphone. Furthermore, a related information collection unit 270 periodically collects information such as a favorite baseball team, a favorite singer, and a favorite hobby of another avatar from external data by using, for example, ChatGPT plugins. Furthermore, the storage control unit 238 periodically detects a state of the headset-type terminal 820 of another user, detects a behavior of another avatar (utterance content and motion) as a state of another avatar displayed on the headset-type terminal 820 of another user, and stores the detected behavior in the history data 222.

Furthermore, it is desirable that the outputting of the conversation by the behavior determination unit 236 is not started in a case where the user instructs the avatar to have a conversation with another avatar, but is autonomously performed by the behavior determination unit 236.

Furthermore, the behavior determination unit 236 may change the face of the avatar according to the emotion depending on a content of the conversation. For example, in a case where the avatar is having a conversation about a favorite baseball team, the avatar may show a smiling expression, and in a case where the avatar is having a conversation about a competitor baseball team, the avatar may show a rigid expression. In addition, a plurality of levels of facial expressions may be determined in advance according to the emotion, and the level of the facial expressions may be changed according to the number of conversational exchanges or the like. For example, in a case where the number of conversational exchanges increases, the level of facial expression may shift from a normal expression to a mild smile, then to a smiling expression, and to a laughing expression. Furthermore, the motion of the avatar may be changed according to the emotion or the like depending on the content of the conversation. For example, in a case where a conversation about a favorite baseball team is performed, the conversation may be performed using body and hand gestures. Furthermore, the clothes worn by the avatar may be changed according to the conversation of the avatar. For example, in a case where a conversation about a favorite baseball team is being performed, the clothes may be changed to a uniform of the baseball team. With such a configuration, it is possible to change the appearance of the avatar according to an ego or a personality of the avatar.

Furthermore, in a case where a conversation between the avatars has continued for a predetermined period of time, the behavior determination unit 236 may reduce a size of the avatar displayed in the image display region of the headset-type terminal 820. With such a configuration, the avatar can be prevented from disturbing the user wearing the headset-type terminal 820.

Furthermore, the avatar displayed in the image display region of the headset-type terminal 820 may be positioned toward the headset-type terminal 820 of the avatar with which the avatar is having a conversation. For example, in a case where the user wearing the headset-type terminal 820 of another avatar with which the avatar is having a conversation is present on the right side of the user wearing the headset-type terminal 820, the avatar may be arranged on the right side of the image display region of the headset-type terminal 820.

Furthermore, in a case where the behavior determination unit 236 determines, as the avatar behavior, to have a conversation with another avatar, the behavior determination unit 236 may determine a conversation to be uttered, further based on the state of the headset-type terminal 820 of another user or the emotion of another avatar displayed on the headset-type terminal 820 of another user.

Here, the avatar is, for example, a 3D avatar, and may be selected by the user from among avatars prepared in advance, and the avatar may be a virtual avatar of the user or may be an avatar the user likes, the avatar being generated by the user. In the case of generating the avatar, the image generation AI may be utilized to generate avatars in a plurality of visual styles such as photorealistic, cartoon, anime-style, and oil-painting styles.

Furthermore, in addition, in a case where the behavior determination unit 236 of the seventh other example determines, as the avatar behavior, to participate in a party, the behavior determination unit 236 determines participation of the avatar in the party by monitoring a behavior of a family member who is the user or based on the event data stored in the history data 222 and an output of the sentence generation model.

Furthermore, for the participation of the avatar in the party, the related information collection unit 270 collects information related to preferences and concerns, such as an interest, a concern, hobby, a preference, an orientation, and the like of the family member, who is the user, for each family member. Furthermore, for the participation of the avatar in the party, the storage control unit 238 stores the information related to the preferences and concerns collected by the related information collection unit 270 in collected data 223 for each family member.

For example, in a case where a family member has held a party on a birthday or an anniversary, the behavior control unit 250 causes the avatar to participate in the party as a surprise. Furthermore, the behavior control unit 250 causes the avatar to participate in the party based on the event data stored in the history data 222. Furthermore, the behavior control unit 250 determines, as the avatar behavior, execution of a predetermined event for the family member based on the emotion of the family member and/or the avatar participating in the party. Specifically, the behavior control unit 250 causes the avatar to participate in the party based on any one or more of the interest, the concern, the hobby, the preference, the orientation, a predetermined anniversary, and the like of each family member, which are included in the information related to the preferences and concerns of the family member stored in the collected data 223, and determines a behavior of the avatar to be performed in the party.

Specifically, the behavior control unit 250 controls the behavior of the avatar based on the history data 222 including an emotion value of the family and/or the avatar and the collected data 223 such that the event is carried out in a way that heightens the emotion of the family member and/or the avatar. At this time, the behavior control unit 250 changes the facial expression of the avatar to a pleasant expression, a smiling expression, or the like according to at least one of the state of the user who is the family member, the emotion of the user, or the emotion of the avatar, and controls the behavior of the avatar such that the event is carried out in a way that heightens the emotion of the family member and/or the avatar. Furthermore, the behavior control unit 250 may display, as the avatar, a favorite character of the family member.

Furthermore, the behavior control unit 250 causes the avatar to sing a birthday song, a favorite song of the family member, a Christmas song, or the like on a birthday or an anniversary of the family member, present a picture or a moving image of the past birthday or anniversary, present a picture diary of the past anniversaries, or display a cake, a Christmas tree, or the like according to a content of the party, thereby causing the avatar to help make a great memory in consideration of the preference, an interest, or the like of the family member.

Here, the avatar is, for example, a 3D avatar, and may be selected by the user from among avatars prepared in advance, and the avatar may be a virtual avatar of the user or may be an avatar the user likes, the avatar being generated by the user. In the case of generating the avatar, the image generation AI may be utilized to generate avatars in a plurality of visual styles such as photorealistic, cartoon, anime-style, and oil-painting styles.

In the agent system 800 according to the present embodiment, the related information collection unit 270 may collect information related to preference information from external data (websites such as news sites and moving image sites) based on the preference information acquired for the user 10 at a predetermined timing.

Specifically, the related information collection unit 270 acquires the preference information (for example, the websites) indicating matters of interest to the user 10 from the utterance content of the user 10 or a setting operation performed by the user 10.

The related information collection unit 270 collects news related to the preference information from the external data at regular intervals by using, for example, ChatGPT plugins (Internet search <URL: https://openai.com/blog/chatgpt-plugins>). For example, in a case where information indicating that the user 10 is a fan of a specific professional baseball team is acquired as the preference information, the related information collection unit 270 collects news related to a game result of the specific professional baseball team from the external data at a predetermined time every day, for example, using ChatGPT plugins. In addition, the related information collection unit 270 may collect data of a website related to the preference information from external data and acquire a summary or the like of a content of the website. For example, the related information collection unit 270 creates a search query based on the preference information by using the sentence generation model, acquires the data of the website related to the preference information from a search site k by using the search query, and acquires a summary of the content in the website by using the sentence generation model.

The emotion determination unit 232 determines the emotion of the avatar based on the information related to the preference information, which is collected by the related information collection unit 270. In the agent system 800, the emotion determination unit 232 of the control unit 228B determines the emotion value of the agent based on the state of the headset-type terminal 820, and substitutes the emotion value of the agent as the emotion value of the avatar.

Specifically, the emotion determination unit 232 determines the emotion of the avatar by inputting a text representing the information related to the preference information, which is collected by the related information collection unit 270, to the neural network trained in advance for emotion determination, and acquiring the emotion value indicating each emotion. For example, in a case where the collected news related to the game result of the specific professional baseball team indicates that the specific professional baseball team has won, the emotion of the avatar is determined so as to increase the emotion value of “joy” of the avatar.

In a case where the emotion value of the avatar is equal to or larger than a threshold, the storage control unit 238 stores the information related to the preference information, which is collected by the related information collection unit 270, in the collected data 223.

In the autonomous processing in the agent system 800 of the present embodiment, control is performed such that the avatar spontaneously and periodically detects the state of the user 10. The agent system 800 constantly detects the liking and the preference of the user 10, and the agent system 800 stores the detected liking and preference of the user 10 as the characteristics of the user 10 and grasps in advance what kind of web (website) the user 10 is interested in according to the liking and the preference of the user 10. The agent system 800 causes the avatar to have a mind and spontaneously propose a website that looks fun. As a result, the user 10 feels that the avatar enjoys the website together with the user 10 and finds information that the user enjoys.

The behavior determination unit 236 determines, as the avatar behavior, any one of a plurality of types of avatar behaviors (corresponding to robot behaviors) including performing no operation, by using at least one of the state of the user 10, the emotion of the user 10, the emotion of the avatar, or the state of the avatar, and the behavior determination model 221 at a predetermined timing. Here, a case where the text generation model having the dialogue function is used as the behavior determination model 221 will be described as an example.

For example, the behavior determination unit 236 inputs a text representing at least one of the state of the user 10, the emotion of the user 10, the emotion of the avatar, or the state of the avatar and a text for inquiry about the avatar behavior to the text generation model, and determines the behavior of the avatar based on an output of the text generation model.

For example, the plurality of types of avatar behaviors as events include the following behaviors (1) to (11).
(1) The avatar does nothing.
(2) The avatar dreams.
(3) The avatar speaks to the user.
(4) The avatar creates a picture diary.
(5) The avatar proposes an activity.
(6) The avatar proposes a person the user should meet.
(7) The avatar introduces news that the user is interested in.
(8) The avatar edits pictures and moving images.
(9) The avatar studies with the user.
(10) The avatar recalls memory.
(11) The avatar proposes a recommended website to the user.

The behavior determination unit 236 inputs, to the text generation model, a text representing each of the state of the user 10 recognized by the state recognition unit 230, the current emotion value of the user 10 determined by the emotion determination unit 232, and the current emotion value of the avatar determined by the emotion determination unit 232, and a text for inquiry about any of the plurality of types of avatar behaviors including performing no operation, every lapse of a certain period of time, and determines the behavior of the avatar based on an output of the text generation model. In the determination of the avatar behavior, a text representing the state of the avatar recognized by the state recognition unit 230 may be further included.

In a case where the behavior determination unit 236 determines, as the avatar behavior, the behavior “(11) The avatar proposes a recommended website to the user”, in other words, proposal of external data related to the preference information of the user 10, the behavior determination unit 236 proposes data of the website related to the preference information acquired by the related information collection unit 270.

Furthermore, the behavior determination unit 236 generates information for explaining a website to be proposed to the user 10 to the user 10. For example, one or more texts indicating a summary of a content of the website and a text for inquiry about how the avatar should explain the website are input to the text generation model, and information for explaining the website to the user 10 is generated based on an output of the text generation model.

The storage control unit 238 stores, in the history data 222, information specifying the website determined to be proposed to the user 10. Furthermore, the storage control unit 238 stores the information for explaining the website to the user 10 in the history data 222 in association with the website.

In a case where the behavior determination unit 236 determines, as the avatar behavior, the behavior “(11) The avatar proposes a recommended website to the user”, it is preferable to cause the behavior control unit 250 to control the avatar to propose a recommended website to the user 10.

In a case where the proposal of the website to the user 10 is determined as the avatar behavior, the behavior control unit 250 displays an image of the website together with the avatar in the image display region of the headset-type terminal 820 as the control target 252C worn by the user 10. That is, in a case where the proposed website is an image site, the behavior control unit 250 displays an image of the image site, in a case where the proposed website is a news site, the behavior control unit 250 displays a news image, and the behavior control unit 250 displays the avatar so as to be overlaid on the displayed image.

Furthermore, in a case where a voice, music, or the like is included in the proposed website, the behavior control unit 250 outputs the voice, music, or the like through the speaker as the control target 252C. Furthermore, the behavior control unit 250 outputs the information for explaining the website to the user 10 through the speaker as the control target 252C.

In the case of displaying the preference information of the user 10 in the image display region of the headset-type terminal 820, the behavior control unit 250 determines the facial expression of the avatar set according to the emotion value of the user 10 or the emotion value of the avatar, and controls the display of the avatar in the image display region so as to have the determined facial expression of the avatar.

Furthermore, in the case of displaying the preference information of the user 10 in the image display region of the control target 252C, the behavior control unit 250 controls the display of the avatar such that the avatar moves according to the image of the website, a sound and music output from the speaker, and the information for explaining the website to the user 10.

As a result, the user 10 wearing the headset-type terminal 820 can be guided by the avatar and enjoy information such as an image and a video of a website the user 10 likes. Furthermore, since the facial expression of the avatar changes according to the emotion of the user 10 or the emotion of the avatar, it is possible to further enjoy information such as an image or a video of the website the user 10 likes.

Furthermore, as the avatar moves according to the video, music, or the like of the website, the user 10 can enjoy the video, music, or the like of the website further together with the avatar.

Furthermore, in a case where the behavior control unit 250 determines, as the avatar behavior, to propose external data related to the preference information of the user, the avatar may be operated with an appearance corresponding to the website related to the preference information of the user collected in advance. For example, in a case where the website related to the preference information of the user is a news site, the avatar may be operated with an appearance of a newscaster.

In the above embodiment, a case in which the headset-type terminal 820 is used has been described as an example, but the disclosure is not limited thereto, and a glasses-type terminal having an image display region for displaying the avatar may be used.

Furthermore, in the above embodiment, a case where the text generation model capable of generating a sentence according to an input text is used has been described as an example, but the disclosure is not limited thereto, and a data generation model other than the text generation model may be used. For example, a prompt including an instruction is input to the data generation model, and pieces of inference data such as speech data indicating a speech, text data indicating a text, and image data indicating an image are input to the data generation model. The data generation model infers the input inference data according to the instruction indicated by the prompt, and outputs an inference result in a data format such as speech data or text data. Here, the inference refers to, for example, analysis, classification, prediction, and/or summary.

Further, in the above embodiment, a case where the robot 100 recognizes the user 10 by using a face image of the user 10 has been described, but the disclosed technology is not limited to such an aspect. For example, the robot 100 may recognize the user 10 by using a voice uttered by the user 10, a mail address of the user 10, an ID of a social network service (SNS) of the user 10, an ID card in which a wireless IC tag is embedded and which is possessed by the user 10, or the like.

The robot 100 is an example of the electronic equipment including the behavior control system. An application target of the behavior control system is not limited to the robot 100, and the behavior control system can be applied to various types of electronic equipment. Further, functions of a server 300 may be implemented by one or more computers. At least some functions of the server 300 may be implemented by a virtual machine. Further, at least some functions of the server 300 may be implemented on a cloud.

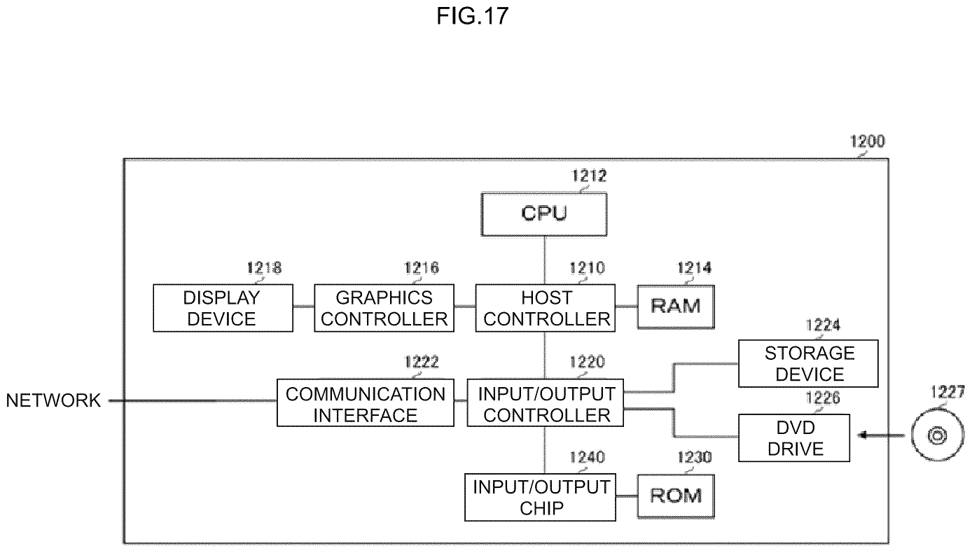

FIG. 17 schematically shows an example of a hardware configuration of a computer 1200 that functions as the smartphone 50, the robot 100, the server 300, and the agent systems 500, 700, and 800. A program installed in the computer 1200 can cause the computer 1200 to function as one or more “units” of the device according to the present embodiment, or cause the computer 1200 to perform an operation associated with the device according to the embodiment or one or more “units” thereof, and/or can cause the computer 1200 to execute a process according to the embodiment or a stage of the process. Such a program may be executed by a CPU 1212 to cause the computer 1200 to perform a certain operation associated with some or all of the blocks in the flowcharts and block diagrams described herein.

The computer 1200 according to the embodiment includes the CPU 1212, a random access memory (RAM) 1214, and a graphics controller 1216, which are mutually connected by a host controller 1210. The computer 1200 also includes input/output units such as a communication interface 1222, a storage device 1224, a digital versatile disk (DVD) drive 1226, and an integrated circuit (IC) card drive, which are connected to the host controller 1210 via an input/output controller 1220. The DVD drive 1226 may be a DVD-ROM drive, a DVD-RAM drive, or the like. The storage device 1224 may be a hard disk drive, a solid state drive, or the like. The computer 1200 also includes a read only memory (ROM) 1230 and a legacy input/output unit such as a keyboard, which are connected to the input/output controller 1220 via an input/output chip 1240.

The CPU 1212 operates according to the program stored in the ROM 1230 and the RAM 1214, thereby controlling each unit. The graphics controller 1216 acquires image data generated by the CPU 1212 in a frame buffer or the like provided in the RAM 1214 or itself, and causes the image data to be displayed on a display device 1218.

The communication interface 1222 communicates with other electronic devices via a network. The storage device 1224 stores the program and data to be used by the CPU 1212 in the computer 1200. The DVD drive 1226 reads the program or data from a DVD-ROM 1227 or the like and provides the program or data to the storage device 1224. The IC card drive reads the program and data from an IC card and/or writes the program and data to the IC card.

The ROM 1230 stores therein a boot program to be executed by the computer 1200 at the time of activation and/or a program that depends on hardware of the computer 1200. The input/output chip 1240 may also connect various input/output units to the input/output controller 1220 via a USB port, a parallel port, a serial port, a keyboard port, a mouse port, or the like.

The program is provided by a computer-readable storage medium such as the DVD-ROM 1227 or the IC card. The program is read from the computer-readable storage medium, installed in the storage device 1224, the RAM 1214, or the ROM 1230, which is also an example of the computer-readable storage medium, and executed by the CPU 1212. Information processing described in these programs is read by the computer 1200 and provides cooperation between the programs and various types of hardware resources described above. The device or method may be configured by implementing operation or processing of information according to the use of the computer 1200.

For example, in a case where communication is performed between the computer 1200 and an external device, the CPU 1212 may execute a communication program loaded into the RAM 1214 and instruct the communication interface 1222 to execute communication processing based on processing described in the communication program. Under the control of the CPU 1212, the communication interface 1222 reads transmission data stored in a transmission buffer region provided in a recording medium such as the RAM 1214, the storage device 1224, the DVD-ROM 1227, or the IC card, transmits the read transmission data to the network, or writes reception data received from the network to a reception buffer region or the like provided on the recording medium.

In addition, the CPU 1212 may read a necessary part of or the entire file or database stored in an external recording medium such as the storage device 1224, the DVD drive 1226 (DVD-ROM 1227), the IC card, or the like into the RAM 1214, and may perform various types of processing on the data on the RAM 1214. Next, the CPU 1212 may write back the processed data to the external recording medium.

Various types of information such as various types of programs, data, tables, and databases may be stored in a recording medium and subjected to the information processing. The CPU 1212 may perform various types of processing on the data read from the RAM 1214, the various types of processing including various types of operations, the information processing, condition determination, conditional branching, unconditional branching, and information search/replacement, which are described throughout the disclosure and designated by a command sequence of a program, and write back the results to the RAM 1214. In addition, the CPU 1212 may search for information in a file, a database, or the like in the recording medium. For example, in a case where a plurality of entries each having an attribute value of a first attribute associated with an attribute value of a second attribute are stored in the recording medium, the CPU 1212 may search for an entry in which the attribute value of the first attribute satisfies a designated condition among the plurality of entries, read the attribute value of the second attribute stored in the entry, and thereby acquire the attribute value of the second attribute associated with the first attribute satisfying a predetermined condition.

The program or software module described above may be stored in a computer-readable storage medium on the computer 1200 or in the vicinity of the computer 1200. Further, a recording medium such as a hard disk or a RAM provided in a server system connected to a dedicated communication network or the Internet can be used as the computer-readable storage medium, thereby providing a program to the computer 1200 via the network.

The blocks in the flowcharts and block diagrams in the embodiment may represent stages of a process in which the operation is performed or “units” of the device that are responsible for performing the operation. Certain stages and “units” may be implemented by a dedicated circuit, a programmable circuit provided together with a computer-readable instruction stored on a computer-readable storage medium, and/or a processor provided together with the computer-readable instruction stored on the computer-readable storage medium. The dedicated circuit may include a digital and/or analog hardware circuit, and may include an integrated circuit (IC) and/or a discrete circuit. The programmable circuit may include a reconfigurable hardware circuit such as a field programmable gate array (FPGA) or a programmable logic array (PLA), the reconfigurable hardware circuit including, for example, AND, OR, XOR, NAND, NOR, and other logical operations, a flip-flop, a register, and a memory element.

The computer-readable storage medium may include any tangible device capable of storing an instruction to be executed by a suitable device, so that the computer-readable storage medium having the instruction stored therein includes an article including an instruction that may be executed to create means for performing the operation specified in the flowcharts or block diagrams. Examples of the computer-readable storage medium may include an electronic storage medium, a magnetic storage medium, an optical storage medium, an electromagnetic storage medium, and a semiconductor storage medium. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disc read only memory (CD-ROM), a digital versatile disk (DVD), a Blu-Ray disk, a memory stick, and an integrated circuit card.

The computer-readable instruction may include a source code or an object code described in any combination of one or more programming languages, including an assembler instruction, an instruction-set-architecture (ISA) instruction, a machine instruction, a machine-dependent instruction, a microcode, a firmware instruction, state setting data, or an object-oriented programming language such as Smalltalk, JAVA (registered trademark), or C++, and a procedural programming language according to the related art, such as the “C” programming language or similar programming languages.

The computer-readable instruction may be provided for a processor of a general purpose computer, a special purpose computer, or another programmable data processing device, or a programmable circuit, either locally or via a local area network (LAN) or a wide area network (WAN) such as the Internet, to cause the processor of the general purpose computer, the special purpose computer, or the another programmable data processing device or the programmable circuit to execute the computer-readable instruction to generate means for performing the operation designated in the flowcharts or block diagrams. Examples of the processor include a computer processor, a processing unit, a microprocessor, a digital signal processor, a controller, and a microcontroller.

Although the disclosure has been described with reference to the embodiments, the technical scope of the disclosure is not limited to the scope described in the embodiments. It is apparent to those skilled in the art that various modifications or improvements can be made to the above embodiments. It is apparent from the description of the claims that such changed embodiments or improved embodiments can also be included in the technical scope of the disclosure.

It should be noted that an order of execution of processing such as operations, procedures, steps, and stages in the devices, systems, programs, and methods shown in the claims, the specification, and the drawings can be implemented in any order unless “before”, “prior to”, or the like is explicitly stated, and unless the output of the previous processing is used in the later processing. Even in a case where the operation flow in the claims, the specification, and the drawings is described using the terms “first”, “next”, and the like for convenience, it does not mean that it is essential to execute the operation flow in this order.

1. A computing apparatus comprising:
a processor;
a memory coupled to the processor, the memory storing:
a text generation model configured to generate output text responsive to input text,
history data including a plurality of event records, each event record including an emotion value and associated user behavior data, and
scheduled behavior data;
a communication interface configured to receive sensor data from a sensor device; and
circuitry configured to:
recognize a user state based on the sensor data received via the communication interface,
compute a first emotion value representing an emotional state of a user based on the user state,
compute a second emotion value representing an emotional state of an avatar,
generate input text including a representation of the user state, the first emotion value,
the second emotion value, and a query regarding avatar behavior selection,
apply the text generation model to the input text to generate output text indicating a selected avatar behavior from among a plurality of avatar behavior types,
determine, based on the selected avatar behavior, a schedule for the user using the text generation model based on preference information extracted from the history data,
store the determined schedule in the scheduled behavior data, and
generate output signals encoding avatar display data corresponding to the selected avatar behavior for transmission to a display device.

2. The apparatus of claim 1, wherein the memory comprises a random access memory coupled to the processor via a host controller.

3. The apparatus of claim 1, further comprising a graphics controller coupled to the processor and configured to render the avatar display data in a frame buffer.

4. The apparatus of claim 1, wherein the memory further comprises a storage device storing the text generation model and the history data, the storage device comprising at least one of a hard disk drive or a solid state drive.

5. The apparatus of claim 1, further comprising a read only memory storing a boot program executed by the processor at activation.

6. The apparatus of claim 1, further comprising an input/output controller coupling the communication interface to the processor via the host controller.

7. The apparatus of claim 1, wherein the circuitry is further configured to:
determine that a schedule is a schedule that the user does not want to attend based on at least the user state and the first emotion value, and
generate output signals encoding a rejection notification for the schedule.

8. The apparatus of claim 1, wherein the second emotion value includes values for a plurality of emotion classifications including joy, anger, sorrow, and pleasure.

9. The apparatus of claim 1, wherein the plurality of avatar behavior types includes at least: performing no operation, dreaming, speaking to the user, creating a picture diary, proposing an activity, and determining a schedule.

10. The apparatus of claim 1, wherein the circuitry is further configured to:
read the scheduled behavior data in response to detecting user presence after a period of user absence, and
generate output signals based on the read scheduled behavior data.

11. The apparatus of claim 1, wherein the circuitry is further configured to:
generate an image representing event data selected from the history data using an image generation model,
generate an explanatory sentence representing the event data using the text generation model, and
output a combination of the image and the explanatory sentence as a picture diary.

12. The apparatus of claim 1, wherein the circuitry is further configured to:
create an emotion changing event by combining emotion data and action data extracted from the history data using the text generation model, and
store the emotion changing event in the scheduled behavior data.

13. The apparatus of claim 1, wherein the communication interface is configured to communicate via a network conforming to a TCP/IP protocol stack.

14. The apparatus of claim 1, wherein the processor comprises a central processing unit configured to execute instructions stored in the memory.

15. The apparatus of claim 1, wherein the circuitry is implemented by a programmable circuit comprising at least one of a field programmable gate array or a programmable logic array.

16. The apparatus of claim 1, wherein the memory comprises a semiconductor storage medium including at least one of SRAM, DRAM, EPROM, EEPROM, or flash memory.

17. The apparatus of claim 1, wherein the circuitry is further configured to transmit the scheduled behavior data to a remote device via the communication interface and receive updated behavior model parameters from the remote device.

18. A computing apparatus comprising:
a central processing unit;
a random access memory coupled to the central processing unit via a host controller;
a graphics controller coupled to the host controller and configured to render image data in a frame buffer;
a storage device coupled to an input/output controller, the storage device storing:
a data generation model configured to generate output data responsive to input data,
history data including event records associating emotion values with user behavior data, and
scheduled behavior data;
a communication interface coupled to the input/output controller; and
processing circuitry configured to:
receive, via the communication interface, sensor data representing a state of a user,
compute a first emotion value representing an emotional state of the user,
compute a second emotion value representing an emotional state of an avatar,
input, to the data generation model, data representing at least one of the state of the user,
the first emotion value, or the second emotion value, and data for inquiry about avatar behavior,
determine an avatar behavior based on an output of the data generation model,
store behavior data in the scheduled behavior data based on the determined avatar behavior, and
cause the graphics controller to render avatar display data corresponding to the determined avatar behavior.

19. The apparatus of claim 18, wherein the processing circuitry is further configured to:
determine that a scheduled event is an event that the user does not want to attend based on the state of the user and the first emotion value, and
generate a rejection notification for the scheduled event.

20. A method for controlling avatar behavior using a computing apparatus, the method comprising:
receiving, at a communication interface of the computing apparatus, sensor data representing a state of a user;
computing, by a processor of the computing apparatus, a first emotion value representing an emotional state of the user based on the sensor data;
computing, by the processor, a second emotion value representing an emotional state of an avatar;
generating input text including a representation of the state of the user, the first emotion value, the second emotion value, and a query regarding avatar behavior selection;
applying a text generation model stored in a memory of the computing apparatus to the input text to generate output text indicating a selected avatar behavior;
determining, based on the selected avatar behavior, a schedule for the user using the text generation model and preference information extracted from history data stored in the memory;
storing the determined schedule in scheduled behavior data in the memory; and
generating, by a graphics controller of the computing apparatus, avatar display data corresponding to the selected avatar behavior for rendering on a display device.
